(19) United States
(12) Patent Application Publication
(10) Pub. No.: US 2018/0252957 A1
(43) Pub. Date: Sep. 6, 2018

(54) POLYMERIZABLE LIQUID CRYSTAL COMPOSITION AND OPTICALLY ANISOTROPIC BODY FORMED FROM THE SAME

(71) Applicant: DIC Corporation, Tokyo (JP)

(72) Inventors: Mika Yamamoto, Kita-adachi-gun (JP); Yasuhiro Kuwana, Kita-adachi-gun (JP); Yoshiyuki Ono, Kita-adachi-gun (JP)

(73) Assignee: DIC Corporation, Tokyo (JP)

(21) Appl. No.: 15/755,956

(22) PCT Filed: Aug. 19, 2016
(86) PCT No.: PCT/JP2016/074234

§ 371 Date: Feb. 27, 2018

(30) Foreign Application Priority Data
Sep. 1, 2015 (JP) 2015-171976

(51) Int. Cl. G02F 1/13363; G02F 1/1335; G02F 1/1337; C09K 19/36

(52) U.S. Cl. CPC G02F 1/13363; G02F 1/133528; G02F 1/133514; G02F 1/1337; G02F 1/133602; G02F 1/133504; G02F 2001/133507; G02F 2001/133541; G02F 2001/133638; G02F 2001/133543; G02F 2001/133548; G02F 2201/123; C09K 19/36

(57) ABSTRACT

The present invention provides a polymerizable cholesteric liquid crystal composition containing: one or two or more polymerizable liquid crystal compounds (I) having two or more polymerizable functional groups in the molecule; a chiral compound (III); a polymerization initiator (IV); optionally a non-silicon compound (V) having a repeating unit; and optionally one or two or more polymerizable liquid crystal compounds (II) having one polymerizable functional group. An optically anisotropic body formed from a polymerizable liquid crystal composition according to the present invention is also provided.

### TECHNICAL FIELD

The present invention relates to a polymerizable cholesteric liquid crystal composition useful as a constituent of an optically anisotropic body used for optical compensation or viewing angle compensation of liquid crystal displays and the like, as a constituent of an optically anisotropic body used for organic ELs, or as an optically anisotropic body for use in optical devices, and more particularly to an optically anisotropic body, a retardation film, a patterned retardation film, a brightness enhancement film, an antireflection film, a thermal barrier film, and a laminate having a protective layer on the optically anisotropic body, each formed from the polymerizable cholesteric liquid crystal composition, and to a liquid crystal display, an image display apparatus, an optical device, and a printed material, each including the optically anisotropic body, the retardation film, the patterned retardation film, the brightness enhancement film, the antireflection film, or the thermal barrier film.

### BACKGROUND ART

A polymerizable liquid crystal composition is useful as a constituent of an optically anisotropic body. An optically anisotropic body is used in various liquid crystal displays as a polarizing film or a retardation film, for example. A polarizing film or a retardation film is formed by applying a polymerizable liquid crystal composition to a substrate, evaporating the solvent to form a coating film, and heating the polymerizable liquid crystal composition aligned by an alignment film or irradiating the polymerizable liquid crystal composition aligned by an alignment film with an active energy beam to cure the polymerizable liquid crystal composition. In particular, it is known that a polymerizable cholesteric liquid crystal composition that contains a polymerizable liquid crystal composition and a chiral compound has circular polarization separation characteristics. Application of such a polymerizable cholesteric liquid crystal composition to retardation films, patterned retardation films, brightness enhancement films, antireflection films, thermal barrier films, various optical devices, such as diffraction gratings and pickup lenses, and anti-counterfeit printed materials is being studied.

An optically anisotropic body used as a constituent of liquid crystal displays and image display apparatuses should have high heat resistance. Patent Literature 1 discloses that a liquid crystal compound, with four or more benzene rings or cyclohexane rings can be used to form a heat-resistant retardation film in baking after formation of a retardation film. In spite of improved heat resistance, however, use of some polymerizable liquid crystal compositions causes a problem of poor alignment. In spite of improved heat resistance in Patent Literature 1, however, use of some polymerizable liquid crystal compositions tends to disturb the alignment. Patent Literature 2 discloses that the addition of multibranched compound, such as a dendrimer, to a polymerizable liquid crystal composition provides a retardation film that has small variations in phase difference, has small variations in its surface profile even after a baking process subsequent to the formation of the retardation film, causes no crack even in a transparent electrode sputtering process, which is a downstream process of the baking process, and has a stable surface profile. Although the retardation film has a stable surface profile, Patent Literature 2 does not disclose the heat resistance of the retardation film after an additional baking process subsequent to the transparent electrode sputtering process, which actual liquid crystal displays and image display apparatuses are subjected to.

### CITATION LIST

### Patent Literature

PTL 1: Japanese Unexamined Patent Application Publication No. 2011-148761

PTL 2: Japanese Unexamined Patent Application Publication No. 2010-138283

### SUMMARY OF INVENTION

### Technical Problem

The present invention provides a polymerizable cholesteric liquid crystal composition. A thin film, such as an optically anisotropic body or a retardation film, formed by curing the polymerizable cholesteric liquid crystal composition has good alignment and high heat resistance. The present invention also provides an optically anisotropic body, a retardation film, a patterned retardation film, a brightness enhancement film, an antireflection film, and a thermal barrier film, each formed from the polymerizable liquid crystal composition, a laminate having a protective layer on the optically anisotropic body, and a liquid crystal display, an image display apparatus, an optical device, and a printed material, each including the optically anisotropic body, retardation film, patterned retardation film, brightness enhancement film, antireflection film, or thermal barrier film.

### Solution to Problem

The present invention is a result of extensive studies focusing on a polymerizable liquid crystal composition to achieve the objects described above.

The present invention provides a polymerizable cholesteric liquid crystal composition containing: one or two or more polymerizable liquid crystal compounds (I) having two or more polymerizable functional groups in the molecule; a chiral compound (III); a polymerization initiator (IV); optionally a non-silicon compound (V) having a repeating unit; and optionally one or two or more polymerizable liquid crystal compounds (II) having one polymerizable functional group. An optically anisotropic body formed from a polymerizable liquid crystal composition according to the present invention is also provided.

### Advantageous Effects of Invention

A polymerizable cholesteric liquid crystal composition according to the present invention can be used to form a thin film, such as an optically anisotropic body or a retardation film, that has good alignment with fewer alignment defects. A thin film, such as an optically anisotropic body or a retardation film, formed by curing the liquid crystal composition has high heat resistance and is therefore useful for various optical materials. Furthermore, a liquid crystal display including the thin film, such as an optically anisotropic body or a retardation film, can have good display characteristics.

### BRIEF DESCRIPTION OF DRAWINGS

FIG. 1 is a schematic view of a liquid crystal display according to an embodiment of the present invention.

FIG. 2 is a schematic view of a liquid crystal display according to an embodiment of the present invention.

FIG. 3 is a schematic view of a liquid crystal display according to an embodiment of the present invention.

FIG. 4 is a schematic view of a liquid crystal display according to an embodiment of the present invention.

FIG. 5 is a schematic view of a liquid crystal display according to an embodiment of the present invention.

FIG. 6 is a schematic view of a liquid crystal display according to an embodiment of the present invention.

FIG. 7 is a schematic view of a liquid crystal display according to an embodiment of the present invention.

FIG. 8 is a schematic view of a liquid crystal display according to an embodiment of the present invention.

FIG. 9 is a schematic view of a liquid crystal display according to an embodiment of the present invention.

FIG. 10 is a schematic view of a liquid crystal display according to an embodiment of the present invention.

FIG. 11 is a schematic view of a liquid crystal display according to an embodiment of the present invention.

FIG. 12 is a schematic view of a liquid crystal display according to an embodiment of the present invention.

FIG. 13 is a schematic view of a liquid crystal display according to an embodiment of the present invention.

### REFERENCE SIGNS LIST

(1) polarization layer

(2) adhesive layer

(3) light-transmitting substrate

(4) color filter layer

(5) planarization layer

(6) alignment film for retardation film

(7) retardation film 1 formed from a polymerizable liquid crystal composition

(8) retardation film 2 formed from a polymerizable liquid crystal composition

(5) transparent electrode layer

(10) alignment film

(11) liquid crystal composition

(12) alignment film

(13) pixel electrode layer

(14) light-transmitting substrate

(15) adhesive layer

(16) polarization layer

(17) backlight

### Description of Embodiments

The best mode of a polymerizable liquid crystal composition according to the present invention will be described below. The term “liquid crystal” in a polymerizable liquid crystal composition, as used herein, is intended to refer to liquid crystallinity after an organic solvent is removed from the polymerizable liquid crystal composition applied to a substrate. The term “liquid crystal” in a polymerizable liquid crystal compound, as used herein, is intended to refer to liquid crystallinity of only one polymerizable liquid crystal compound or liquid crystallinity of a mixture with another liquid crystal compound. A polymerizable liquid crystal composition can be polymerized by light irradiation, such as ultraviolet light irradiation, by heating, or by a combination thereof, to produce a polymer (film).

### (Polymerizable Liquid Crystal Compound)

A polymerizable cholesteric liquid, crystal composition according to the present invention may contain any traditional polymerizable liquid crystal compound, provided that the polymerizable cholesteric liquid crystal composition contains one or two or more polymerizable liquid crystal compounds having two or more polymerizable functional groups in the molecule.

Examples include rod-like polymerizable liquid crystal compounds having a rigid moiety including a plurality of structures such as a 1,4-phenylene group 1,4-cyclohexlene group, which is called a mesogenic group, and having a polymerizable functional group, such as a vinyl group, an acryl group, or a (meth)acryl group, described in “Handbook of Liquid. Crystals” (edited by D. Demus, J. W. Goodby, G. W. Gray, H. W. Spiess, and V. Vill, Wiley-VCH, 1998), Kikan kagaku sosetsu No. 22, “Ekisyo no kagaku (Chemistry of liquid crystal)” (edited by Chemical Society of Japan, 1994), Japanese Unexamined Patent Application Publications No. 7-294735, No. 8-3111, No. 8-29618, No. 11-80090, No. 11-116538, and No. 11-148073, and rod-like polymerizable liquid crystal compounds having a maleimide group described in Japanese Unexamined Patent Application Publications No. 2004-2373 and No. 2004-99446. Among others, rod-like liquid crystal compounds having a polymerizable group are preferred because they can easily have a liquid crystalline temperature range including low temperatures near room temperature.

### (Polymerizable Liquid Crystal Compounds Having Two or More Polymerizable Functional Groups in Molecule)

A polymerizable cholesteric liquid crystal composition according to the present invention contains one or two or more polymerizable liquid crystal compounds having two or more polymerizable functional groups in the molecule. A polymerizable liquid crystal compound having two or more polymerizable functional groups in the molecule can be used to form a coating film with high curability in the formation of a polymer produced by polymerizing a polymerizable cholesteric liquid crystal composition. Specific examples of the polymerizable liquid crystal compound having two or more polymerizable functional groups in the molecule include the compounds represented by the general formula (I-1).

[Chem. 1]

P¹¹-(Sp¹¹-X¹¹)_{q1}-MG¹²-((X¹²-Sp¹²)_{q2}-P¹²)_{q3} (I-1)

In the formula, P¹¹ and P¹² independently denote a polymerizable functional group, Sp¹¹ and Sp¹² independently denote an alkylene group having 1 to 18 carbon atoms or a single bond, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group, X¹¹ and X¹² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CHS—OCO—, —CH═CH—, —N═N—, —CH═N—N═CH—, —CF═CF—, —C═C—, or a single bond (provided that P¹¹-Sp¹¹, P¹²-Sp¹², Sp¹¹-X¹¹, and SP¹²-X¹² have no direct bonding of heteroatoms), q1 and q2 are independently 0 or 1, q3 is 1 or 2, and MG¹² denotes a mesogenic group.

P¹¹ and P¹² preferably independently denote a substituent selected from the polymerizable groups represented by the following formulae (P-2-1) to (P-2-20).

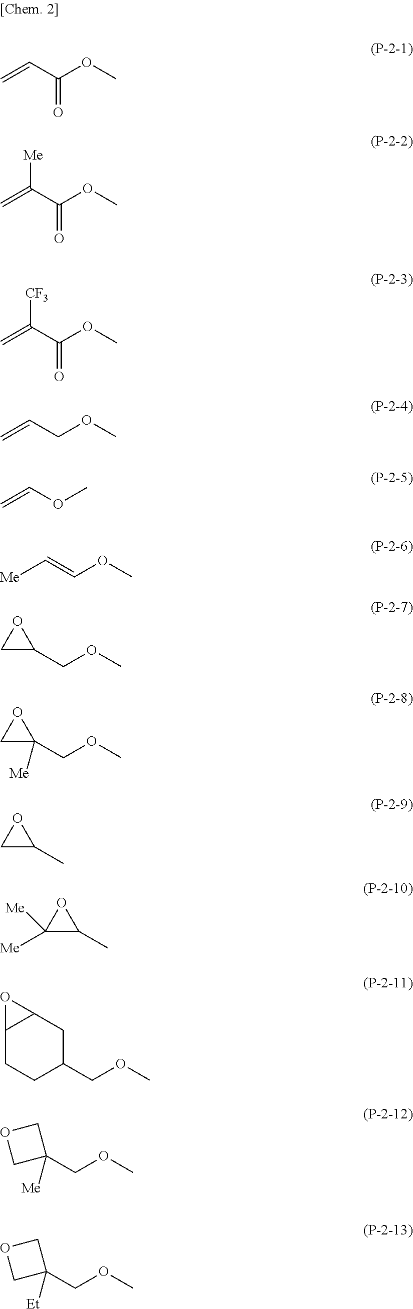

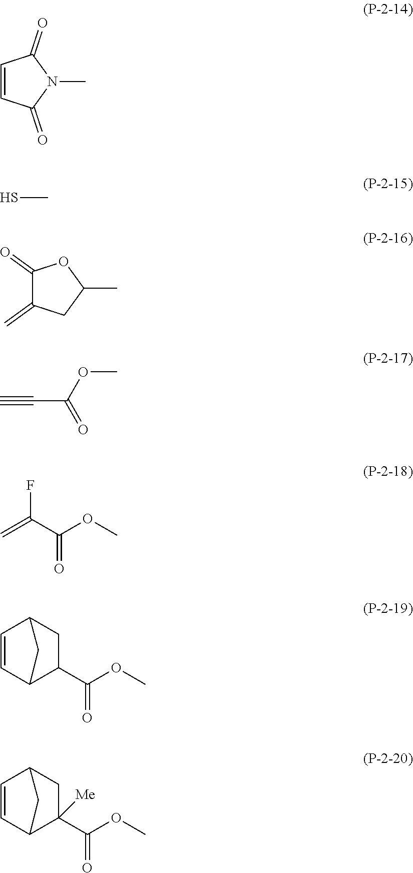

Among these polymerizable functional groups, in terms of high polymerization reactivity, the formulae (P-2-1), (P-2-2), (P-2-7), (P-2-12), and (P-2-13) are preferred,, and the formulae (P-2-1) and (P-2-2) are more preferred.

MG¹² denotes a mesogenic group represented by the general formula (I-b).

[Chem. 3]

-(A1-Z1)ᵣ₁-A2-Z2-A3- (I-b)

(wherein A1, A2, and A3 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms, Z1 and Z2 independently denote an alkyl group having 2 to 10 carbon atoms and optionally having —COO—, —OCO—, —CH₂CH₂—, —OCH₂—, —CH₂O—, —CH═CH—, —C═C—, —CH═CHCOO—, —OCOCH═CH—, —CH₂CH₂COO—, —CH₂CH₂OCO—, —COOCH₂H₂—, —OCOCH ₂CH₂—, —C═N—, —N═C—, —CONR—, —NHCO—, —C(CF₃)₂—, or a halogen atom (a fluorine atom, a chlorine atom, a bromine atom, or an iodine atom) or a single bond, Z1 and Z2 preferably independently denote —COO—, —OCO—, —CH₂CH₂—, —OCH₂—, —CH₂O—, —CH═CH—, —C═C—, —CH═CHCOO—, —OCOCH═CH—, —CH₂CH₂COO—, —CH₂CH₂OCO—, —COOCH₂CH₂—, —OCOCH₂CH₂—, or a single bond, more preferably —COO—, —OCO—, —OCH₂—, —CH₂O—, —CH₂CH₂O—, —CH₂CH₂OCO—, —COOCH₂CH₂—, —OCOCH₂CH₂—, or a single bond, r1 is 0, 1, 2, or 3, a plurality of A1s and Z1s, if present, may be the same or different A1s and Z1s, respectively, and if q3 is 2 or 3, then any of A1, A2, and A3 has one or two —(X¹²-Sp¹²)_{q2}-P¹² groups) A1, A2, and A3 preferably independently denote a 1,4-phenylene group, a 1,4-cyclohexylene group, or a 2,6-naphthylene group.

### (Bifunctional Polymerizable Liquid Crystal Compound)

The polymerizable liquid crystal compound having two or more polymerizable functional groups in the molecule and represented by the general formula (I-1) is preferably a bifunctional polymerizable liquid crystal compound having two polymerizable functional groups in the molecule and represented by the following general formula (I-1-1).

[Chem. 4]

P¹¹-(Sp¹¹-X¹¹)_{q1}-MG¹²-(X¹²-Sp¹²)_{q2}-P¹² (I-1-1)

(wherein P¹¹ and P¹² independently denote a polymerizable functional group, Sp¹¹ and Sp¹² independently denote an alkylene group having 1 to 18 carbon atoms or a single bond, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group, X¹¹ and X¹² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C═C—, or a single bond (provided that P¹¹-Sp¹¹, P¹²-Sp¹², Sp¹¹-X¹¹, and Sp¹²-X¹² gave no direct bonding of heteroatoms), q1 and q2 are independently 0 or 1, and MG¹² denotes a mesogenic group)

P¹¹ and P¹² preferably independently denote a substituent selected from the polymerizable groups represented by the formulae (P-2-1) to (P-2-20). Among these polymerizable functional groups, in terms of high polymerization reactivity, the formulae (P-2-1), (P-2-2), (P-2-7), (P-2-12), and (P-2-13) are; preferred, and the formulae (P-2-1) and (P-2-2) are more preferred.

Sp¹¹ and. Sp¹² preferably in dependently denote an alkylene group having 1 to 15 carbon atoms, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group, Sp¹¹ and Sp¹² more preferably independently denote an alkylene group having 1 to 12 carbon atoms, and one —CH₂— or two or more nonadjacent —CH₂— groups in the alkylene group are independently optionally substituted with —O—, —COO—, —OCO—, or —OCO—O—.

X¹¹ and X¹² preferably independently denote —O—, —OCH₂—, —CH₂O—, —CO—, —COO—, —OCO—, —O—CO—O—, —CO—NH—, —NH—CO—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C═C—, or a single bond, and X¹¹ and X¹² more preferably independently denote —O—, —OCH₂—, —CH₂O—, —CO—, —COO—, —OCO—, —O—CO—O—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C═C—, or a single bond.

MG¹² denotes a mesogenic group, the general formula (I-1-b)

[Chem. 5]

-(A1-Z1)ᵣ₁-A2-Z2-A3- (I-1-b)

In the formula, A1, A2, and A3 independently denote a 1,4-phenylene group, a 1,4-cyclohexylene group, a 1,4-cyclohexenyl group, a tetrahydropyran-2, 5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyioxy group having 2 to 8 carbon atoms, alkenoyl group having 2 to 8 carbon atoms, and/or alkenoyloxy group having 2 to 8 carbon atoms, Z1 and Z2 independently denote an alkyl group having 2 to 10 carbon atoms and optionally having —COO—, —OCO—, —CH₂CH₂—, —OCH₂—, —CH₂O—, —CH═CH—, —C═C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, or a halogen atom (a fluorine atom, a chlorine atom, a bromine atom, or an iodine atom) or a single bond, Z1 and Z2 preferably independently denote —COO—, —OCO—, —CH₂CH₂—, —OCH₂—, —CH₂O—, —CH═CH—, —C═C—, —CH═CHCOO—, —OCOCH═CH—, —CH₂CH₂COO—, —CH₂CH₂OCO—, —COOCH₂CH₂—, —OCOCH₂CH₂—, or a single bond, more preferably —COO—, —OCO—, —OCH₂—, —CH₂O—, —CH₂CH₂O—, —CH₂CH₂OCO—, —COOCH₂CH₂—, —OCOCH₂CH₂—, or a single bond, r1 is 0, 1, 2, or 3, and a plurality of A1s and Z1s, if present, may be the same or different A1s and Z1s, respectively. A1, A2, and A3 preferably independently denote a 1,4-phenylene group, a 1,4-cyclohexylene group, or a 2,6-naphthylene group.

Examples of the general formula (I-1-1) include, but are not limited to, the compounds represented by the following general formulae (I-1-1-1) to (I-1-1-4).

[Chem. 6]

P¹¹-(Sp¹¹-X¹¹)_{q1}-A2-Z2-A3-(X¹²-Sp¹²)_{q2}-P¹² (I-1-1-1)

P¹¹-(Sp¹¹-X¹¹)_{q1}-A11-Z11-A2-Z2-A3-(X¹²-Sp¹²)_{q2}-P¹² (I-1-1-2)

P¹¹-(Sp¹¹-X¹¹)_{q1}-A11-Z11-A12-Z12-A2-Z2-A3-(X¹²-Sp¹²)_{q2}-P¹² (I-1-1-3)

P¹¹-(Sp¹¹-X¹¹)_{q1}-A11-Z11-A12-Z12-A13-Z13-A2-Z2-A3-(X¹²-Sp¹²)_{q2}-P¹² (I-1-1-4)

In the formulae, P¹¹, Sp¹¹, X¹¹, q1, X¹², Sp¹², q2, and P¹² are the same as defined in the general formula (I-1-1),

A11 and A12 and A13, A2, and A3 are the same as A1 to A3 defined in the general formula (I-1-b) and may be the same or different, and

Z11 and Z12 and Z13, and Z2 are the same as Z1 and Z2, respectively, defined in the general formula (I-1-b) and may be the same or different.

Among the compounds represented by the: general formulae; (I-1-1-1) to (I-1-1-4), the compounds represented by the general formulae (I-1-1-2) to (I-1-1-4) and having three or more ring structures are preferably used in terms of good alignment of an optically anisotropic body formed, and the compounds represented by the general formula (I-1-1-2) and having three ring structures are particularly preferably used.

Examples of the compounds represented by the general formulae (I-1-1-1) to (I-1-1-4) include, but are not limited to, the compounds represented by the following general formulae (I-1-1-1-1) to (I-1-1-1-21).

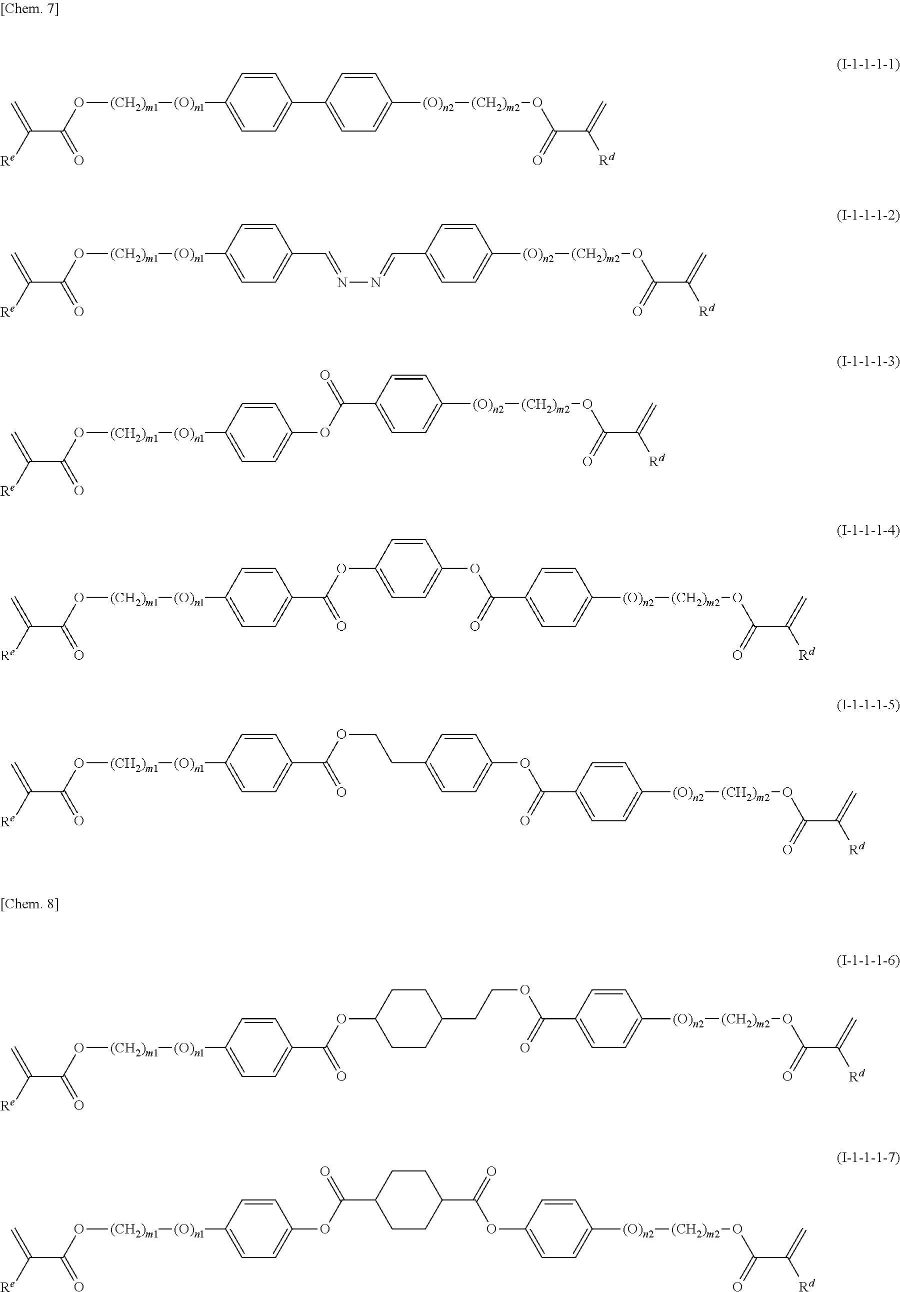

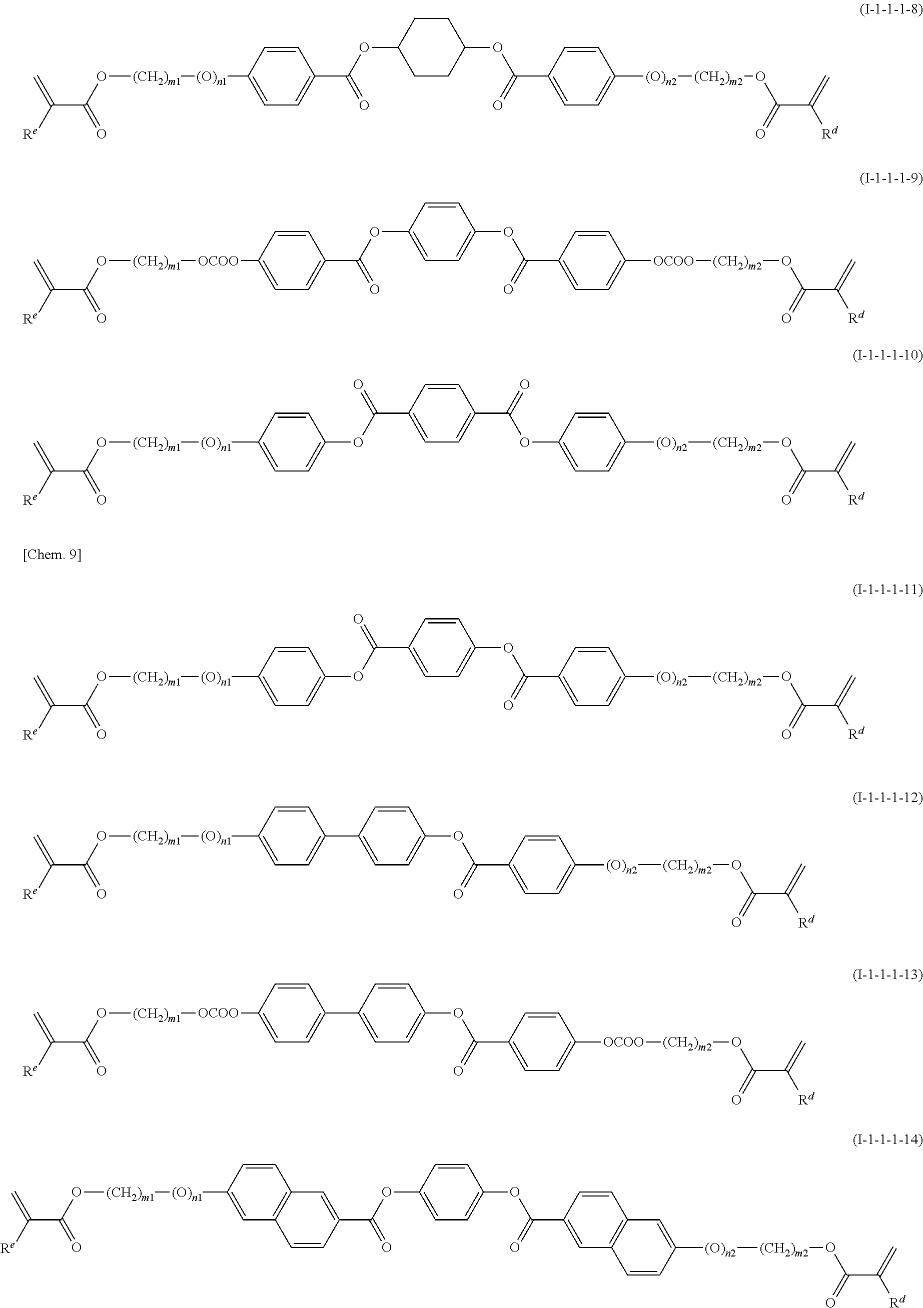

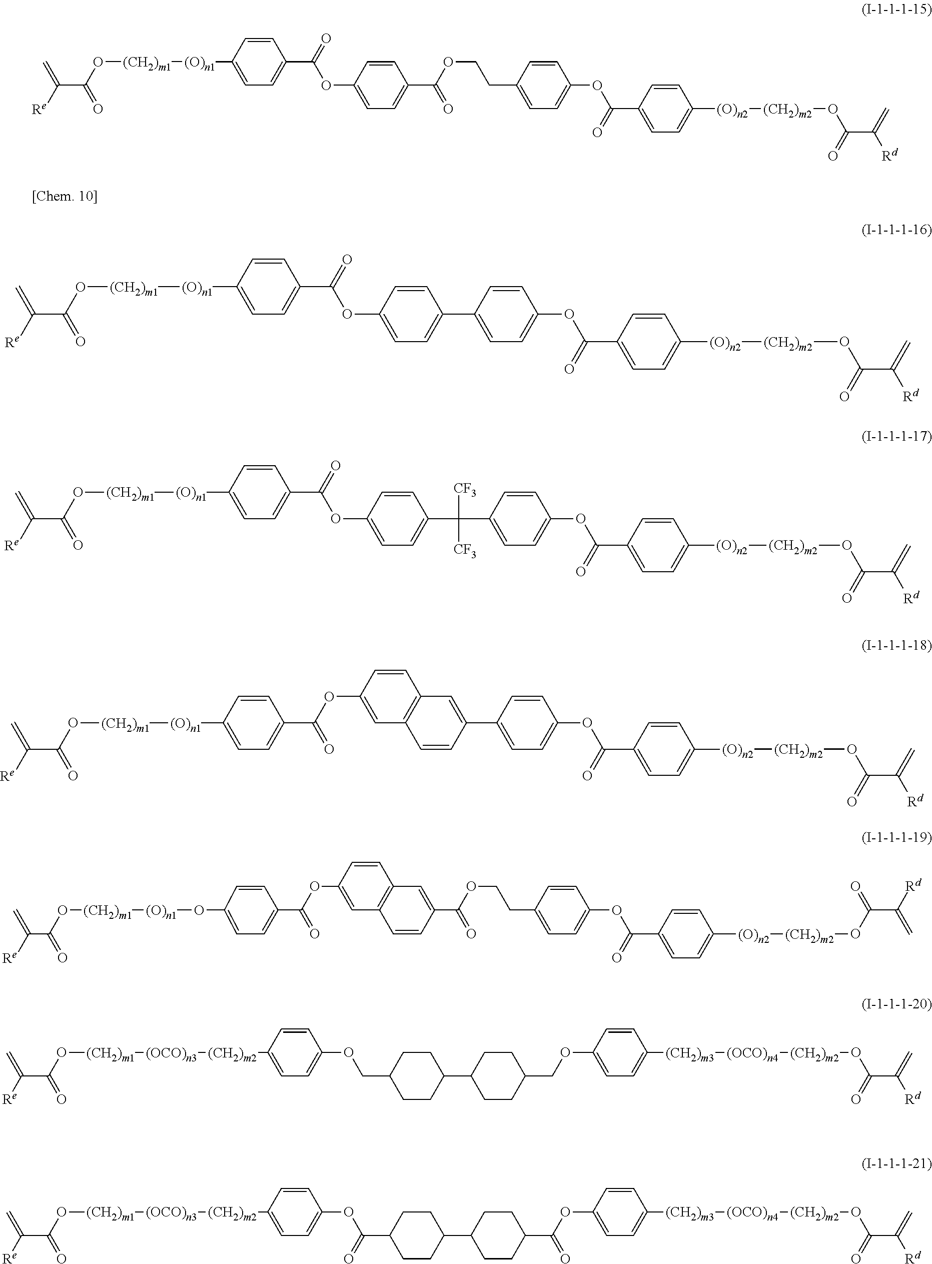

In the formulae, R^{d} and R⁸ independently denote a hydrogen atom or a methyl group.

the cyclic group may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to carbon atoms, and

m1 and m2 independently denote an integer in the range of 0 to 18, and n1, n2, n3, and n4 are independently 0 or 1.

One or two or more, preferably one to five, more preferably two to five, liquid crystal compounds having two polymerizable functional groups may be used.

The total amount, of the polymerizable liquid crystal compound(s) having two polymerizable functional groups in the molecule preferably ranges from 10% to 98% by mass, more preferably 15% to 98% by mass, particularly preferably 20% to 98% by mass, of the total amount of the polymerizable liquid crystal compound (I), the polymerizable liquid crystal compound (II), and the chiral compound (III) in the polymerizable cholesteric liquid crystal composition. The lower limit is preferably 30% or more by mass, more preferably 50% or more by mass, in terms of the curability of a coating film to be formed.

### (Trifunctional Polymerizable Liquid Crystal Compound)

The polymerizable liquid crystal compound having two or more polymerizable functional groups in the molecule and represented by the general formula (I-1) is preferably a trifunctional polymerizable liquid crystal compound having three polymerizable functional groups in the molecule and represented by the following general formula (I-1-2).

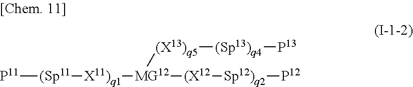

(wherein P¹² to P¹³ independently denote a polymerizable functional group, Sp¹¹ to S¹³ independently denote an alkylene group having 1 to 18 carbon atoms or a single bond, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group, X¹¹ to X¹³ independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C═C—, or a single bond (provided that P¹¹-Sp¹¹, P¹²-Sp¹², Sp¹¹-X¹¹, Sp¹²-X¹², Sp¹³-X¹³, and Sp¹³-X¹³ have no direct bonding of heteroatoms), q1, q2, q4, and q5 are independently 0 or 1, and MG¹² denotes a mesogenic group)

P¹² and P¹³ preferably independently denote a substifuent selected from, the polymerizable groups represented by the following formulae (P-2-1) to (P-2-20).

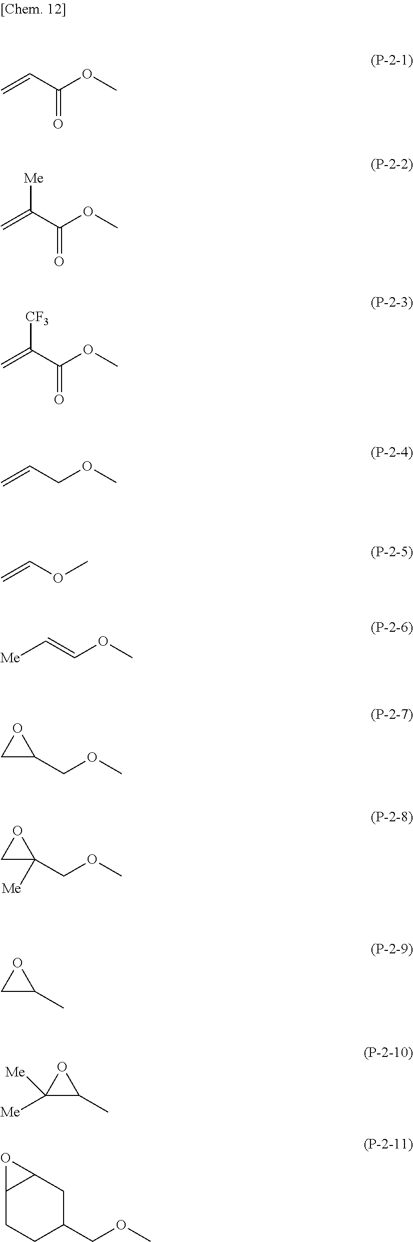

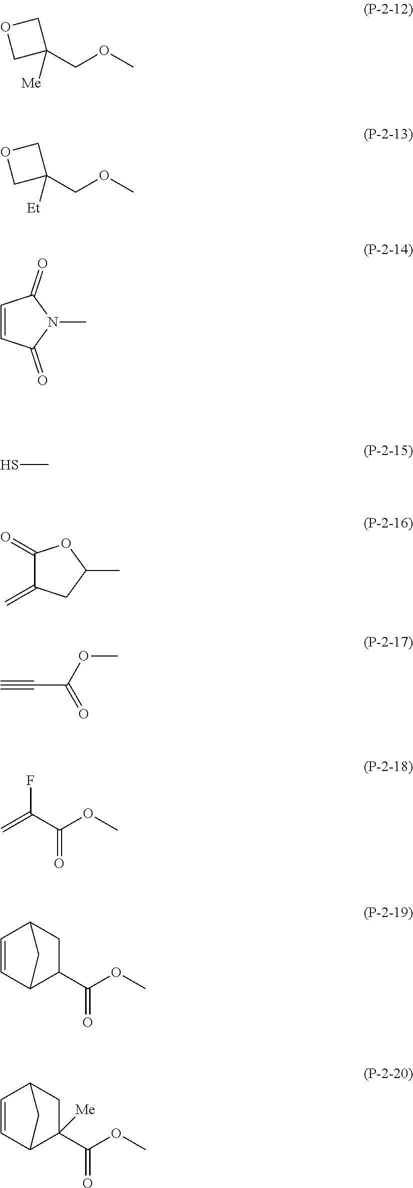

Among these polymerizable functional groups, in terms of high polymerization reactivity, the formulae (P-2-1), (P-2-2), (P-2-7), (P-2-12), and (P-2-13) are preferred, and the formulae (P-2-1) and (P-2-2) are more preferred.

Sp¹¹ to Sp¹³ preferably independently denote an. alkylene group having 1 to 15 carbon atoms, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group, Sp¹¹ to Sp¹³ more preferably independently denote an alkylene group having 1 to 12 carbon atoms, and one —CH₂— or two or more nonadjacent —CH₂— groups in the alkylene group are independently optionally substituted with —O—, —COO—, —OCO—, or —OCO—O—. X¹¹ to X¹³ preferably independently denote —O—, —OCH₂—, —CH₂O—, —CO—, —COO—, —OCO—, —O—CO—O—, —CO—NH—, —NH—CO—, CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C═C—, or a single bond, and X¹¹ to X¹³ more preferably independently denote —O—, —OCH₂—, —CH₂O—, —CO—, —COO—, —OCO—, —O—CO—O—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C═C—, or a single bond.

MG¹² denotes a mesogenic group represented by the general formula (I-2-b).

[Chem. 13]

-(A1-Z1)ᵣ₁-A2-Z2-A3- (I-2-b)

In the formula, A1, A2, and A3 independently denote a 1,4-phenylene group, a 1,4-cyclohezylene group, a 1,4-cyclohexenyl group, a tetrahydropyran-2,5-diyl group, a 1,3-dioxane-2,5-diyl group, a tetrahydrothiopyran-2,5-diyl group, a 1,4-bicydo (2, 2, 2)octylene group, a deoahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxv group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms, and any of A1, if present, A2, and A3 has a -(X¹³)_{q5}-(Sp¹³) group. Z1 and Z2 independently denote an alkyl group having 2 to 10 carbon atoms and optionally having —COO—, —OCO—, —CH₂CH₂—, —OCH₂—, —CH₂O—, —CH═CH—, —C═C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, or a halogen atom (a fluorine atom, a chlorine atom, a bromine atom, or an iodine atom) or a single bond, Z1 and Z2 preferably independently denote —COO—, —OCO—, —CH₂CH₂—, —OCH₂—, —CH₂O—, —CH═CH—, —C═C—, —CH═CHCOO—, —OCOC H═CH—, —CH₂CH₂COO—, —CH₂CH₂OCO—, —COOCH₂CH₂—, —OCOCH₂CH₂—, or a single bond, r1 is 0, 1, 2, or 3, and a plurality of A1s and S1s, if present, may be the same or different A1s and S1s, respectively. A1, A2, and A3 preferably independently denote a 1,4-phenylene group, a 1,4-cvclohexylene group, or a 2,6-naphthylene group.

Examples of the general formula (I-1-2) include, but are not limited to, the compounds represented by the following general formulae (I-1-2-1) to (I-1-2-8).

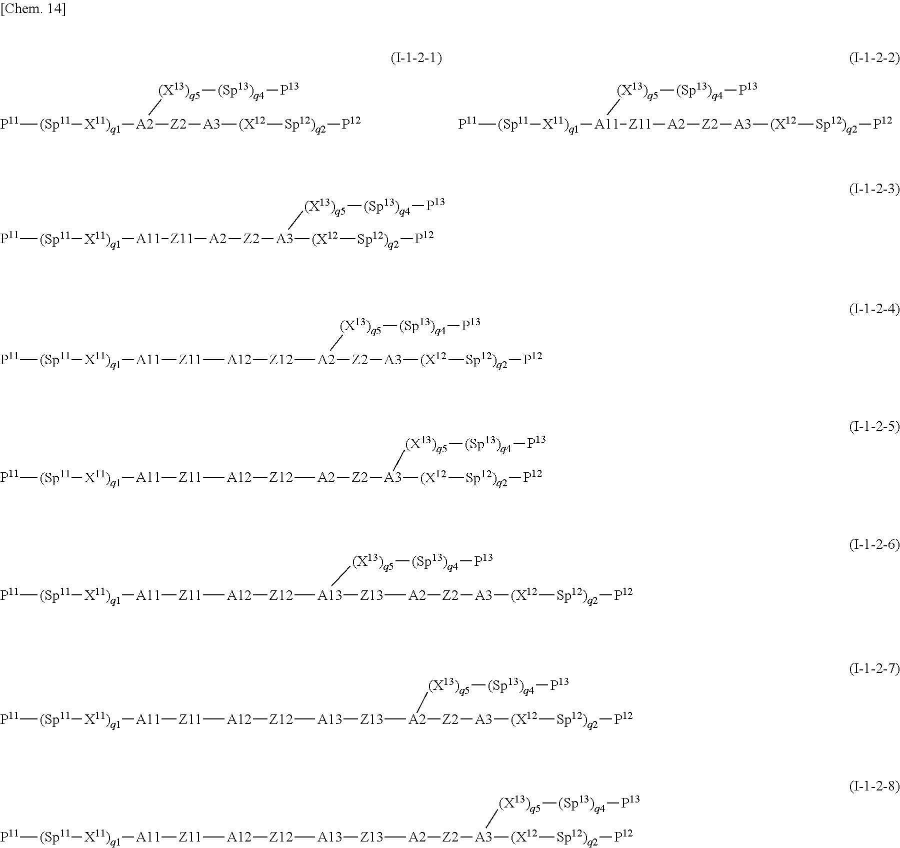

In the formulae, P¹¹, Sp¹¹, X¹¹, q1, X¹², Sp¹², q2, P¹², X¹³, q5, Sp¹³, q4, aud P¹² are the same as defined in the general formala (I-1-2),

A11 and A12 and A13, A2, and A3 are the same as A1 to A3, respectively, defined in the general formula (I-2-b) and may bo the same or different, and

Z11 and Z12 and Z3, and Z2 are the same as Z1 and Z2, respectively, defined in the general formula (I-2-b) and may be the same or different.

Examples of the compounds represented by the general formulae (I-1-2-1) to (I-1-2-8) include, but are not limited to, the compounds represented by the following general formulae (I-1-2-1-1) to (I-1-2-1-8).

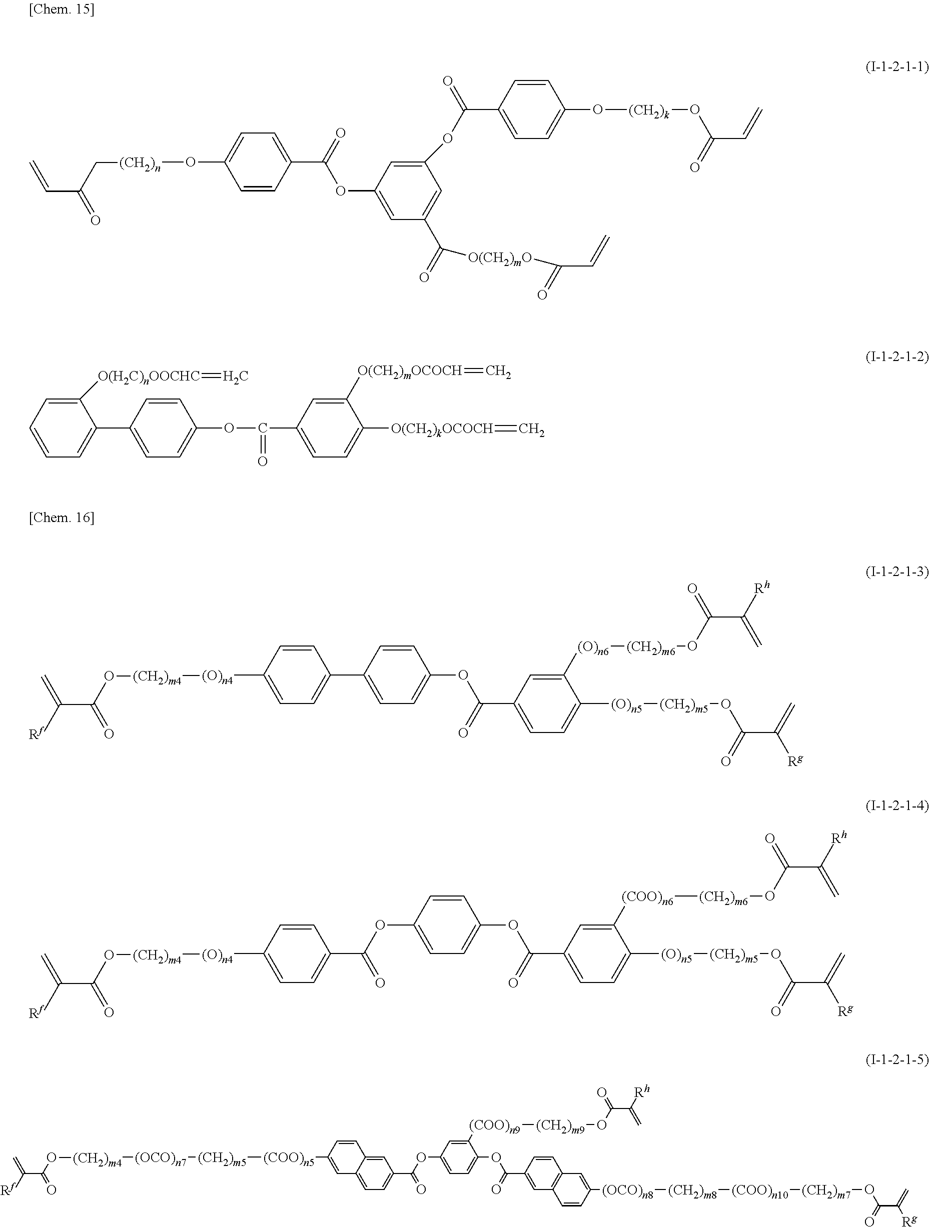

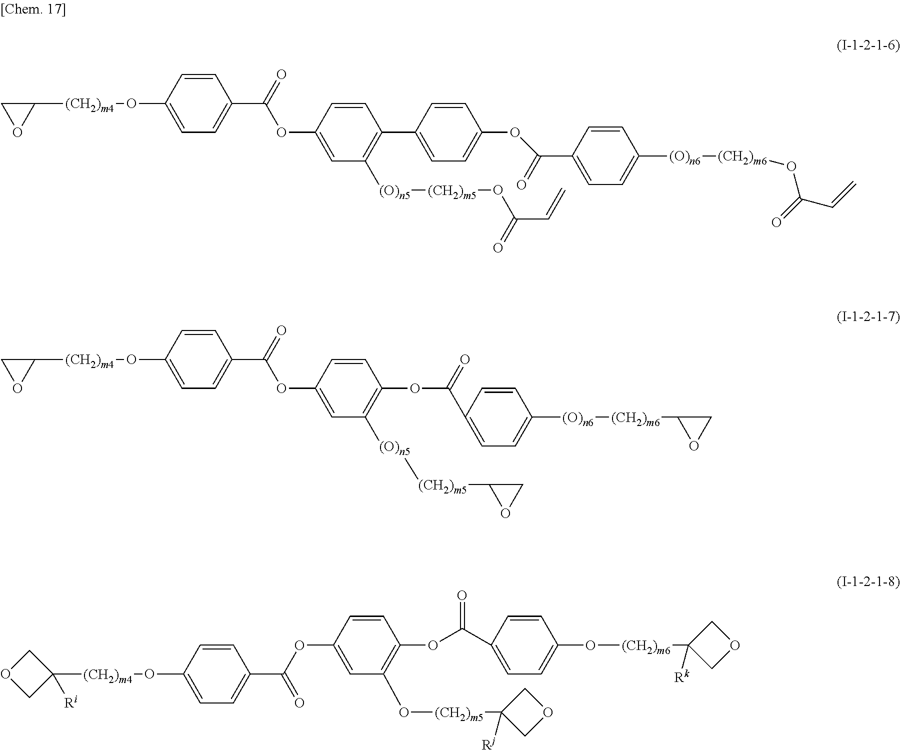

Although two symbols * in the general formulae (I-1-2-1-5) represent a binding site, no linking group is present at the site. In the formulae, R^{f}, R^{g}, and R^{h} independently denote a hydrogen atom or a methyl group, Rⁱ, R^{j} and R^{k} independently denote a hydrogen atom, a halogen atom (a fluorine atom, a chlorine atom, a bromine atom, or an iodine atom), an alkyl group having 1 to 6 carbon atoms, an alkoxy group having 1 to 6 carbon atoms, or a cyano group, if these groups denote an alkyl group having 1 to 6 carbon atoms or an alkoxy group having 1 to 6 carbon atoms, all the groups may be unsubstituted or substituted with one or two or more halogen atoms (a fluorine atom, a chlorine atom, a bromine atom, and an iodine atom), and the cyclic group may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyioxy group having 2 to 8 carbon atoms, n, m, and k independently denote an integer in the range of 1 to 18, m4 to m9 independently denote an integer in the range of 0 to 18, and n4 to n10 are independently 0 or 1.

One or two or more polyfunctional polymerizable liquid crystal compounds having three polymerizable functional groups may be used.

The total amount of the polyfunctional polymerizable liquid crystal compound(s) having three polymerizable functional groups in the molecule preferably ranges from 0% to 40% by mass, more preferably 0% to 30% by mass, particularly preferably 0% to 20% by mass, of the total amount of the polymerizable liquid crystal compound (I), the polymerizable liquid crystal compound (II), and the chiral compound (III) in the polymerizable cholesteric liquid crystal composition including a polymerizable liquid crystal compound represented by the general formula (II-1).

### (Monofunctional Polymerizable Liquid Crystal Compound)

A polymerizable cholesteric liquid crystal composition according to the present invention may contain one or two or more monofunctional polymerizable liquid crystal compounds (II) having one polymerizable functional group in the molecule. If a polymerizable liquid crystal composition according to the present invention contains the polymerizable liquid crystal compound having two or more polymerizable functional groups in the molecule as an essential component, a monofunctional polymerizable liquid crystal compound having one polymerizable functional group in the molecule may be used as an optional component. Specific examples of the monofunctional polymerizable liquid crystal compound include the compounds represented by the following general formula (II-1).

[Chem. 18]

P²²-(sp²²-X²²)_{q6}-MG²²-R²¹ (II-1)

In the formula, P²² denotes a polymerizable functional group, Sp²² denotes an alkylene group having 1 to 18 carbon atoms or a single bond, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group, X²² denotes —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C═C—, or a single bond (provided that P²²-Sp²² and Sp²²-X²² contain no direct bonding of heteroatoms other than C or H), q6 is 0 or 1, MG²² denotes a mesogenic group, R²¹ denotes a hydrogen atom, a halogen atom (a fluorine atom, a chlorine atom, a bromine atom, or an: .iodine atom), a cyano group, a linear or branched alkyl group having 1 to 12 carbon atoras, or a linear or branched alkenyl group having 1 to 12 carbon atoms, one —CH₂— or two or more nonadjacent —CH₂— groups in the alkyl group and the alkenyl group are independently optionally substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C═C—, one or two or more hydrogen atoms of the alkyl group and the alkenyl group are independently optionally substituted with a halogen atom (a fluorine atom, a chlorine atom, a bromine atom, or an iodine atom) or a cyano group, and the plurality of substituents, if present, may be the same or different.

P²² preferably denotes a substituent selected from the polymerizable groups represented by the following formulae (P-2-1) to (P-2-20).

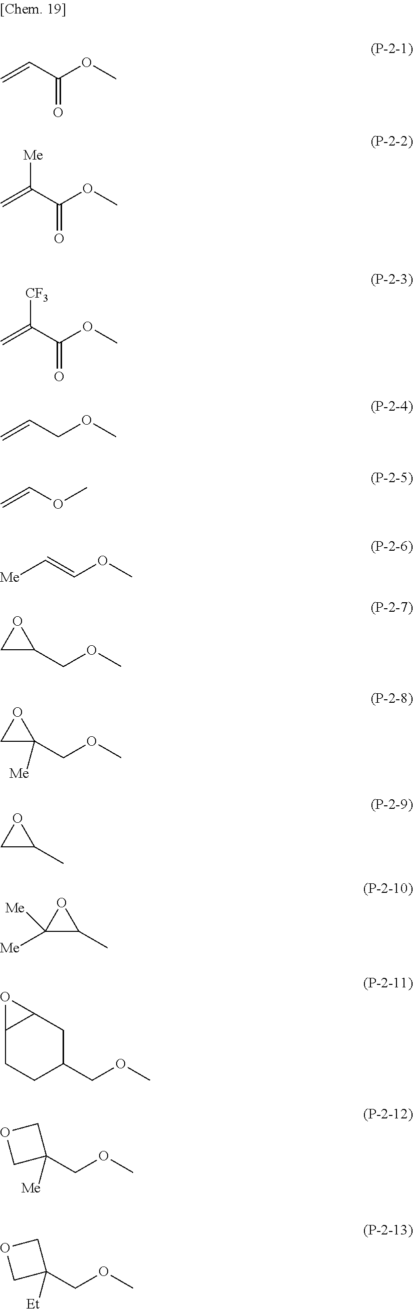

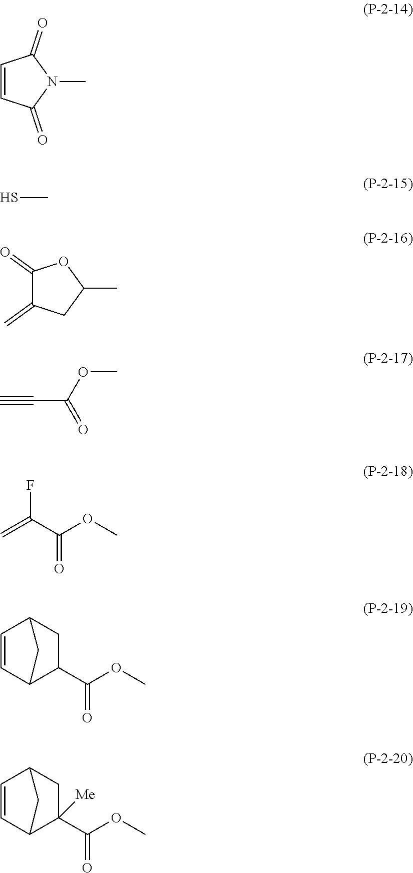

Among these polymerizable functional groups, in terms of high polymerization reactivity, the formulae (P-2-1), (P-2-2), (P-2-7), (P-2-12), and (P-2-13) are preferred,, and the formulae (P-2-1) and (P-2-2) are more preferred.

Sp²² preferably denotes an alkylene group having 1 to 15 carbon atoms, one —CH₂— or two or more nonadlacent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group, Sp²² preferably denotes an alkylene group) having 1 to 12 carbon, atoms, and one —CH₂— or two or more, nonadjacent —CH₂— groups in the alkylene group are independently optionally substituted with —O—, —COO—, —OCO—, or —OCO—O—O—.

X²² preferably denotes —O—, —OCH₂—, —CH₂O—, —CO—, —COO—, —OCO—, —O—CO—O—, —CO—NH—, —NH—CO—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C═C—, or a single bond, and X²² preferably denotes —O—, —OCH₂—, —CH₂O—, —CO—, —COO—, —OCO—, —O—CO—O—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C═C—, or a single bond.

MG²² denotes a mesogenic group, the general formula (II-1-b)

[Chem. 20]

-(A1-Z1)ᵣ₁-A2-Z2-A3- (II-1-b)

(wherein A1, A2, and A3 independently denote a 1,4-phenylene group, a 1,4-oyolohexylene group, a 1,4-cyclohexenyl group, a.tetrahydropyran-2,5-diyl group, a 1,3-dioxane-2,5-diyl group, a tetrahydrothiopyran-2,5-diyl group, a 1,4-bicyclo (2,2,2) octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms, and A1, A2, and A3 preferably independently denote a 1,4-phenylene group, a 1,4-cyclohexylene group, or a 2,6-naphthylene group, each optionally having the substituent.

R²¹ more preferably denotes a hydrogen atom, a halogen atom (a fluorine atom, a chlorine atom, a bromine atom, or an iodine atom), a cyano group, a linear or branched alkyl group having 1 to 8 carbon atoms, or a linear or branched alkenyl group having 1 to 8 carbon atoms, one —CH₂— or two or more nonadjacent —CH₂— groups in the alkyl group and the alkenyl group are independently optionally substituted with —O—, —CO—, —COO—, —OCO—, —O—CO—O—, —CH═CH—COO—, —CH═CH—OCO—, —COO—CH═CH—, —OCO—CH═CH—, —CH═CH—, or —C═C—, one or two or more hydrogen atoms of the alkyl group and the alkenyl group are independently optionally substituted with a halogen atom (a fluorine atom, a chlorine atom, a bromine atom, or an iodine atom) or a cyano group, and the plurality of substituents, if present, may be the same or different.

Examples of the general formula (II-1) include, but are not limited to, the compounds represented by the following general formulae (II-1-1) to (II-1-4).

[Chem. 21]

P²²-(Sp²²-X²²)_{q1}-A2-Z2-A3-R²¹ (II-1-1)

P²²-(Sp²²-X²²)_{q1}-A11-Z11-A2-Z2-A3-R21 (II-1-2)

P²²-(Sp²²-X²²)_{q1}-A11 -Z11-A12-Z12-A2-Z2-A3-R²¹ (II-1-3)

P²²-(Sp²²-X²²)_{q1}-A11-Z11-A12-Z12-A13-Z13-A2-Z2-A3-R²¹ (II-1-4)

In the formulae, P²², Sp²², X²², q1, and R²¹ are the same as defined in the general formula (II-1),

A11, A12, A13, A2, and A3 are the same as A1 to A3 defined in the general formula (II-1-b) and may be the same or different,

Z11, Z12, Z13, and Z2 are the same as Z1 to Z3 defined in the general formula (II-1-b) and may be the same or different, and

examples of the compounds represented by the general formulae (II-1-1) to (II-1-4) include, but are not limited to, the compounds represented by the following formulae (II-1-1-1) to (II-1-1-26).

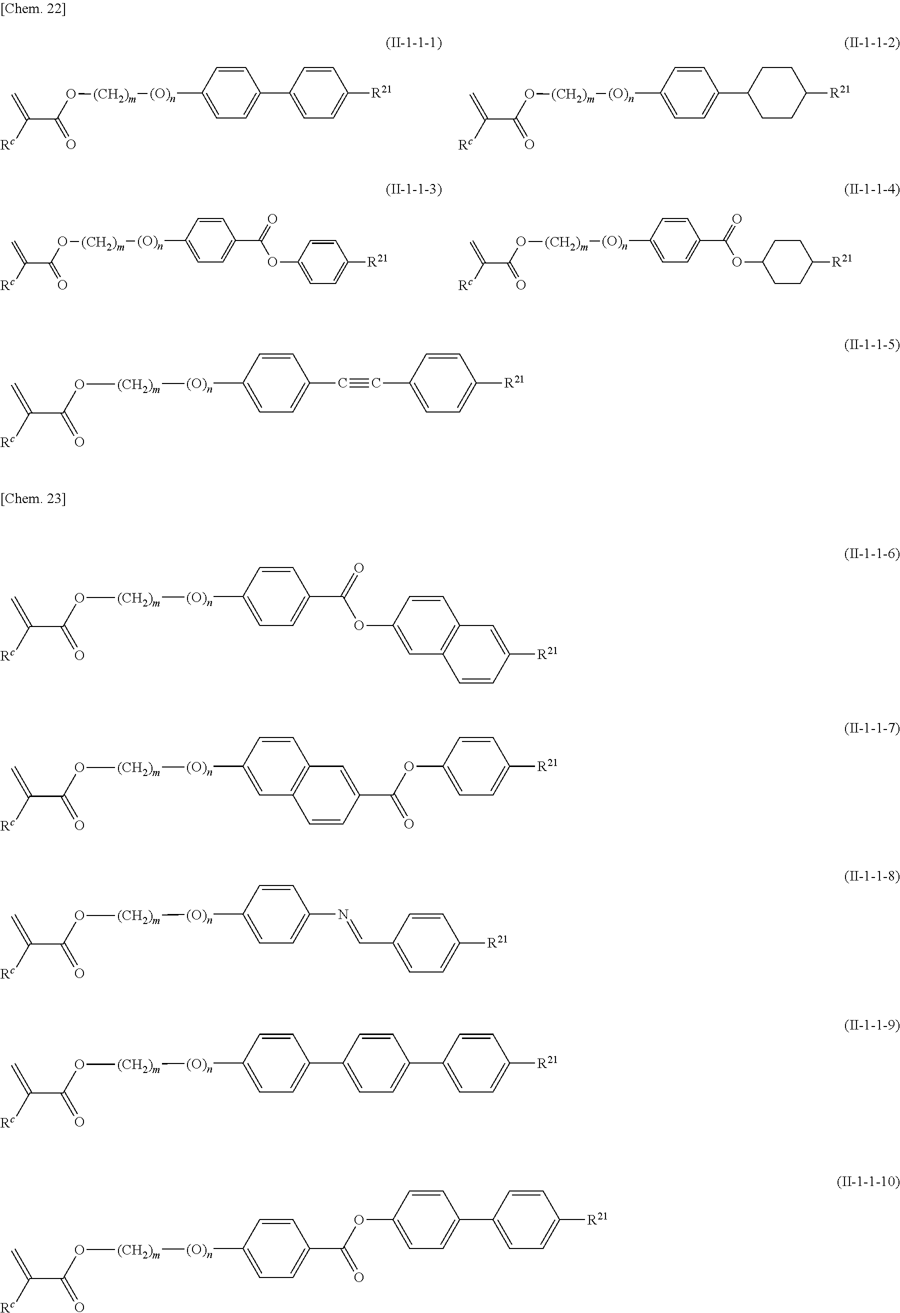

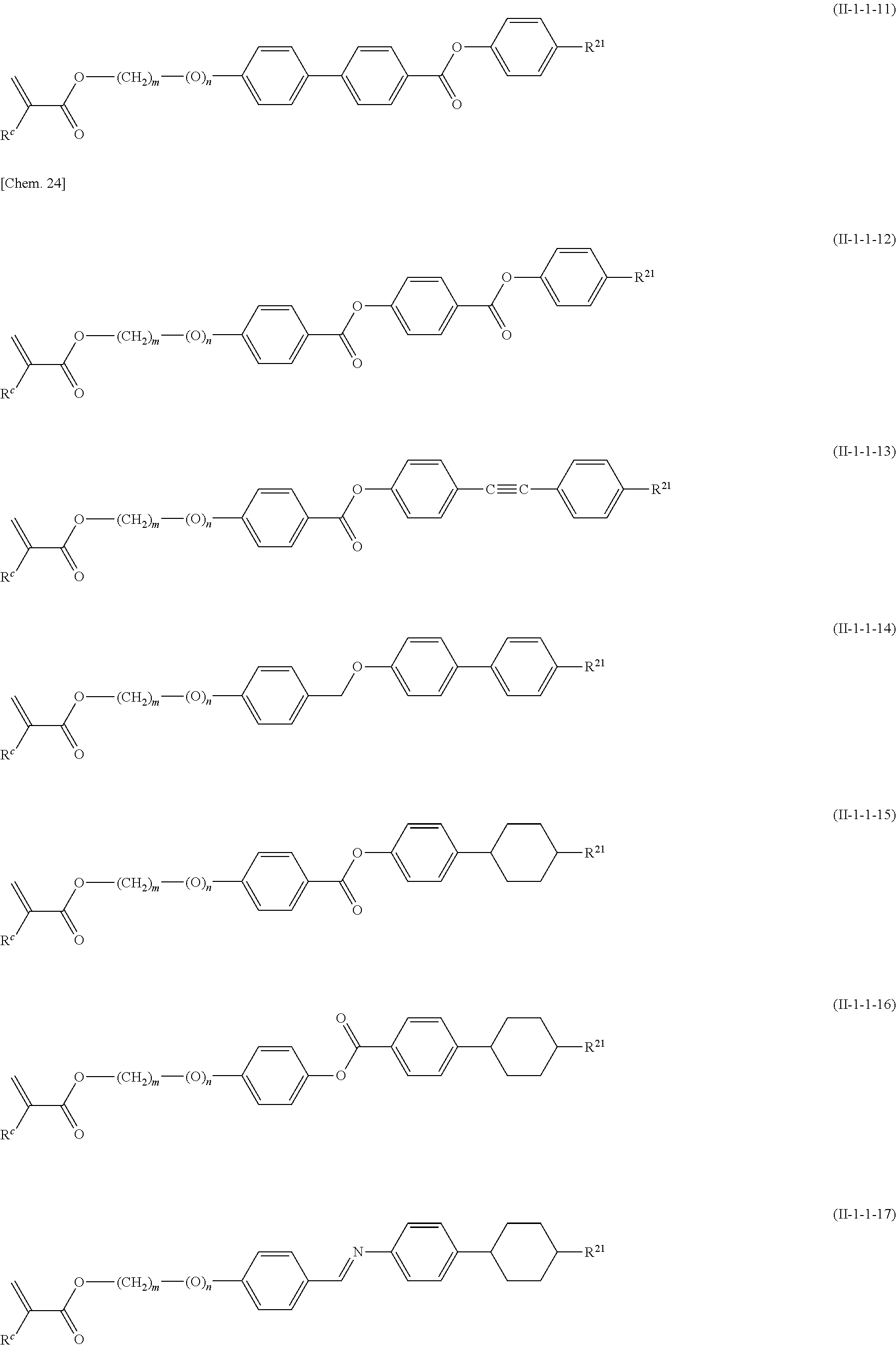

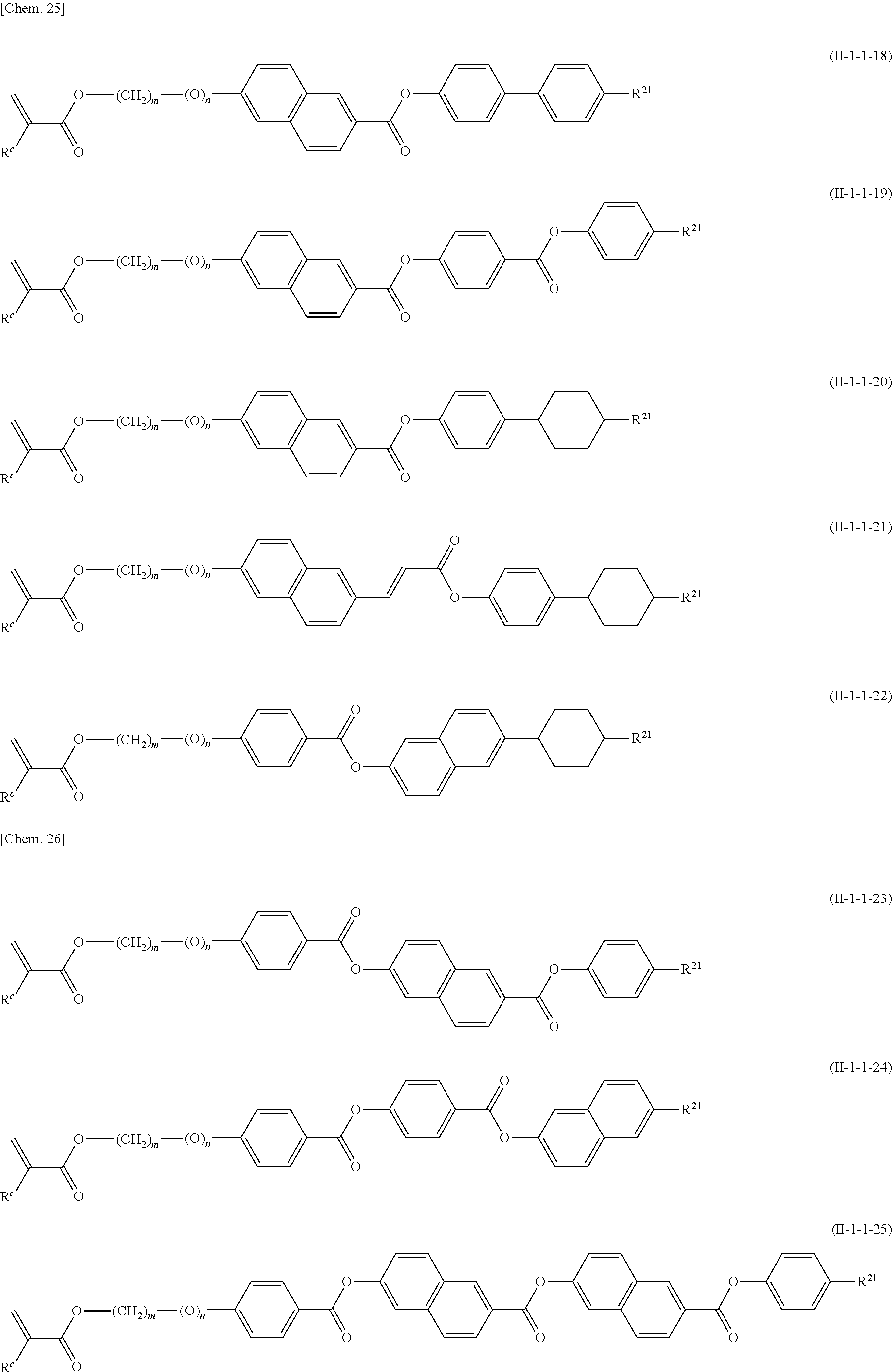

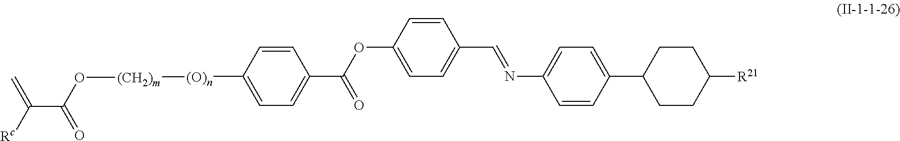

In the formulae, R^{c} denotes a hydrogen atom or a methyl group, m denotes an integer in the range of 0 to 18, n is 0 or 1, R²¹ is the same as defined in the general formulae (II-1-1) to (II-1-4), and R²¹ preferably denotes a hydrogen atom, a halogen atom (a fluorine atom, a chlorine atom, a bromine atom, or an iodine atom), a cyano group, a linear alkyl group having 1 to 6 carbon atoms, or a linear alkenyl group having 1 to 6 carbon atoms, one —CH₂— of the linear alkyl group and the linear alkenyl group being optionally substituted with —O—, —CO—, —COO—, or —OCO—.

The cyclic group may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenvloxy group having 2 to 8 carbon atoms, alkenoyl group having 2 to 8 carbon atoms, and/or alkenoyloxy group having 2 to 8 carbon atoms.

The total amount, of the monofunctional polymerizable liquid crystal compound(s) having one polymerizable functional group in the molecule preferably ranges from 0% to 55% by mass, more preferably 0% to 50% by mass, particularly preferably 0% to 45% by mass, of the total amount of the polymerizable liquid crystal compound (I), the polymerizable liquid crystal, compound (II), and the chiral compound (III) in the polymerizable cholesteric liquid crystal composition. The upper limit is preferably 50% or less by mass, more preferably 40% or less by mass, in terms of the curability of a coating film to be formed.

A polymerizable cholesteric liquid crystal composition according to the present invention preferably contains two or more of these polymerizable liquid crystal compounds and contains as essential components at least one of the polymerizable liquid crystal compounds having one polymerizable functional group in the molecule and at least one of the polymerizable liquid crystal compounds having two polymerizable functional groups in the molecule. In particular, a mixture of at least one polymerizable liquid crystal compound having one polymerizable functional group in the molecule selected from (II-1-2) to (II-1-4) and at least one polymerizable liquid crystal compound having two polymerizable functional groups in the molecule selected from (I-1-2) to (I-1-4) is particularly preferred.

The total amount, of the polymerizable liquid crystal compound(s) having one polymerizable functional group in the molecule and the polymerizable liquid crystal, compound(s) having two polymerizable functional groups in the molecule preferably ranges from 60% to 100% by mass, particularly preferably 70% to 100% by mass, of the total amount of polymerizable liquid crystal compounds in the polymerizable choiesteric liquid crystal composition.

### (Other Liquid Crystal Compounds)

A compound having no polymerizable group and having a mesogenic group may be added to a liquid crystal composition according to the present invention. Examples of such a compound include compounds for use in common liquid crystal devices, for example, super-twisted nematic (STN) liquid crystals, twisted nematic (TN) liquid crystals, and thin-film transistor (TFT) liquid crystals.

More specifically, the compound having no polymerizable functional group and having a mesogenic group is preferably a compound represented by the following general formula (5).

[Chem. 27]

R⁵¹-MG³-R⁵² (5)

A mesogenic group represented by MG³ may be a compound represented by the general formula (5-b).

[Chem. 28]

—Z0_{d}-(A1_{d}-Z1_{d})ₙₑ-A2_{d}-Z2_{d}-A3_{d}-Z3_{d}- (5-b)

(wherein A1², A2^{d}, and A3^{d} independentiy denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo (2,2,2) octylene group, a decahydronaphthalene-2,6-diyl group, a pvridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4, 4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms,

Z0^{d}, Z1^{d}, Z2^{d}, and Z3^{d} independently denote —COO—, —OCO—, —CH₂CH₂—, —OCH₂—, —CH₂O—, —CH═CH—, —C═C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms and optionally having a halogen atom, or a single bond,

ne is 0, 1, or 2, and

R⁵¹ and R⁵² independently denote a hydrogen atom, a halogen atom, a cyano group, or an alkyl group having 1 to 18 carbon atoms, the alkyl group is optionally substituted with at least one halogen atom or CN, and one CH₂ group or nonadjacent two or more CH₂ groups in the alkyl group are independently optionally substituted with —O—, —S—, —NH—, —N(CH₃)—, —CO—, —COO—, —OCO—, —OCOO—, —SCO—, —COS—, or —C═C— without direct bonding of oxygen atoms)

Specific examples are described below. However, the present invention is not limited to these examples.

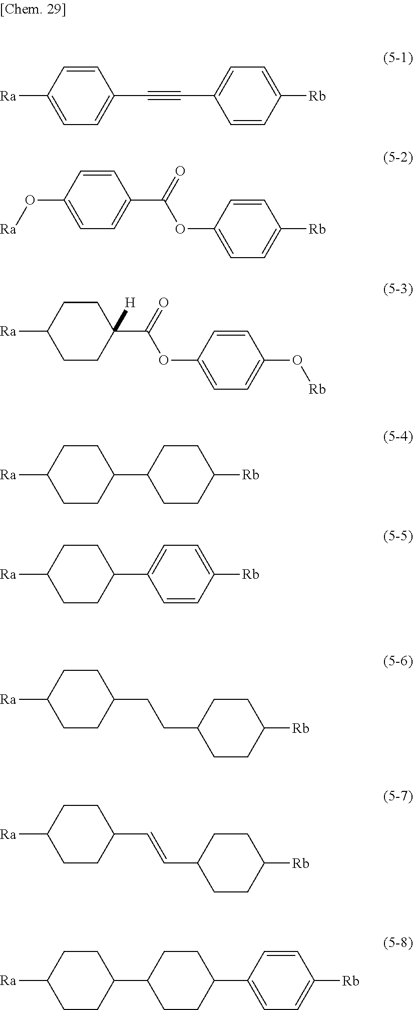

Ra and Rb independently denote a hydrogen atom, an alfcyl group having 1 to 6 carbon atoms, an alkoxy group having 1 to 6 carbon atoms, an alkenyl group having 1 to 6 carbon atoms, or a cyano group, and if these groups denote an alkyl group having 1 to 6 carbon atoms or an alkoxy group having 1 to 6 carbon atoms, all the groups may be unsubstituted or substituted with one or two or more halogen atoms.

The total amount of the compound having a mesogenic. group preferably ranges from 0% to 20% by mass, preferably 0% to 15% by mass, particularly preferably 0% to 10% by mass, of the total amount of polymerizable liquid crystal compounds in the polymerizable cholesteric liquid crystal composition.

### (Chiral Compound)

A polymerizable cholesteric liquid crystal composition according to the present invention contains a chiral compound (III), which may or may not have liquid crystallinity.

The chiral compound in the present invention preferably has one or more polymerizable functional groups. The polymerizable chiral compound preferably has one or more polymerizable functional groups. Examples of such a compound include polymerizable chiral compounds containing a chiral saccharide, such as isosorbide, isomannitol, or glucoside, and having a rigid moiety, such as a 1,4-phenylene group 1,4-cyclohexlene group, and a polymerizable functional group, such as a vinyl group, an acryloyl group, a (meth)acryloyl group, or a maleimide group, as described in Japanese Unexamined Patent Application Publication No. 11-193287, Japanese Unexamined Patent Application Publication No. 2001-158788, Japanese Unexamined Patent Application Publication (Translation of PCT Application) No. 2006-52669, and Japanese Unexamined Patent Application Publications No. 2007-269639, No. 2007-269640, and No. 2009-84178, polymerizable chiral compounds composed of a terpenoid derivative, as described in Japanese Unexamined Patent Application Publication No. 8-239666, polymerizable chiral compounds composed of a mesogenic group and a spacer having a chiral moiety, as described in NATURE, VOL. 35, pp. 467-469 (Nov. 30, 1995) and NATURE, VOL. 392, pp. 476-479 (Apr. 2, 1998), and polymerizable chiral compounds having a binaphthyl group, as described in Japanese Unexamined Patent Application Publication (Translation of PCT Application) No. 2004-504285 and Japanese Unexamined Patent Application Publication No. 2007-248945. Among others, chiral compounds with high helical twisting power (HTP) are preferred in a polymerizable cholesteric liquid crystal composition according to the present invention.

The amount of the polymerizable chiral compound needs to be adjusted for the helical twisting power of the compound and preferably ranges from 2% to 25% by mass, more preferably 2% to 20% by mass, still more preferably 2% to 15% by mass, particularly preferably 2% to 15% by mass, of the total amount of the polymerizable .liquid crystal compound (I), the polymerizable liquid crystal compound (II), and the chiral compound (III) in the polymerizable cholesteric liquid crystal composition.

The general formula of the chiral compound includes, but is not limited to, the general formulae (III-1) to (III-4).

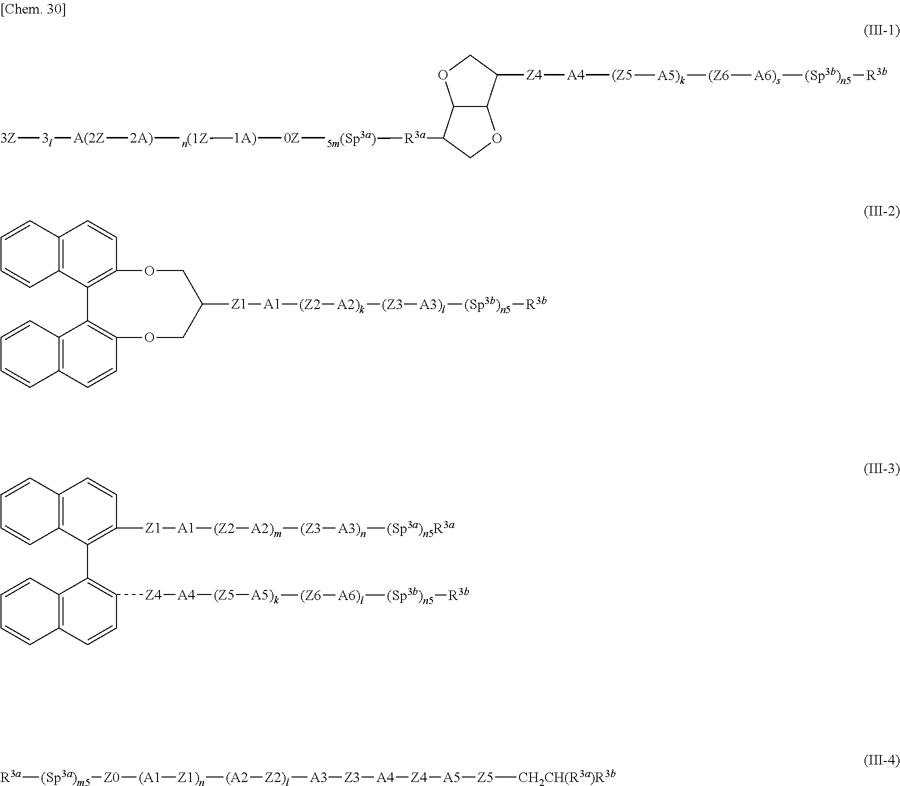

In the formulae, Sp^{3a} and Sp^{3b} independently denote an alkylene group having 0 to 18 carbon atoms, the alkylene group is optionally substituted.with one or more halogen atoms, CN groups, or alkyl groups having a polymerizable functional group, and having 1 to 8 carbon, atoms, and one CH₂ group or nonadjacent two or more CH₂ groups .in the alkyl group are optionally substituted with —O—, —S—, —NH—, —N(CH₃)—, —CO—, —COO—, —OCO—, —OCOO—, —SCO—, —COS—, or —C═C— without direct bonding of oxygen atoms,

A1, A2, A3, A4, and A5 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, n, l, and k are independently 0 or 1, and 0≤n+l+k≤3,

Z0, Z1, Z2, Z3, Z4, Z5, and Z6 independently denote —COO—, —OCO—, —CH₂CH₂—, —OCH₂—, —CH₂O—, —CH═CH—, —C═C—, —CH═CHCOO—, —OCOCH—CH—, —CH₂CH₂,COO—, —CH₂CH₂OCO—, —COOCH₂CH₂—, —OCOGH₂CH₂—, —CONH—, —NHCO—, an alkyl .group having 2 to 10 carbon atoms and optionally having ;a halogen atom, or a single bond,

n5 and m5 are independently 0 or 1,

R^{3a} and R^{3b} denote a hydrogen atom, a halogen atom, a cyano group, or an alkyl group having 1 to 18 carbon atoms, the alkyl group is optionally substituted with at least one halogen atom or CN, and one CH₂ group or nonadjacent two or more CH₂ groups in the alkyl group are independently optionally substituted with —O—, —S—, —NH—, —N(CH₃)—, —CO—, —COO—, —OCO—, —OCOO—, —SCO—, —COS—, or —C═C— without direct bonding of oxygen atoms,

or R^{3a} and R^{3b} the general formula (III-a)

[Chem. 31]

-P^{3a} (III-a)

(wherein P^{3a} denotes a polymerizable functional group)

P^{3a} preferably denotes a substituent selected from the polymerizable groups represented by the following formulae (P-1) to (P-20).

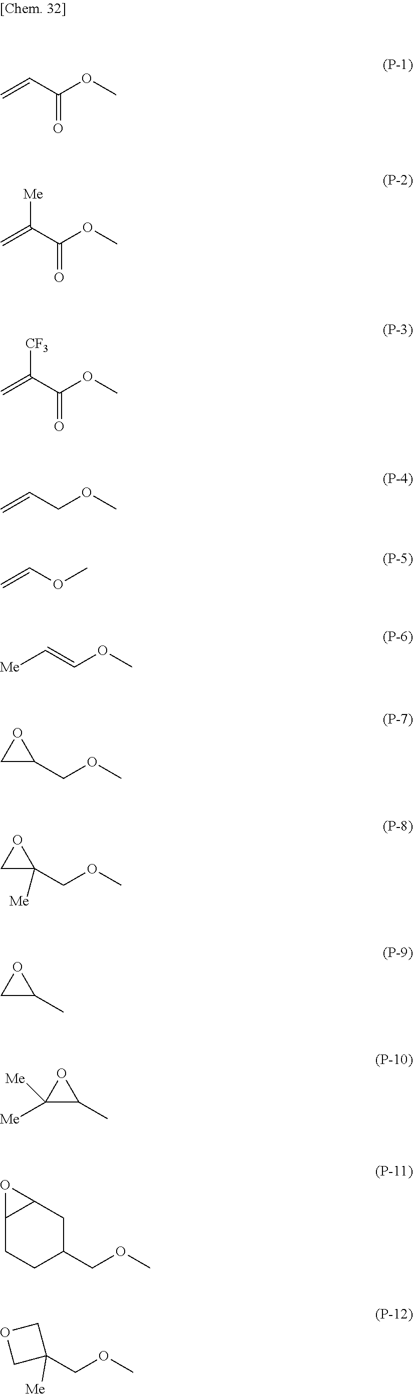

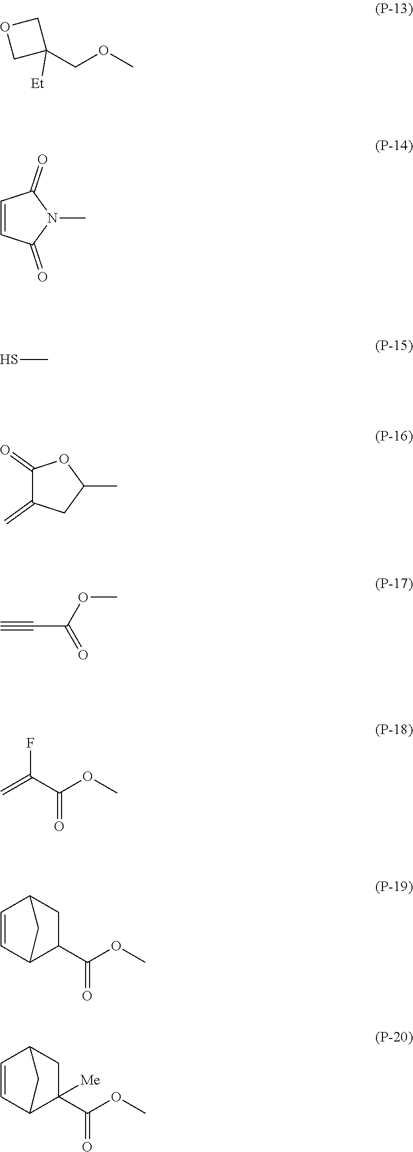

Among these polymerizable functional groups, in terms of high polymerization reactivity and storage stability, the formula (P-1) or the formula (P-2), (F-7), (p-12), or (P-13) is preferred, and the formula (P-1), (P-7), or (P-22) is more preferred.

Specific examples of the chiral compound include, but are not limited to, the compounds (III-5) to (III-46).

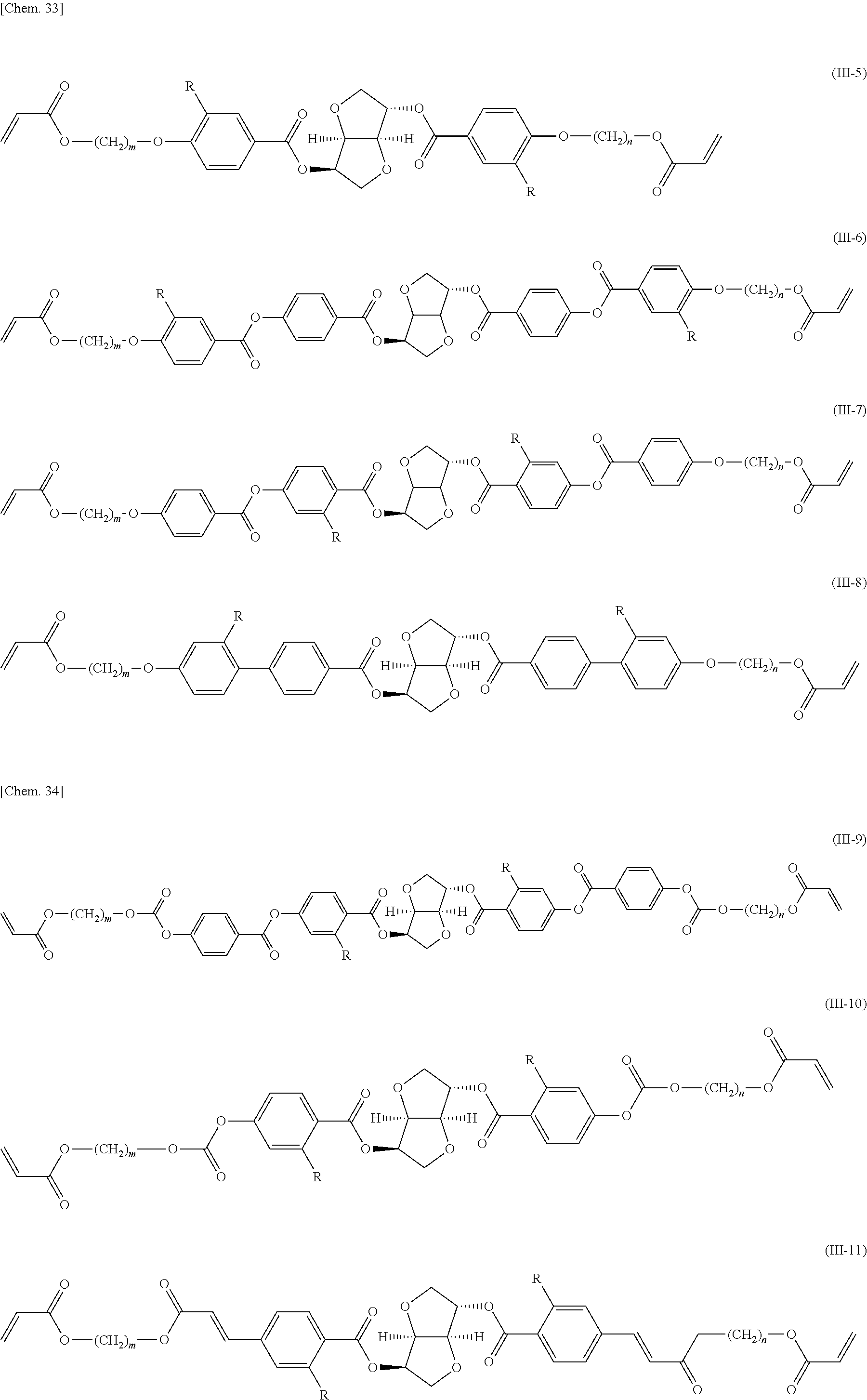

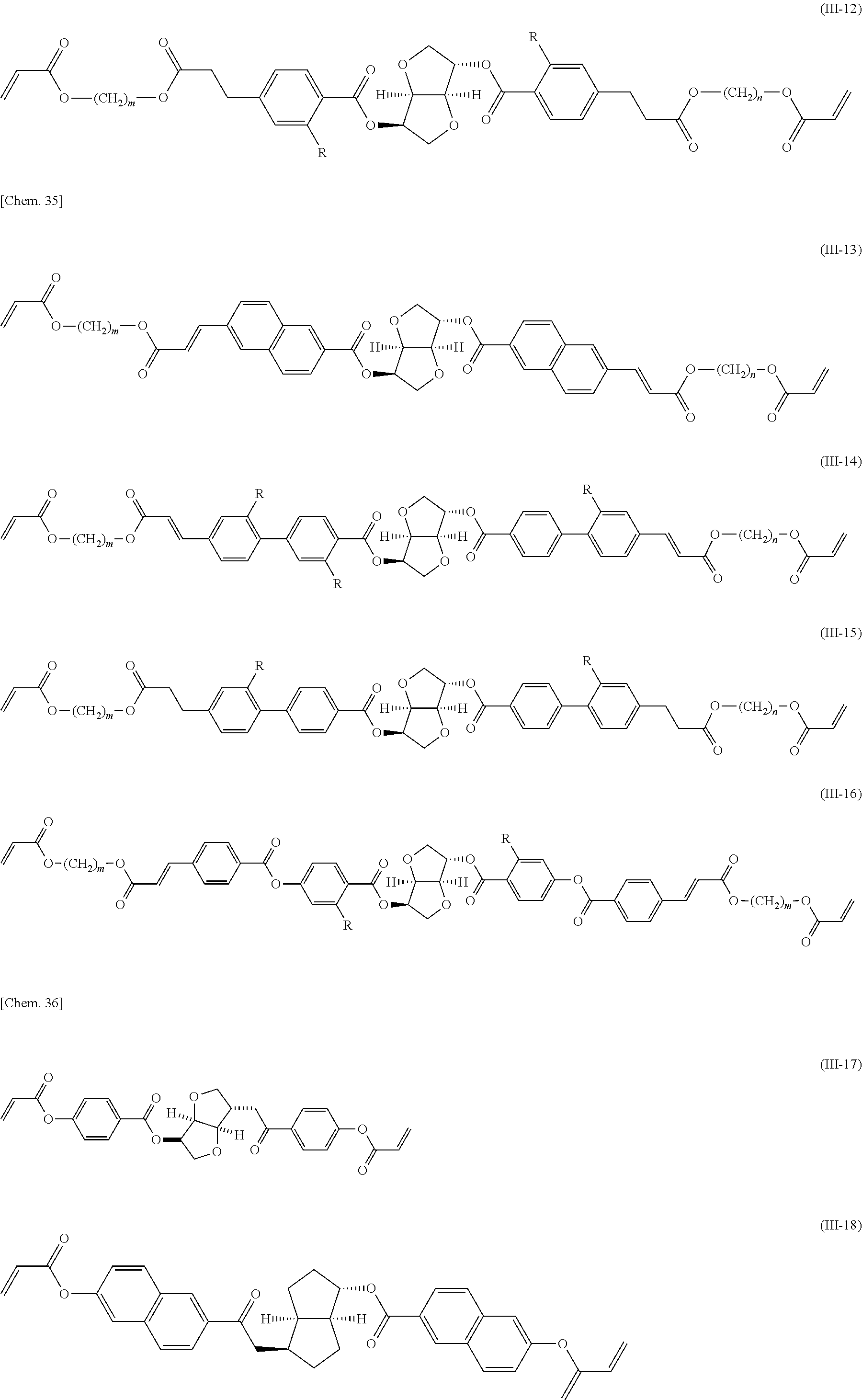

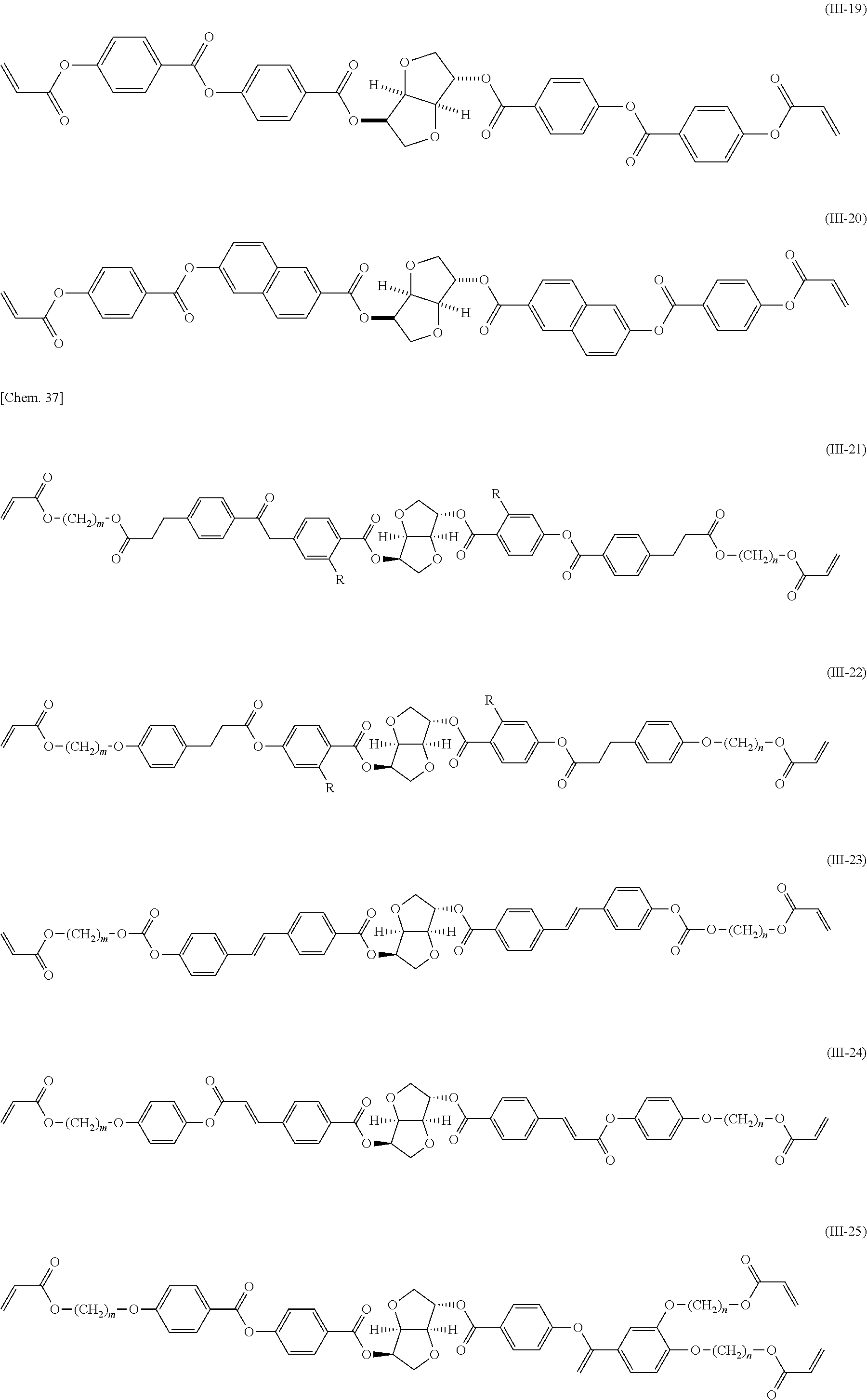

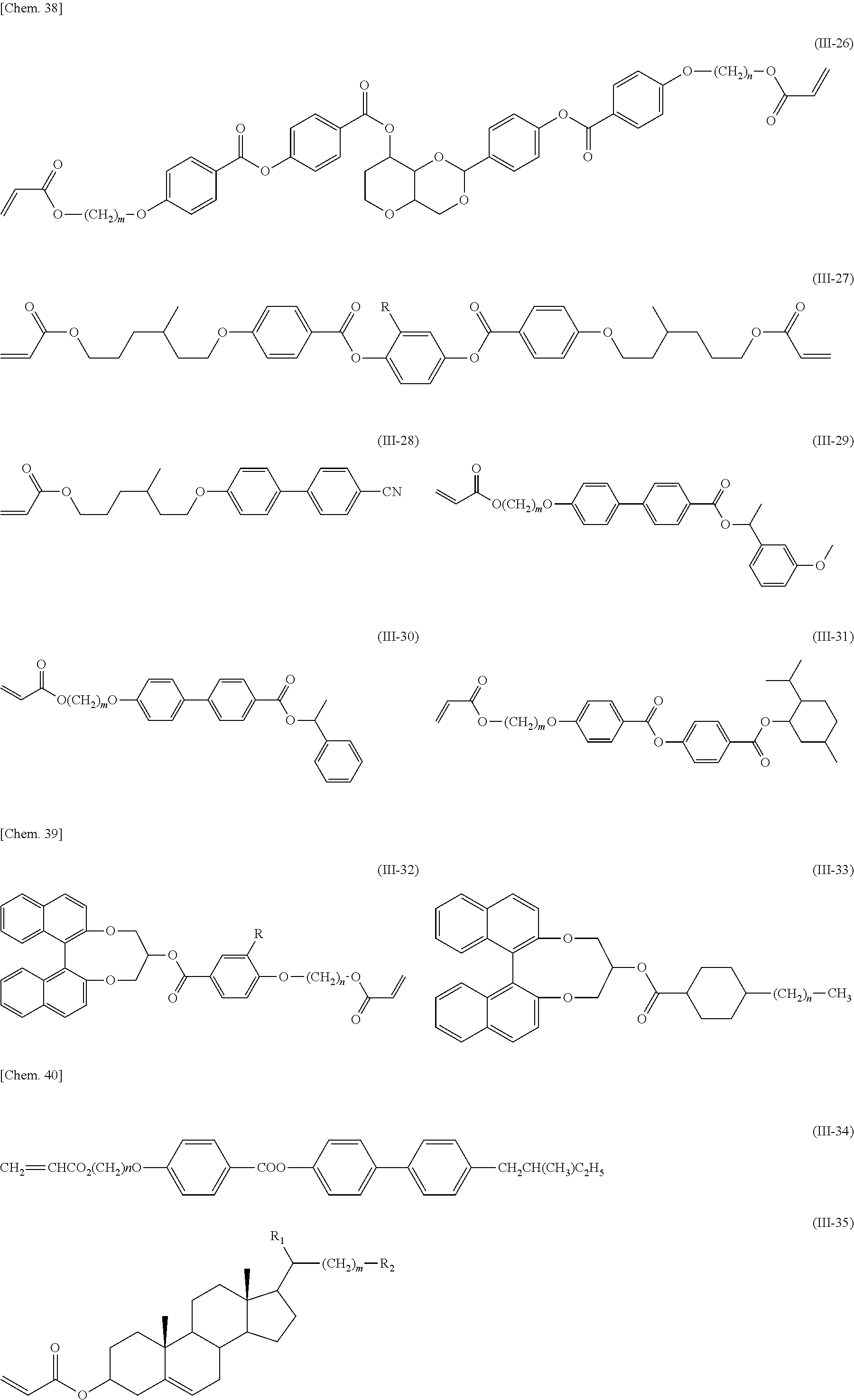

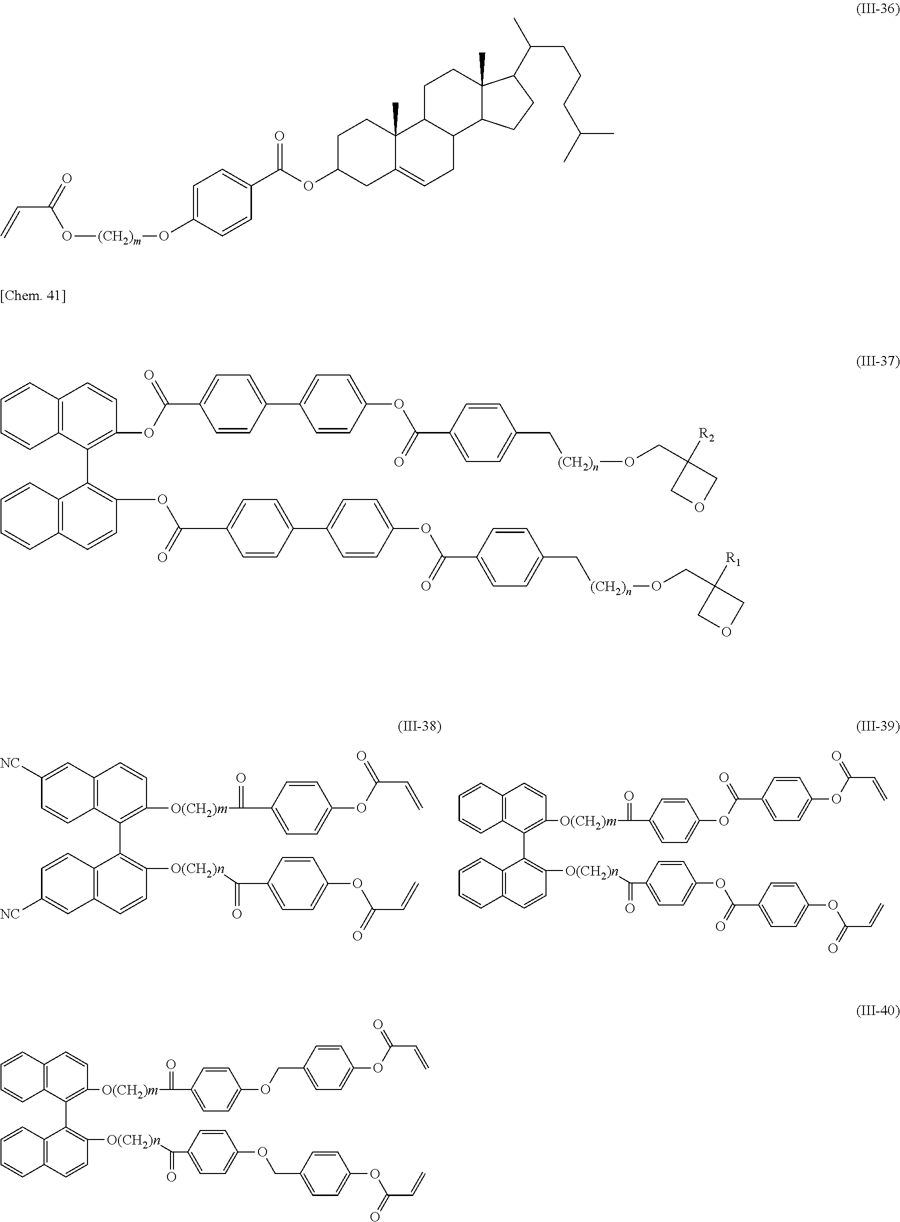

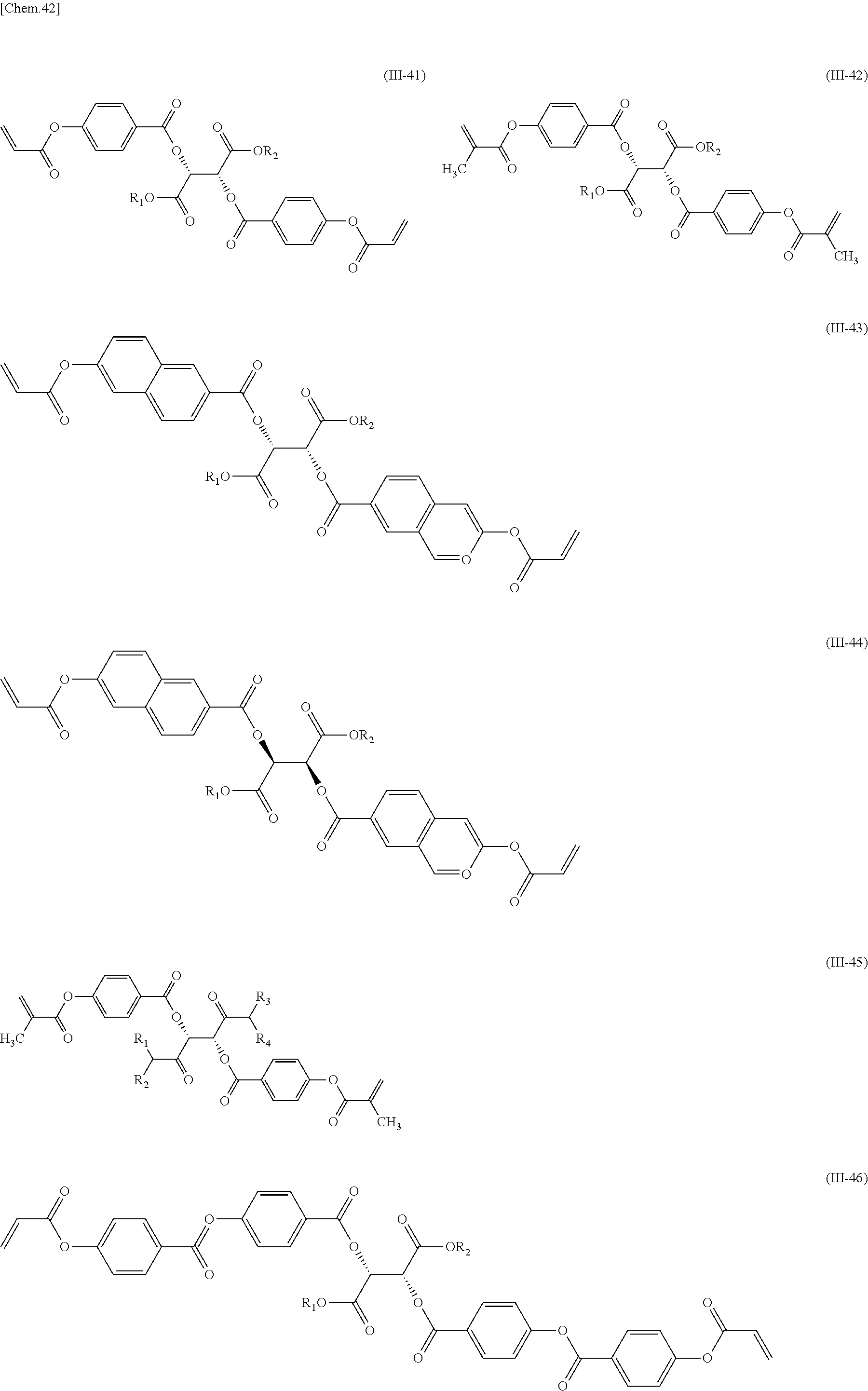

(In the formulae, m and n independently denote an integer in the range of 1 to 18, and R and R₁ to R4 independently denote a hydrogen atom, an alkyl group having 1 to 6 carbon atoms, an alkoxy group having 1 to 6 carbon atoms, a carboxy group, or a cyano group. If these groups denote an alkyl group having 1 to 6 carbon atoms or an alkoxy group having 1 to 6 carbon atoms, all the groups may be unsubstituted or substituted with one or two or more halogen atoms.)

### (Polymerizable Discotic Compound)

A polymerizable liquid crystal composition according to the present invention may contain a polymerizable discotic compound, which may or may not have liquid crystallinity, other than the polymerizable compound represented by the general formula (II).

The polymerizable discotic compound in the present invention preferably has one or more polymerizable functional groups. Examples of such a compound include polymerizable compounds as described in Japanese Unexamined Patent Application Publications No. 7-281028, No. 7-287120, No. 7-333431, and No. 8-27284.

The amount of the polymerizable discotic compound needs to be appropriately adjusted and preferably ranges from 0% to 10% by mass of the amount of the polymerizable composition.

The general formula of the. polymerizable discotic compound includes, but is not limited to, the general formulae (4-1) to (4-3).

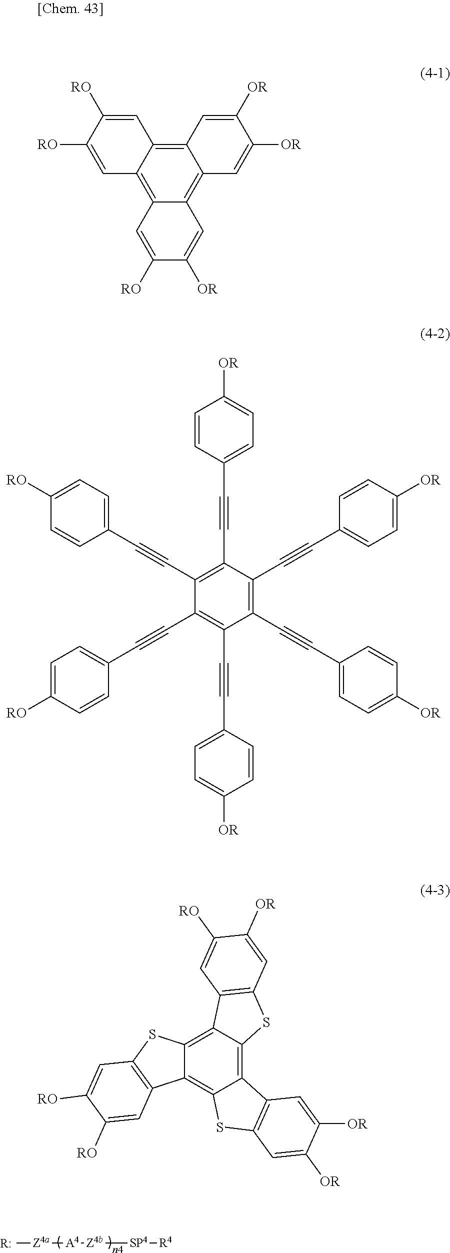

In the formulae, Sp⁴ denotes an alkylene group having 0 to 18 carbon atoms, the alkylene group is optionally substituted with one or more halogen atoms, CN groups, or alkyl groups having -a.polymerliable functional group and having 1 to 8 carbon atoms, and one CH₂ group or nonadjaeent two or more CH₂ groups in the alkyl group are optionally substituted with —O—, —S—, —NH—, —N(CH₃)—, —CO—, —COO—, —OCO—, —OCOO—, —SCO—, —COS—, or —C═C— without direct bonding of oxygen atoms,

A⁴ denotes a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group,

n5 is 0 or 1,

Z^{4a} denotes —CO—, —CH₂ CH₂—, —CH₂O—, —CH═CH—, —CH═CHCOO—, —CH₂CH₂COO—, —CH₂CH₂OCO—, —COCH₂CH₂—, an alkyl group having 2 to 10 carbon atoms and optionally having a halogen atom, or a single bond,

Z^{4b} denotes; —COO—, —OCO—, —OCH₂—, —CH₂O—, —CH═CH—, —C═C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, —OCOO—, an alkyl group having 2 to 10 carbon atoms and optionally having a halogen atom, or a single bond,

R4 denotes a hydrogen atom, a halogen atom, a cyano group, or an alkyl group having 1 to 18 carbon atoms, the alkyl group is optionally substituted with at least one halogen atom or CN, and one CH₂ group or nonadjacent two or more CH₂ groups in the alkyl group are independently optionally substituted with —O—, —S—, —NH—, —N(CH₃)—, —CO—, —COO—, —OCO—, —OCOO—, —SCO—, —COS—, or —C═C— without direct bonding of oxygen atoms,

R⁴ the general formula (4-a)

[Chem. 44]

-P₄ₐ (4-a)

(wherein P^{4a} denotes a polymerizable functional group, and Sp^{3a} has the same meaning as Sp¹)

P^{4a} preferably denotes a substituent selected from the polymerizable groups represented by the following formulae (P-1) to (P-20).

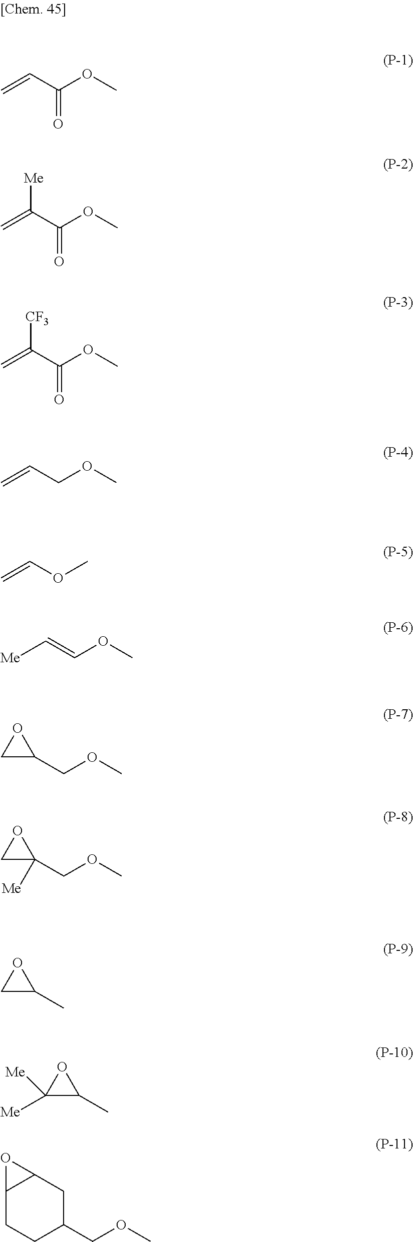

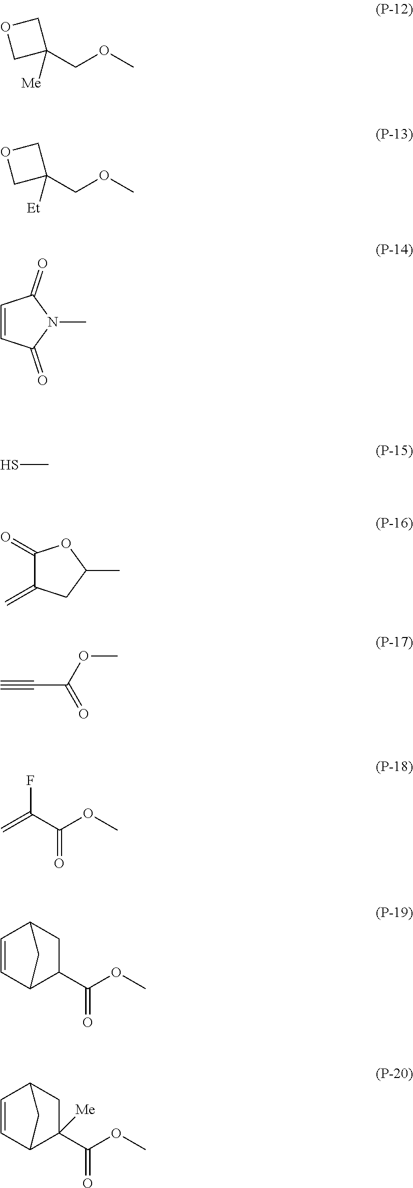

Among these polymerizable functional groups, in terms of high polymerization reactivity and storage stability, the formula (P-1) or the formula (P-2), (P-7), (P-12), or (P-13) is preferred, and the formula (P-1), (P-7), or (P-12) is more preferred.

Specific examples of the polymerizable discotic compound include, but are not limited to, the compounds (4-4) to (4-8)

### (Polymerization Initiator)

### (Photopolymerization Initiator)

A polymerizable liquid crystal composition according to the present invention preferably contains a photopolymerization initiator. A polymerizable liquid crystal composition according to the present invention preferably contains at least one photopolymerization initiator. Specific examples include “Irgacure 651”, “Irgacure 184”, “Darocur 1173”, “Irgacure 907”, “Irgacure 127”, “Irgacure 369”, “Irgacure 379”, “Irgacure 819”, “Irgacure 2959”, “Irgacure 1800”, “Irgacure 250”, “Irgacure 754”, “Irgacure 784”, “Irgacure OXEOI”, “Irgacure OXE02”, “Lucirin TPO”, “Darocur 1173”, and “Darocur MBF” manufactured by BASF, “Esacure 1001M”, “Esacure KIP150”, “Speedcure BEM”, “Speedcure EMS”, “Speedcure MBP”, “Speedcure PBS”, “Speedcure ITX”, “Speedcure DETX”, “Speedcure EBD”, “Speedcure MBB”, and “Speedcure BP” manufactured by LAMBSON, “Kayacure DMBI” manufactured by Nippon Kayaku Co., Ltd., “TAS-A” manufactured by Nihon SiberHegner (the present DKSH), “Adeka Optomer SP-152”, “Adeka Optomer SP-170”, “Adeka Optomer N-1414”, “Adeka Optomer N-1606”, “Adeka Optomer N-1717”, and “Adeka Optomer N-1919” manufactured by Adeka Corporation, “Cyracure UVI-6990”, “Cyracure UVI-6974”, and “Cyracure UVI-6992” manufactured by UCC., “Adefca Optomer S.F-150, SP-152, SP-170, SP-172” manufactured by Adeka Corporation, “Photoinitiator 2074” manufactured by Shodia., “Trgacure 250” manufactured by BASF, “UV-93SGC” manufactured by GE Silicones, and “DTS-102” manufactured by Midori Kagaku Co., Ltd.

The amount of the photopolymerization initiator to be used preferably ranges from 0.1 to 7 parts by mass, more preferably 0.5 to 6 parts by mass, still more preferably 1 to 6 parts by mass, particularly preferably 3 to 6 parts by mass, per 100 parts by mass of the polymerizable liquid crystal compound (I), the polymerizable liquid crystal compound (II), and the chiral compound (III) in total in the polymerizable cholesteric liquid crystal composition. These may be used alone or in combination. A sensitizer may also be added.

### (Thermal Polymerization Initiator)

A polymerizable cholesteric liquid crystal composition according to the present invention may contain a thermal polymerization initiator as well as a photopolymerization initiator. The thermal polymerization initiator may be a known thermal polymerization initiator, for example, an organic peroxide, such as methylacetoacetate peroxide, cumene hydroperoxide, benzoyl peroxide, bis(4-t-butylcyclohexyl)peroxydicarbonate, t-butylperoxybenzoate, methyl ethyl ketone peroxide, 1,1-bis(t-hexylperoxy)3,3,5-trimethylcyclohexane, p-pentahydroperoxide, t-butylhydroperoxide, dicumyl peroxide, isobutyl peroxide, di(3-methyl-3-methoxybutyl)peroxydicarbonate, or 1,1-bis (t-butylperoxy)cyclohexane, an asonitrile compound, such as 2,2′-azobisisobutyronitrile or 2,21-azobis(2,4-dimethylvaleronitrile), an azoamidine compound, such as 2,2′-azobis(2-methyl-N-phenylpropionamidine) dihydrochloride, an azoamide compound, such as 2,2′azobis{2-methyl-N-[1,1-bis(hydroxymethyl)-2-hydroxyethyl]propionamide}, or an alkylazo compound, such as 2,2′azobis(2,4,4-trimethylpentane).

The amount of the thermal polymerization initiator to be used preferably ranges from 0.1 to 7 parts by mass, more preferably 0.3 to 6 parts by mass, particularly preferably 0.5% to 5% by mass, per 100 parts by mass of the polymerizable liquid crystal compound (I), the polymerizable liquid crystal compound (II), and the chi.rai compound (III) in total in the polymerizable cholesteric liquid crystal composition. These may be used alone or in combination.

### (Compound Having Repeating Unit)

A polymerizable cholesteric liquid crystal composition according to the present invention preferably contains a non-silicon compound (V) having a repeating unit. As described later, when a polymerizable cholesteric liquid crystal composition is used to form an optically anisotropic body, and a protective layer for protecting the optically anisotropic body is formed on the optically anisotropic body film, a non-silicon compound (V) having a repeating unit or a solution containing a non-silicon compound (V) having a repeating unit is used to form the protective layer. Thus, the polymerizable liquid crystal composition does not necessarily contain the non-silicon compound (V) having a repeating unit. A polymerizable cholesteric liquid crystal composition according to the present invention containing a non-silicon compound (V) having a repeating unit can be used to form an optically anisotropic body with good alignment and high heat resistance.

In the present invention, the non-silicon compound (V) having a repeating unit may be an acrylic compound and/or a methacrylic compound (V-1) each having a repeating unit. The acrylic compound and/or methacrylic compound (V-1) each having a repeating unit may be any monomer having a repeating unit, any polymer having a repeating unit, any copolymer having a repeating unit produced from (meth)acrylic compounds, or any copolymer having a repeating unit produced from a (meth)acrylic compound and another polymerizable compound. The acrylic compound and/or methacrylic compound (V-1) each having a repeating unit preferably has a molecular weight Mw of 200000 or less and Mn of 400000 or less so as to be dissolved in a solvent of a polymerizable cholesteric liquid crystal composition. Specific examples of the acrylic compound and/or methacrylic compound (V-1) include the following formulae (V-1-1) to (V-1-15).

Copolymer of 2-ethylhexyl aerylate and butyl acrylate (V-1-1)

Copolymer of butyl acrylate and butyl methacrylate (V-1-2)

2-ethylbutyl acrylate polymer (V-1-3)

Butyl acrylate polymer (V-1-4)

Ethyl acrylate polymer (V-1-5)

2-ethylhexyl acrylate polymer (V-1-6)

1,9-nonanediol acrylate (V-1-7)

Poly(propylene glycol) diacrylate (V-1-8)

Benzyl acrylate polymer (V-1-9)

Copolymer of 2-ethylhexyl acrylate, butyl acrylate, and butyl methacrylate (V-1-10)

Copolymer of the following (V-a) and (V-b) (V-1-11)

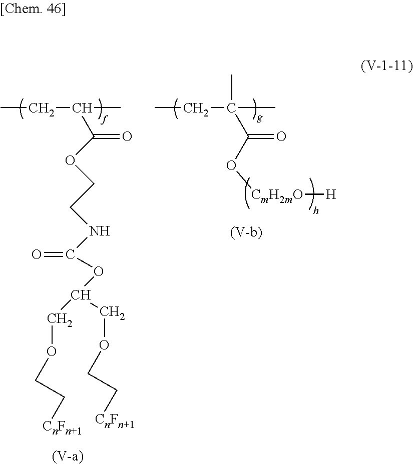

Copolymer of the following (V-c) and (V-d) (V-1-12)

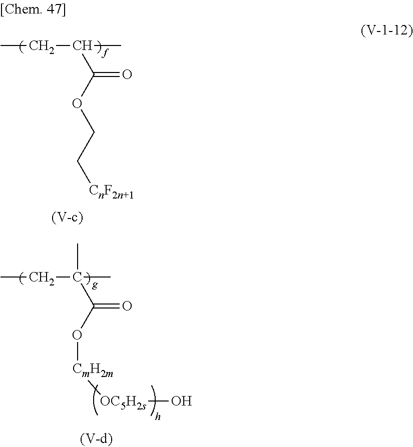

Phenyl glycidyl ether acrylafe polymer (V-1-13)

The following polymer (V-1-14)

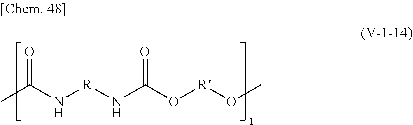

The following polymer (V-1-15)

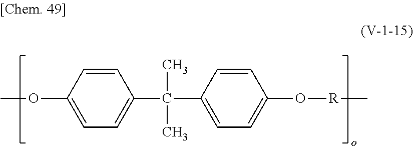

(In the formulae, f, g, l, and o independently denote an integer of 1 or more, f preferably ranges from 1.5 to: 50, g preferably ranges from 50 to 85, 1 preferably ranges1 from 1 to 20, and o preferably ranges from 1 to 20. Furthermore, n, h, m, and s independently denote an integer of 1 or more, n preferably ranges from 1 to 20, h preferably ranges from 1 to 20, m preferably ranges from 1 to 20, and s preferably ranges from 1 to 20. In the formulae, R and R′ independently denote a hydrocarbon group having 1 to 20 carbon atoms or an aromatic hydrocarbon, and the hydrogen atoms in the hydrocarbon group are optionally substituted with one or more halogen atoms.)

In the present invention, the non-silicon compound (V) having a repeating unit may be a compound having a repeating unit represented by the following general formula (V-2) and having a weight-average molecular weight of 100 or more.

[Chem. 50]

—(CR¹¹R¹²—CR¹³R¹⁴)— (V-2)

In the formula, R¹¹, R¹², R¹³, and R¹⁴ independently denote a hydrogen atom, a halogen atom, or a hydrocarbon group having 1 to 20 carbon atoms, and the hydrogen atoms in the hydrocarbon group are optionally substituted with one or more halogen atoms.

Preferred examples of the compound represented by the general formula (V-2) include polyethylene, polypropylene, polyisobutylene, paraffin, liquid paraffin, chlorinated polypropylene, chlorinated paraffin, and chlorinated liquid paraffin.

In the present invention, the non-silicon compound (V) having a repeating unit may be a polyimide compound and/or polyamide compound (V-3) each having a repeating unit represented by the following general formula. The polyimide compound and/or polyamide compound (V-3) each having a repeating unit may be any monomer having a repeating unit, any polymer having a repeating unit, or any copolymer having a repeating unit produced from a polyimide compound and/or a polyamide compound and another polymerizable compound. The polyimide compound and/or polyamide compound (V-3) each having a repeating unit preferably lias a molecular weight Mw of 200000 or less and Mn of 400000 or less so as to be dissolved in a solvent of a polymerizable cholesteric liquid crystal composition. Specific examples of the polyimide compound and/or polyamide compound (V-3) include the polymers represented by the following formulae (V-3-1) to (V-3-4).

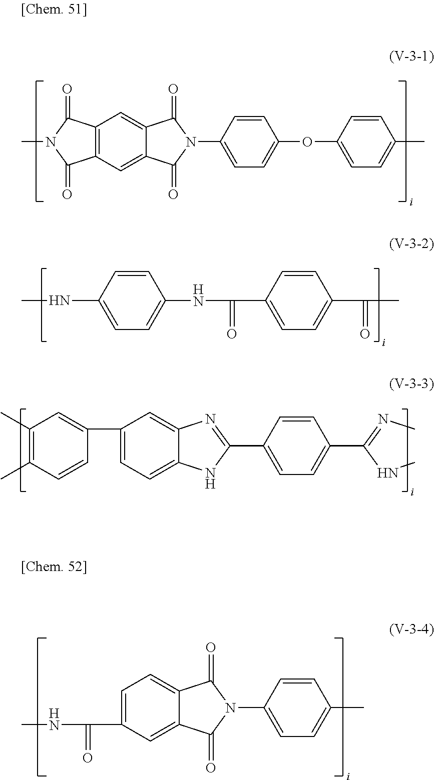

(wherein i denotes an integer of 1 or more, preferably 1 to 50)

The amount of the non-silicon compound (V) having a repeating unit to be used preferably ranges from 0.1 to 6 parts by mass, more preferably 0.1 to 5.5 parts by mass, particularly preferably 0.1% to 5% by mass, per 100 parts by mass of the polwrierizable liquid crystal compound (I), the polymerizable liquid crystal compound (II), and the chiral compound (III) in total in the polymerizable cholesteric liquid crystal composition. These may be used alone or in combination.

### (Organic Solvent)

An organic solvent may be added to a polymerizable cholesteric liquid crystal composition according to the present invention. The organic solvent is not particularly limited and is preferably an organic solvent that can easily dissolve a polymerizable liquid crystal compound and that can evaporate at a temperature of 100° C. or less. Examples of such a solvent include aromatic hydrocarbons, such as toluene, xylene, cumene, and mesitylene, ester solvents, such as methyl acetate., ethyl, acetate, propyl, acetate, and butyl acetate, ketone solvents, such as methyl ethyl ketone, methyl isobutyl ketone, cyclohexanone, and cyclopentanone, ether solvents, such as tetrahydrofuran, 1,2-dimethoxyethane, and anisole, amide solvents, such as N,N-dimethylformamide and N-methyl-2-pyrrolidone, and propylene glycol monomethyl ether acetate, diethylene glycol monomethyl ether acetate, γ-butyrolactone, and chlorobenzene. These may be used alone or in combination. At least one of ketone solvents, ether solvents, ester solvents, and aromatic hydrocarbon solvents is preferably used in terms of the stability of the solution.

A composition for use in the present invention can be applied to a substrate in the form of a solution in an organic solvent. The ratio of the organic solvent to a polymerizable cholesteric liquid crystal composition is not particularly limited provided that the application state does not significantly deteriorate. The total amount of organic solvent(s) preferably ranges from 10% to 95% by mass, more preferably 12% to 90% by mass, particularly preferably 15% to 85% by mass, of the polymerizable cholesteric liquid crystal composition.

For uniform dissolution, preferably, a polymerizable cholesteric liquid crystal composition is dissolved in an organic solvent by heating and stirring. The heating temperature in the heating and stirring is adjusted for the solubility of the composition in the organic solvent and preferably ranges from 15° C. to 110° C., more preferably 15° C. to 105° C., still more preferably 15° C. to 100° C., particularly preferably 20° C. to 90° C., in terms of productivity.

The addition of a solvent is preferably accompanied by mixing using a mixer. Specific examples of the mixer include dispersers, dispersing apparatuses with impeller blades, such as propellers and turbine blades, paint shakers, planetary mixers, shaking apparatuses, stirrers, shakers, and rotatory evaporators. Furthermore, ultrasonic irradiation apparatuses may also be used.

The rotational speed during the addition of the solvent is preferably adjusted for the type of mixer. To produce a uniform solution of the polymerizable liquid crystal composition, the rotational speed preferably ranges from 10 to 1000 rpm, more preferably 50 to 300 rpm, particularly preferably 150 to 600 rpm.

(Polymeri zation Inhibitor)

A polymerization inhibitor is preferably added to a polymerizable cholesteric liquid crystal composition according to the present invention. Examples of the polymerization inhibitor include phenolic, compounds, quinone compounds, amine compounds, throether compounds, and nitroso compounds.

Examples of the phenolic compounds include p-methoxyphenol, cresol, t-butylcatechol, 3,5-di-t-butyl-4-hydroxytoluene, 2.2′-methylenebis(4-ethyl-6-t-butylphenol), 2.2′-methylenebis(4-ethyl-6-t-butylphenol), 4.4′-thiobis(3-methyl-6-t-butylphenol), 4-methoxy-l-naphthol, and 4,4′-dialkoxy-2,2′-bi-1-naphthol.

Examples of the quinone compounds include hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, and diphenoquinone.

Examples of the amine compounds include p-phenylenediamine, 4-aminodiphenylamine, N.N′-diphenyl-p-phenylenediamine, N-i-propyl-N′-phenyl-p-phenylenediamine, N-(1.3-dimethylbutyl)-N′-phenyl-p-phenylenediamine, N.N′-di-2-naphthyl-p-phenylenediamine, diphenylamine, N-phenyl-β-naphthylamine, 4.4′-dicumyl-diphenylamine, and 4.4′-dioctyl-diphenylamine.

Examples of the thioether compounds include phenothiazine and distearyl thiodipropionate.

Examples of the nitroso compounds include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthol, N,N-dimethyl p-nitrosoaniline, p-nitrosociiphenylamine, p-nitrondimethylamine, p-nitron-N,S-diethylamine, N-nitrosoethanolamine, N-nitrosodi-n-butylaiaine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2,4.6-tri-tert-butylnitronbenzene, N-nitroso-N-methyl-p-toluenesulfonamide, N-nitroso-N-ethylurethane, N-nitroso-N-n-propylurethane, 1-nitroso-2-naphthol, 2-nitroso-1-naphthol, 1-nitroso-2-naphthol-3,6-sulfonic acid sodium, 2-nitroso-1-naphthol-4-sulfonic acid sodium, 2-nitroso-5-methylaminophenol hydrochloride, and 2-nitroso-5-methylaminophenol hydrochloride.

The amount of the polymerization inhibitor to be added preferably ranges from 0.01 to 1.0 parts by mass, more preferably 0.0.5 to 0.5 parts by mass, per 100 parts by mass of the polymerizable liquid crystal compound (I), the polymerizable liquid crystal, compound (II), and the chiral compound (III) in total in the polymerizable cholesteric liquid crystal composition.

### (Alignment Controlling Agent)

For cholesteric alignment (plane alignment) of a polymerizable liquid crystal compound, a polymerizable cholesteric liquid crystal composition according to the present invention may contain at least one alignment controlling agent for facilitating alignment. Examples of the alignment controlling agent include alkyl carboxylates, alkyl phosphates, alkyl sulfonates, fluoroalkyl carboxylates, fluoroalkyl phosphates, fluoroalkyl sulfonates, polyoxyethylene derivatives, fluoroalkylethylene oxide derivatives, poly(ethylene glycol) derivatives, alkylammonium salts, and fluoroalkylammonium salts. In particular, fluorosurfactants are preferred. Specific examples include “Megaface F-251”, “Megaface F-444”, “Megaface F-510”, “Megaface F-552”, “Megaface F-553”, “Megaface F-554”, “Megaface F-555”, “Megaface F-558”, “Megaface F-560”, “Megaface F-561”, “Megaface F-563”, “Megaface F-565”, “Megaface F-570”, “Megaface R-40”, “Megaface R-41”, “Megaface R-43”, and “Megaface R-94” (manufactured by DIG Corporation), and “FTX-218”(manufactured, by KEOS Co., Ltd.).

Examples of available alignment controlling agents include, but are not limited to, compounds represented by the following general formulae (5-1) to (5-4).

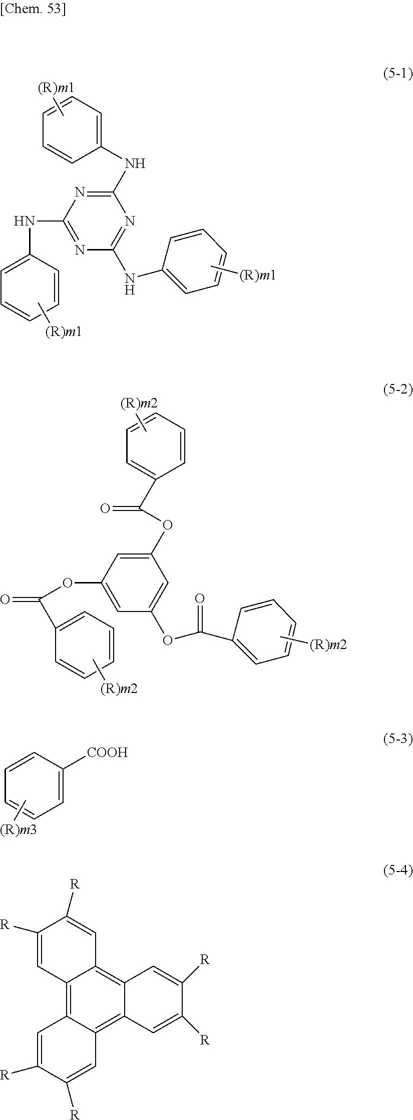

(In the formulae, R may be the same or different and denotes an alkoxy group having 1 to 30 carbon atoms and optionally substituted with a fluorine atom. In the formulae, m1, m2, and m3 independently denote an integer of 1 or more.)

### (Chain Transfer Agent)

A chain transfer agent is preferably added to a polymerizable cholesteric liquid crystal composition according to the present invention to improve the adhesion of an optically anisotropic body formed from the polymerizable cholesteric liquid crystal composition to a substrate. Examples of the chain transfer agent include aromatic hydrocarbons, halogenated hydrocarbons, such as chloroform, carbon tetrachloride, carbon tetrabromide, and bromotrichloromethane, and thiol compounds, such as monothiols, dithiols, trithiols, and tetrathiols. Aromatic hydrocarbons and thiol compounds are preferred. More specifically, the compounds represented by the following general formulae (8-1) to (8-12) are preferred.

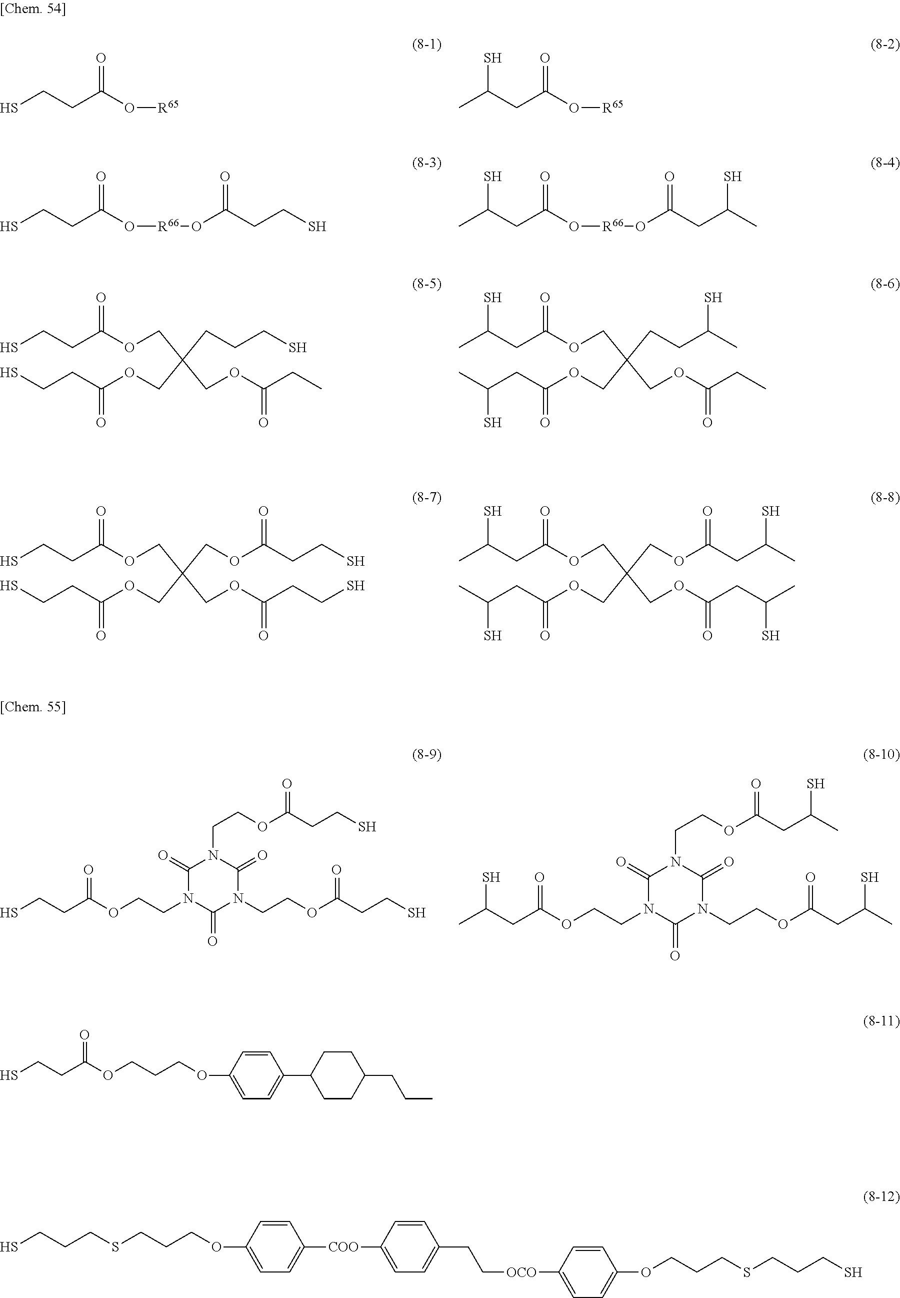

In the formulae, Rss denotes an alkyl group having 2 to 18 carbon atoms, the alkyl group may be linear or branched, one or more methylene groups in the alkyl group are optionally substituted with an oxygen atom, a sulfur atom, —CO—, —OCO—, —COO—, or —CH═CH— without direct bonding of oxygen atoms and sulfur atoms, R⁶⁶ denotes an alkylene group having 2 to 18 carbon atoms, and one or more methylene groups in the alkylene group are optionally substituted with an oxygen atom, a sulfur atom, —CO—, —OCO—, —COO—, or —CH═CH— without direct bonding of oxygen atoms and sulfur atoms.

The amount of the chain transfer agent to foe added preferably ranges from 0.5 to 10 parts by mass, more preferably 1.0 to 5.0 parts by mass, per 100 parts by mass of the polymerizable liquid crystal compound (I), the polymerizable liquid crystal compound (II), and the chiral compound (III) in total in the polymerizable cholesteric liquid crystal composition.

### (Other Additive Agents)

To adjust physical properties, additive agents, such as a polymerizable compound having no liquid crystallinity, a thixotropic agent, an ultraviolet absorber, an infrared absorber, an antioxidant, and a surface-treating agent, may be added for each purpose, provided that the alignment ability of liquid crystals is not significantly reduced.

### (Optically Anisotropic Body)

An optically anisotropic body according to the present invention is formed by applying a polymerizable cholesteric liquid crystal composition according to the present invention to a substrate with an alignment function, aligning the liquid crystal molecules of the polymerizable cholesteric liquid crystal composition according to the present invention while holding the nematic phase and the chiral smectic phase, and polymerizing the polymerizable cholesteric liquid crystal composition. A retardation film described below is one of the applications of an optically anisotropic body according to the present invention and is included in. the concept of the optically anisotropic body.

### (Retardation Film)

A retardation film according to the present invention is formed in the same manner as an optically anisotropic body according to the present invention. A liquid crystal compound forms a uniform continuous alignment state on a substrate and thereby constitutes a retardation film. A retardation film according to the present invention is synonymous with a retardation layer or a retardation coat.

A retardation film formed by aligning by coating and polymerizing a polymerizable cholesteric liquid crystal composition according to the present invention on a substrate may be a negative C plate or a biaxial plate.

The negative C plate is a retardation film in which the refractive index nx in the in-plane slow axis direction, the refractive index ny in the in-plane fast axis direction, and the refractive index nz in the thickness direction satisfy the relationship “nx=ny>nz”. The biaxial plate is a retardation film in which the refractive index nx in the in-plane slow axis direction, the refractive index ny in the in-plane fast axis direction, and the refractive index nz in the thickness direction satisfy the relationship “nx>ny>nz”.

A retardation film according to the present invention is applied in the form suitable for the intended use, such as a liquid crystal display, a display, an optical device, an optical component, a colorant, a security marking, a member for laser emission, an optical film, or a compensation film. A bonding agent or a bonding layer, an adhesive or an adhesive layer, and a protective film or a polarizing film may be stacked.

### (Patterned Retardation Film)

Like an optically anisotropic body according to the present invention, a patterned retardation film according to the present invention is a laminate of a substrate, an alignment film, and a polymer of a polymerizable cholesteric liquid crystal composition. The patterned retardation film is patterned in a polymerization process so as to have a partially different phase difference. The patterning may be in different directions as in grid patterning, circular patterning, or polygonal patterning. A patterned retardation film according to the present invention is used in the intended application, such as a liquid crystal display, a display, an optical device, an optical component, a colorant, a security marking, a member for laser emission, an optical film, or a compensation film.

A method for providing a partially different phase difference includes forming an alignment film on a substrate and performing an alignment treatment that brings a polymerizable cholesteric liquid crystal composition according to the present invention into patterning alignment during application and drying. Examples of such an alignment treatment include fine rubbing, polarized ultraviolet visible light irradiation through a photomask, and micromachining. The alignment film may be a traditional alignment film. Examples of the alignment film include polyimide, polysiloxane, polyamide, poly(vinyl alcohol), polycarbonate, polystyrene, poly(phenylene ether), polyaryiate, poly(ethylene terephthalate), polyethersulfone, epoxy resin, epoxy aerylate resin, acrylic resin, coumarin compounds, chalcone compounds, cinnamate compounds, fulgide compounds, anthraquinone compounds, azo compounds, and arylethene compounds. A compound to be subjected to alignment treatment by fine rubbing is such a compound that promotes the crystallization of a material by alignment treatment or by alignment treatment and a subsequent heating process. Among compounds to be subjected to alignment treatment other than rubbing, photo-alignment materials are preferably used.

### (Brightness Enhancement Film)

A brightness enhancement film according to the present invention is formed in the same manner as an optically anisotropic body according to the present invention. A laminate of a retardation film formed by curing a polymerizable cholesteric liquid crystal composition and a λ/4 wave plate stacked with an adhesive layer interposed therebetween can be used as a brightness enhancement film according to the present invention. A brightness enhancement film according to the present invention in a liquid crystal display can effectively utilize light from a backlight, improve luminance, and increase luminous efficiency.

### (Antireflection Film)

An antireflection film according to the present invention is formed in the same manner as an optically anisotropic body according to the present invention. A laminate of a retardation film formed by curing a polymerizable cholesteric liquid crystal composition and a λ/4 wave plate stacked with an adhesive layer interposed therebetween can be used as an antireflection film according to the present invention. Image display apparatuses, such as organic ELs, have extraneous light reflections, background reflections, and other problems. An antiref lection film according to the present invention can prevent such problems.

### (Thermal Barrier Film)

A thermal barrier film according to the present invention is formed in the same manner as an optically anisotropic body according to the present invention. A laminate of a retardation film formed by curing a polymerizable cholesteric liquid crystal composition can be used as a thermal barrier film according to the present invention. A thermal barrier film according to the present invention can prevent, visible light or infrared light of sunlight from being transmitted.

### (Method for Producing Optically Anisotropic Body)

### (Substrate)

A substrate for use in an optically anisotropic body according to the present invention is a substrate generally used in liquid crystal displays, displays, optical components, and optical films and may be formed of any heat-resistant material that can withstand heat during drying of an applied polymerizable cholesteric liquid crystal composition according to the present invention. Examples of such a substrate include glass substrates, metal substrates, ceramic substrates, and organic materials, such as plastic substrates. In particular, examples of organic materials for the substrate include cellulose derivatives, polyolefin, polyester, polycarbonate, polyacrylate (acrylic resin), polyarylate, polyethersulfone, polyimide, poly(phenylene sulfide), poly(phenylene ether), nylon, and polystyrene. Among these, plastic substrates formed of polyester, polystyrene, polyacrylate, polyolefin, cellulose derivatives, polvarylate, polycarbonate, and the like are preferred, and substrates formed of polyacrylate, polyolefin, and cellulose derivatives are more preferred. A cycloolefin polymer (COP) is particularly preferably used as a polyolefin. Cellulose triacetate (TAG) is particularly preferably used as a cellulose derivative. Poly(methyl methacrylate) (PMMA) is particularly preferably used as a polyacrylate. The shape of the substrate may be flat or may have a curved surface. If necessary, these substrates may have an electrode layer, an antireflection function, or a reflection function.

In order to improve the coating performance or adhesiveness of a polymerizable cholesteric liquid crystal composition according to the present invention, these substrates may be subjected to surface treatment. Examples of the surface treatment include ozone treatment, plasma treatment, corona treatment, and silane coupling treatment. In order to adjust light transmittance and reflectance, an organic thin film, an inorganic oxide thin film, or a thin metal film may be formed on the substrate by evaporation. In order to provide optical added value, the substrate may be a pickup lens, a rod lens, an optical disk, a retardation film, a light diffusing film, or a color filter. Among these, a pickup lens, a retardation film, a light diffusing film, and a color filter are preferred to further improve added value.

### (Alignment Treatment)

The substrate is generally subjected to alignment treatment or may be provided with an alignment film so that a polymerizable cholesteric liquid crystal composition according to the present invention is aligned during application and drying. Examples of the alignment treatment include stretching, rubbing, polarized ultraviolet visible light irradiation, and ion beam treatment. The alignment film, if used, may be a traditional alignment film. Examples of the alignment film include polyimide, polysiloxane, polyamide, poly(vinyl alcohol), polycarbonate, polystyrene, poly(phenylene ether), polyarylate, poly(ethylene terephthalate), polyethersulfone, epoxy resin, epoxy acrylate resin, acrylic resin, coumarin compounds, chalcone compounds, cinnamate compounds, fulgide compounds, anthraquinone compounds, azo compounds, and arylethene compounds. A compound to be subjected to alignment treatment by rubbing is such a compound that promotes the crystallization of a material by alignment treatment or by alignment treatment and a subsequent heating process. Among compounds to be subjected to alignment treatment other than rubbing, photo-alignment materials are preferably used.

### (Application)

An application method for forming an optically anisotropic body according to the present invention may be a traditional method, such as an applicator method, a bar coating method, a spin coating method, a roll coating method, a direct gravure coating method, a reverse gravure coating method, a flexographic coating method, an ink jet method, a die coating method, a cap coating method, a dip coating method, or a slit coating method. An applied polymerizable cholesteric liquid crystal composition is dried, if necessary.

### (Polymerization Method)

The polymerization of a polymerizable cholesteric liquid crystal composition to form an optically anisotropic body according to the present invention is generally performed by light irradiation, such as ultraviolet light irradiation, or by heating while a liquid crystal compound in the polymerizable liquid crystal composition has cholesteric alignment (plane alignment) on a substrate. More specifically, for polymerization by light irradiation, irradiation of ultraviolet light of 390 nm or less is preferred, and irradiation of light with a wavelength in the range of 250 to 370 nm is most preferred. If ultraviolet light of 390 nm or less causes degradation of a polymerizable cholesteric liquid crystal composition, ultraviolet light of 390 nm or more may preferably be used for polymerization. The light is preferably diffused unpolarised light.

A method for polymerizing a polymerizable cholesteric liquid crystal composition according to the present invention may be an active energy beam irradiation method or a thermal polymerization method. The active energy beam irradiation method is preferred because heating is not required and because the reaction proceeds at room temperature. In particular, an ultraviolet light irradiation method is preferred because of its simple operation.

The irradiation temperature is preferably a temperature at which a polymerizable cholesteric liquid crystal composition according to the present invention can maintain the liquid crystal phase. The irradiation temperature of a polymerizable cholesteric liquid crystal composition can be increased to improve the curability of an optically anisotropic body formed. During a temperature rise, liquid crystal compositions generally have a liquid crystal phase at a temperature in the range of a C (solid phase)-N (nematic) transition temperature (hereinafter abbreviated to a C—N transition, temperature) to a N—I transition temperature. During a temperature drop, having a thermodynamically non-equilibriium state, liquid crystal compositions are sometimes not solidified and maintain the liquid crystal state even at a C—N transition temperature or less. Such a state is referred to as a supercooled state. In the present invention, liquid crystal compositions in the supercooled state also maintain the liquid crystal phase. More specifically, irradiation of ultraviolet light of 390 nm or less is preferred, and irradiation of light with a wavelength in the range of 250 to 370 nm is most preferred. If ultraviolet light of 390 nm or less causes the degradation of a polymerizable composition, ultraviolet light of 390 nm or more may preferably be used for polymerization. The light is preferably diffused unpolarized light. The ultraviolet irradiation intensity preferably ranges from 0.05 to 10 kW/m². In particular, 0.2 to 2 kW/m² is preferred. An ultraviolet radiation intensity of less than 0.05 kW/m² results in a very long polymerization time. On the other hand, an intensity of more than 2 kW/m² tends to result in photolysis of liquid crystal molecules in a polymerizable liquid crystal composition and may result in increased heat of polymerization, an increased polymerization temperature, a variation in the order parameter of polymerizable liquid crystals, and a deviation in the retardation of a film after polymerization.

An optically anisotropic body having regions with different alignment directions can be formed by polymerizing only a particular portion by ultraviolet irradiation using a mask, changing the alignment state of an unpolymerized portion by an electric field, a magnetic field, or temperature, and then polymerizing the unpolymerized portion.

An optically anisotropic body having regions with different alignment directions can also be formed by applying an electric field, a magnetic field, or temperature in advance to a polymerizable liquid crystal composition in an unpolymerized state to control alignment and then polymerizing only a particular portion by ultraviolet irradiation using a mask while maintaining the state.

An optically anisotropic body formed by polymerization of a polymerizable liquid crystal composition according to the present invention may be removed from a substrate and used alone as an optically anisotropic body, or may not be removed from a substrate and used as an optically anisotropic body without modification. In particular, such an optically anisotropic body rarely contaminates other members-and is useful as a substrate for lamination or as a laminate with another substrate.

### (Method for Forming Laminate Having Protective Layer on Optically Anisotropic Body)

The following methods are methods for forming a laminate having a protective layer on an optically anisotropic body according to the present invention.

A first method includes adding the non-silicon compound (V) having a repeating unit to a polymerizable cholesteric liquid crystal composition according to the present invention and polymerizing the polymerizable cholesteric liquid crystal composition. In this case, it is surmised that after the application of the polymerizable cholesteric liquid crystal composition and before the formation of an alignment state, if necessary, by drying, the non-silicon compound (V) having a repeating unit is excluded from the polymerizable cholesteric liquid crystal composition, segregates at the interface between the polymerizable cholesteric liquid crystal composition and the air, and forms a protective layer, thereby forming a laminate. In this method, a compound represented by the general formula (V-1) or (V-2) is preferably used as the non-silicon compound (V) having a repeating unit because the compound can separate appropriately from an optically anisotropic body, easily form a protective layer, and form an optically anisotropic body with good alignment.

A second method includes drying and, if necessary, curing a solution containing the non-silicon compound (V) having a repeating unit to form a protective layer on an optically anisotropic body formed by polymerization of a polymerizable cholesteric liquid crystal composition for an optically anisotropic body having an optically anisotropic body according to the present invention. In this case, the polymerizable cholesteric liquid crystal composition may or may not contain the non-silicon compound (V) having a repeating unit. If present, a compound represented by the general formula (V-2) is preferred. In this method, the non-silicon compound (V) having a repeating unit is preferably a compound represented by the general formula (V-1) or (V-3) in terms of a high glass transition temperature and high heat resistance as a protective layer.

### (Liquid Crystal Display)

A liquid crystal display according to the present invention is a display device containing a liquid crystal substance between light-transmitting substrates, such as glass substrates. A liquid crystal display displays an image by changing the molecular orientation of a liquid crystal substance by electrical control with a display controller (not shown) to change the polarization state of backlight polarized by a polarizing plate disposed on the back side of a liquid crystal cell and to control the amount of light passing through a polarizing plate disposed on the viewing side of the liquid crystal cell. A liquid crystal display according to the present embodiment aligns rod-like liquid crystal molecules having negative dielectric constant anisotropy.

In a liquid crystal display according to an embodiment of the present invention, a negative C plate of a retardation film according to the present invention is preferably used to compensate for the viewing angle dependence of polarization axis orthogonality and thereby increase the viewing angle. Preferably, a positive A plate is used together. More preferably, a positive A plate and a negative C plate are stacked.

In the positive A plate, the refractive index nx of the film in the in-plane slow axis direction, the refractive index ny of the film in the in-plane fast axis direction, and the refractive index nz of the film in the thickness direction satisfy the relationship “nx>ny=nz”.

When a positive A plate and a negative C plate are stacked, a first retardation film is preferably the positive A plate, and the; positive A plate preferably has an in-plane retardation, value in the range of 30 to 500 nm at a wavelength of 550 nm. The Nz factor preferably ranges from 0.9 to 1.1. The negative C plate preferably has a retardation value in the range of 20 to 400 nm in the thickness direction at a wavelength of 550 nm.

The refractive index anisotropy in the thickness direction is represented by the retardation value Rth in the thickness direction defined by the formula (2). The retardation value Rth in the thickness direction can be calculated by determining nx, ny, and nz from the in-plane retardation value R₅, the retardation value R₅₀ measured at a tilt angle of 50 degrees with the slow axis being taken as the tilt axis, the film thickness d, and the average refractive index n₀ of the film using the formula (1) and the following formulae (4) to (7) and by substituting nx, ny, and nz into the formula (2). The Nz factor can be calculated using the formula (3). The same is true for the other descriptions in the present specification.

R₀=(nx−ny)×d (1)

Rth=[(nx+ny)/2−nz]×d (2)

Nz factor=(nx−nz)/(nx−ny) (3)

R_{S0}=(nx−ny′)×d/cos(ϕ) (4)

(nx+ny+nz)/3=n₀ (5)

wherein

ϕ=sin⁻¹[sin(50°)/n₀ ] (6)

ny′=ny×nz/[ny²×sin²(ϕ)+nz²×cos²(ϕ)]^{1/2} (7)

In many of the commercially available retardation measuring apparatuses, these numerical calculations are automatically performed in the apparatuses, and the in-plane retardation value R₀ and the retardation value Rth in the thickness direction are automatically displayed. One example of such measuring apparatuses is RETS-100 (manufactured by Otsuka Chemical Co., Ltd.).

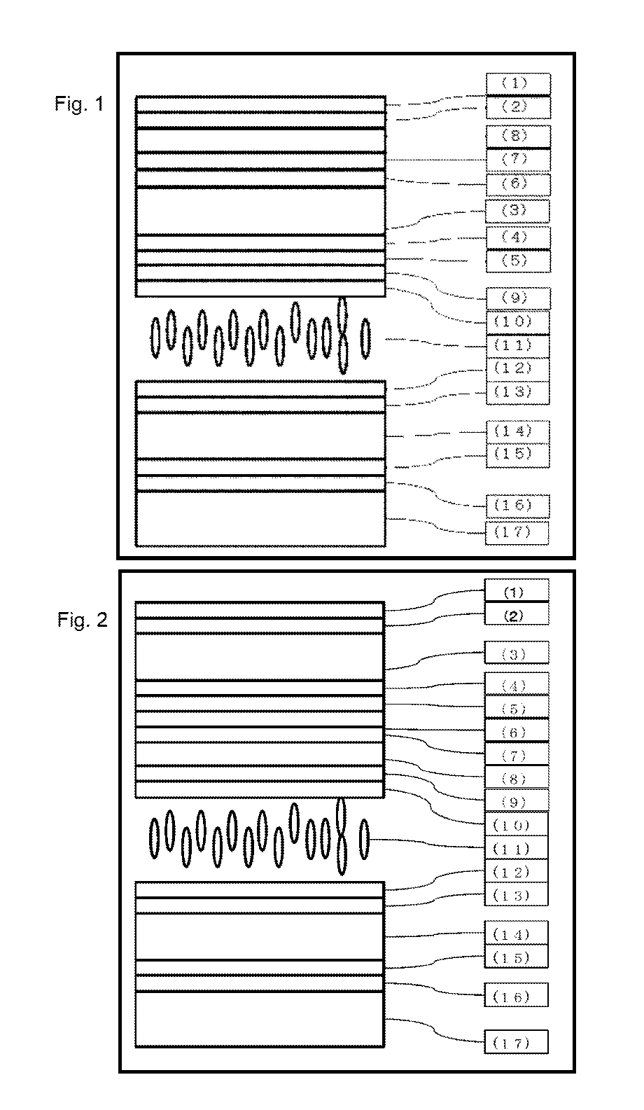

A retardation film according to the present invention can be applied to liquid crystal displays in which the retardation film is disposed on the outside of a liquid crystal cell (out-cell type, FIG. 1) and can also be applied to liquid crystal displays in which the retardation film is disposed on the inside of a liquid crystal cell (in-cell type). In-cell type retardation films are preferred from the perspective of a decrease in the thickness and weight of liquid crystal displays and improvement in productivity due to a fewer number of attaching steps.

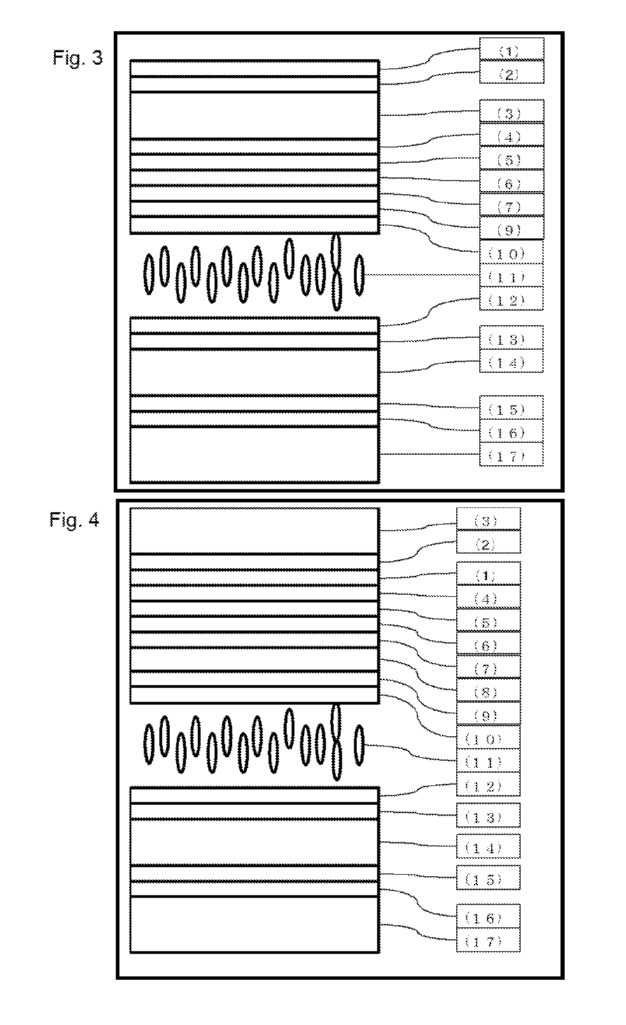

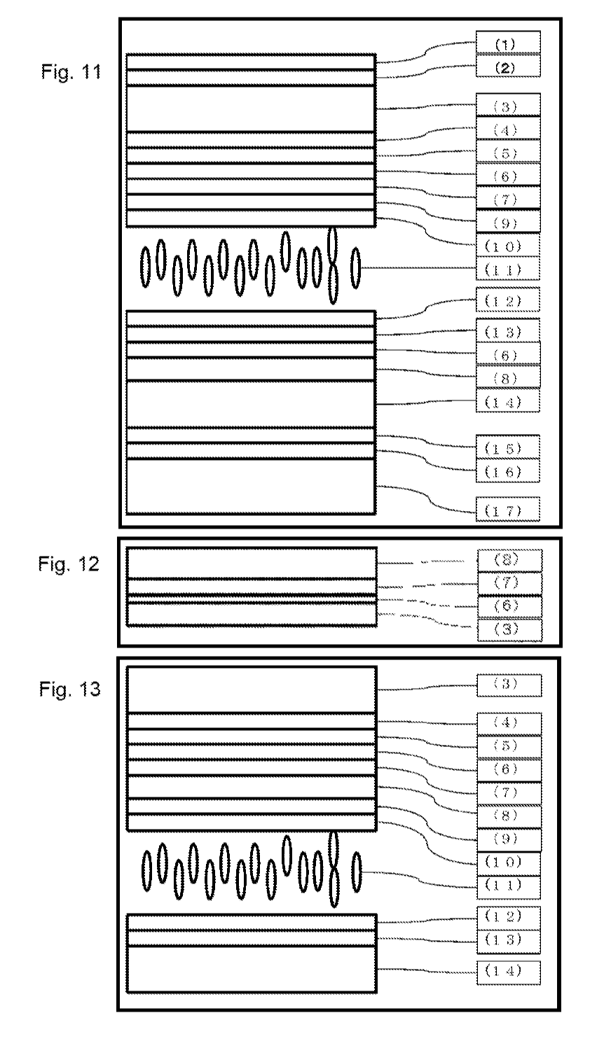

An “in-cell type retardation film” according to the present invention is disposed between a pair of light-transmitting substrates; and is disposed, within a liquid crystal cell. An optically anisotropic body formed by polymerization of a polymerizable liquid crystal composition in an aligned state is used as a retardation film. Liquid crystal displays illustrated in FIGS. 2 and 3 are only examples, and the position of a retardation film is not limited to these examples. For example, a retardation film may be disposed at a desired position, such as between an electrode and an alignment film on the back side (FIGS. 10 and 11).

A liquid crystal display according to the present invention may include a color filter. The color filter is composed of a black matrix and at least a RGB tri-color pixel unit. A color filter layer may be formed by any method. A liquid crystal display according to the present invention may include an alignment film for aligning a liquid crystal composition disposed on a surface of a first substrate and a second substrate facing the liquid crystal composition. The alignment film material is described as in alignment treatment according to the present invention.

In a liquid crystal display according to the present invention, an electrically conductive metal oxide can be used as a transparent electrode material. The metal oxide may be indium oxide (In₂o₃), tin oxide (SnO₂), zinc oxide (ZnO), indium, tin oxide (In₂O₃—SnO₂), indium zinc oxide (In₂O₃—ZnO), niobium doped titanium dioxide (Ti₁₋ₓNbₓO₂), fluorine doped tin oxide, graphene nanoribbon, or metal nanowire. Zinc oxide (ZnO), indium tin oxide (In₂O₃—SnO₂), or indium zinc oxide (In₂O₃—ZnO) are preferred. These transparent electrically conductive films may be patterned by a photo-etching method or a method using a mask.

A liquid crystal display according to the present invention may include a polarization layer. The polarization layer is a member having a function of converting natural light into linearly polarized light. The polarization layer is any film having a polarization function, for example, a film formed by stretching a poly(vinyl alcohol) film on which iodine or a dichroic pigment is adsorbed, a film formed by stretching of a poly(vinyl alcohol) film followed by adsorption of iodine, a dichroic dye, or a dichroic pigment, a film formed by applying an aqueous solution containing a dichroic dye on a substrate to form a polarization layer, or a wire grid polarizer.

The wire grid polarizer, if used, is preferably formed of an electrically conductive material, such as Al, Cu, Ag, Cu, Ni, Cr, or Si.

The polarization layer may include a film serving as a protective film, if necessary. The protective film may be a polvolefin film, for example, formed of a polyethylene, polypropylene, or norbornene polymer, a poly(ethylene terephthalate) film, a polymethacrylate film, a polyacrylate film, or a cellulose ester film.

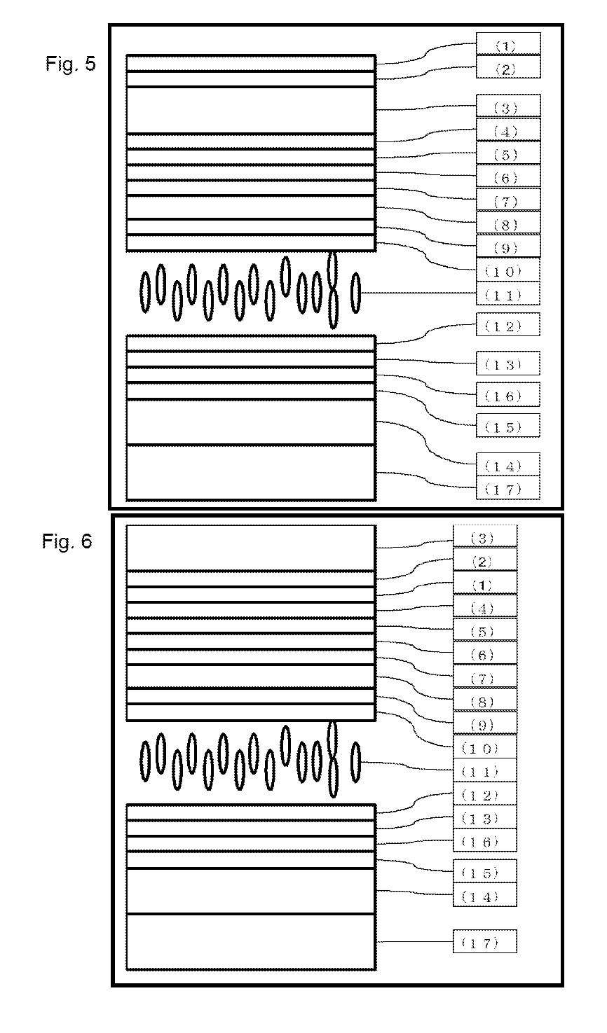

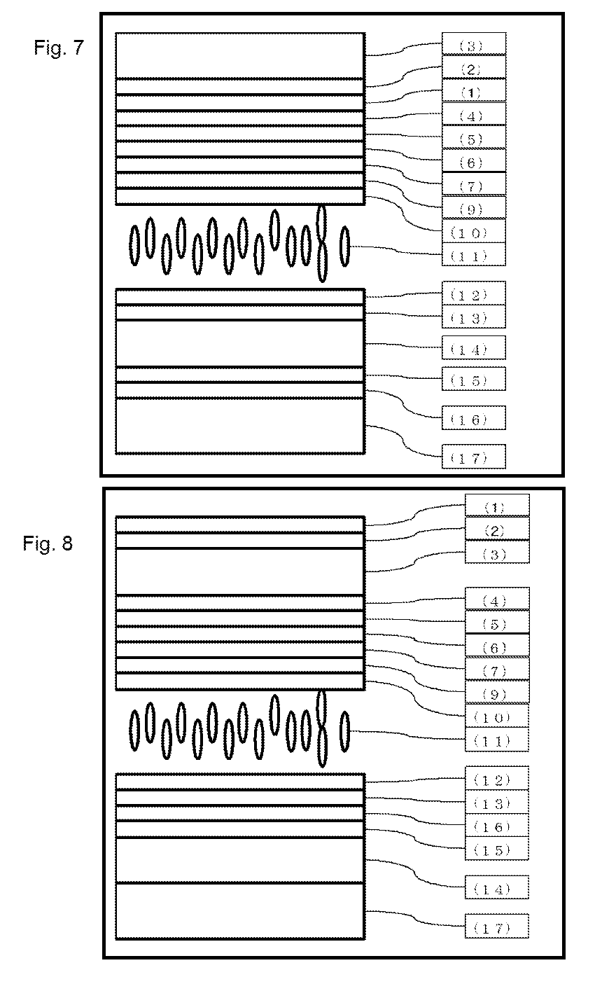

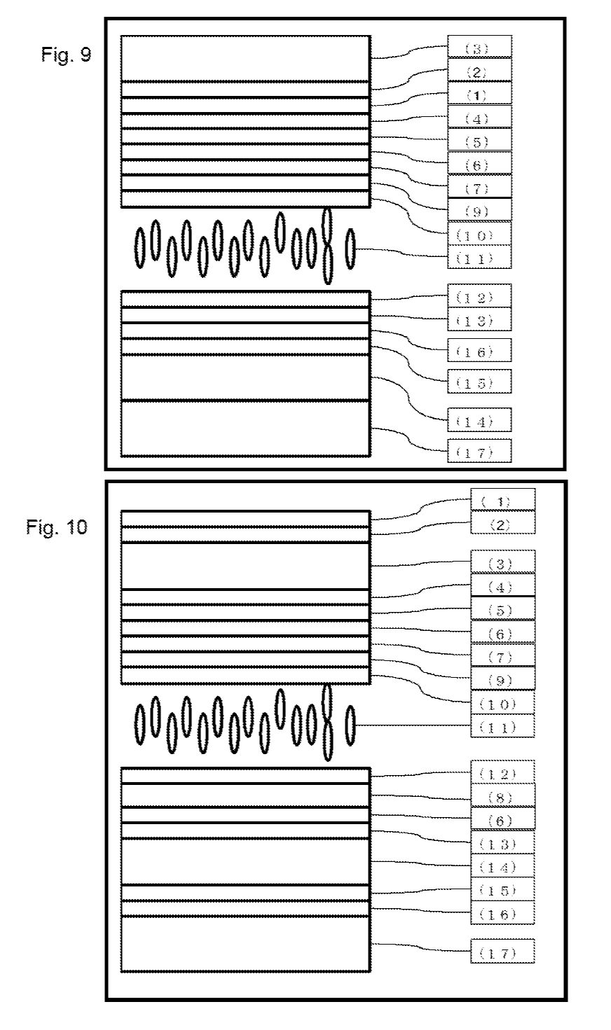

An embodiment of the present invention may include an in-cell polarization layer, in which a polarisation layer is disposed within a liquid crystal cell. Such a liquid crystal display is illustrated in FIGS. 4 to 9.

An optical member including the polarization layer may include an adhesive layer for bonding to a liquid crystal cell. An adhesive layer for bonding to a member other than the liquid crystal cell may also foe formed. The adhesive layer may contain any adhesive, for example, an adhesive containing a base polymer, such as an acrylic polymer, a silicone polymer, polyester, polyurethane, polyamide, polyether, or a fluorinated or rubber polymer. Cyanobiphenyl, phenylcyclohexyl, phenyl benzoate, cyclohexyl benzoate, azomethine, azofoenzene, pyrimidine, dioxane, cyclohexylcyclohexane, stilbene, tolan, and any traditional, substances may be used in a liquid crystal composition according to the present invention.

### (Image Display Apparatus)

An image display apparatus according to the present invention can be used in various apparatuses for image display. The image display apparatus may be an organic EL display or a plasma display apparatus. The use, type, and structure of the image display apparatus are not particularly limited. The image display apparatus may include a diffuser sheet, an antireflection film, a protective film, a light diffuser sheet, a backlight, and other components.

### (Optical Device)

An optically anisotropic body according to the present invention may also be used as an optical device. The optical device may be a diffraction grating or a pickup lens. The use, type, and structure of the optical device are not particularly limited.

### (Printed Material)

An optically anisotropic body according to the present invention may also be used as a printed material. The printed material may be an anti-counterfeit printed material. The use, type, and structure of the printed material are not particularly limited.

### EXAMPLES

The present invention is further described in the following synthesis examples, examples, and comparative examples. However, the present invention is not limited to these examples. Unless otherwise specified, “parts” and “%” are based on mass.

### (Preparation of Polymerizable Liquid Crystal Composition)

Polymerizable liquid crystal compositions according to the present invention for use in retardation films were prepared as described below.

The polymerizable liquid crystal compositions listed in Table 1 were prepared by using the compound represented by the following formula (D-1), the compounds represented by the following formulae (E-1) and (E-2), the compounds having a repeating unit represented by the following formulae (F-1) to (F-9), and the organic solvent cvclopentanone (G-1) at the ratios (parts by mass) listed in Table 1 per 100 parts by mass in total of the compounds represented by the following formulae (A-1) to (A-7), which were polymerizable liquid crystal compounds having two or more polymerizable functional groups in the molecule, the compounds represented by the following formulae (B-1) to (B-3), which were polymerizable liquid crystal compounds having one polymerizable functional group, and the compounds represented by the following formulae (C-1) to (C-6), which were chiral compounds.

### (Preparation of Polymerizable Cholesteric Liquid Crystal Composition (1))

As shown in Table 1, 0.1 parts by mass of methylhydroquinone (MEHQ) (D-1), 3.0 parts by mass of a polymerization initiator (E-1), 0.1 parts by mass of the compound represented by the formula (F-1), and 300 parts by mass of an organic solvent cyclopentanone (G-1) per 100 parts by mass in total of the compound represented by the formula (A-1) (51.0 parts by mass), the compound represented by the formula (A-2) (12.8 parts by mass), the compound represented by the formula (B-1) (9.2 parts by mass), the compound represented by the formula (B-2) (22.4 parts by mass), and the compound represented by the formula (C-1) 4.6 parts by mass were stirred for 1 hour with a mixer having stirring propellers at a stirring speed of 500 rpm and at a solution temperature of 60° C and were passed through a 0.2-μm membrane filter. Thus, a polymerizable cholesteric liquid crystal composition (1) was produced.

### (Preparation of Polymerizable Cholesteric Liquid Crystal Compositions (2) to (28) and Comparative Polymerizable Liquid Crystal Compositions (29) to (40))

Polymerizable cholesteric liquid crystal compositions (2) to (28) and comparative polymerizable cholesteric liquid crystal compositions (29) to (40) were prepared in the same manner as in the preparation of the polymerizable cholesteric liquid crystal composition (1) according to the present invention except that the compounds represented by the formulae (A-1) to (A-7), (B-1) to (B-3), and (C-1) to (C-6), the polymerization inhibitor (D-1), the polymerization initiators (E-1) and (E-2), and the compounds having a repeating unit, represented by the formulae (F-1) to (F-9) listed in Table 1 were used at the ratios listed in Tables 1 to 3.

The following tables list the specific compositions of the polymerizable cholesteric liquid crystal compositions (1) to (28) according to the present invention and the comparative polymerizable cholesteric liquid crystal compositions (23) to (40).

TABLE 1

| Composition | (1) | (2) | (3) | (4) | (5) | (6) | (7) | (8) | (9) | (10) | (11) | (12) | (13) |
|---|---|---|---|---|---|---|---|---|---|---|---|---|---|
| (A-1) | 51.0 | 51.0 | 46.8 | 38.4 | 20.0 | | 51.0 | 51.0 | 46.8 | 39.8 | 38.9 | 38.4 | 20.0 |
| (A-2) | 12.8 | 12.8 | 10.2 | 22.8 | | | 12.8 | 12.8 | 10.2 | 23.8 | 8.8 | 22.8 | |
| (A-3) | | | | 30.1 | | | | | | 31.1 | 30.8 | 30.1 | |
| (A-4) | | | | | | | | | | | 14.4 | | |
| (A-5) | | | | | 60.0 | | | | | | | | 60.0 |
| (A-6) | | | | | | 45.0 | | | | | | | |
| (A-7) | | | | | | 45.0 | | | | | | | |
| (B-1) | 9.2 | 9.2 | 7.0 | | 10.0 | | 9.2 | 9.2 | 7.0 | | | | 10.0 |
| (B-2) | 22.4 | 22.4 | 11.0 | | | | 22.4 | 22.4 | 11.0 | | | | |
| (B-3) | | | 9.6 | | | | | | 9.6 | | | | |
| (C-1) | 4.6 | 4.6 | | | | | 4.6 | 4.6 | | | | | |
| (C-2) | | | 5.2 | | | | | | 5.2 | | | | |
| (C-3) | | | | 4.1 | | | | | | 5.3 | | 4.1 | |
| (C-4) | | | | 4.6 | | | | | | | 7.1 | 4.6 | |
| (C-5) | | | 10.2 | | | | | | 10.2 | | | | |
| (C-6) | | | | | 10.0 | 10.0 | | | | | | | 10.0 |
| (D-1) | 0.1 | 0.1 | 0.1 | 0.1 | 0.1 | 0.1 | 0.1 | 0.1 | 0.1 | 0.1 | 0.1 | 0.1 | 0.1 |
| (E-1) | 3.0 | 3.0 | 3.0 | 3.0 | 3.0 | | 3.0 | 3.0 | 3.0 | 3.0 | 3.0 | 3.0 | 3.0 |
| (E-2) | | | | | | 4.0 | | | | | | | |
| (F-1) | 0.1 | | | 0.1 | 0.1 | | 0.1 | | | 0.1 | | 0.1 | 0.1 |
| (F-2) | | 0.1 | | | | | | 0.1 | | | | | |
| (F-3) | | | | | | 0.1 | | | | | 0.1 | | |
| (F-4) | | | 0.2 | | | | | | 0.2 | | | | |
| (F-5) | | | | | | | | | | | | | |
| (F-6) | | | | | | | | | | | | | |
| (F-7) | | | | | | | | | | | | | |
| (F-8) | | | | | | | | | | | | | |
| (F-9) | | | | | | | | | | | | | |
| (G-1) | 300 | 300 | 300 | 300 | 300 | 300 | 300 | 300 | 300 | 300 | 300 | 300 | 300 |

TABLE 2

| Composition | (14) | (15) | (16) | (17) | (18) | (19) | (20) | (21) | (22) | (23) | (24) | (25) | (26) |
|---|---|---|---|---|---|---|---|---|---|---|---|---|---|
| (A-1) | 20.0 | | | 51.0 | 39.8 | 38.9 | 41.0 | 46.8 | 46.8 | 38.9 | 38.9 | 46.8 | 41.0 |
| (A-2) | | | | 12.8 | 23.8 | 23.1 | 24.4 | 10.2 | 10.2 | 23.1 | 23.1 | 10.2 | 24.4 |
| (A-3) | | | | | 31.1 | 30.8 | 32.2 | | | 30.8 | 30.8 | | 32.2 |
| (A-4) | | | | | | | | | | | | | |
| (A-5) | 60.0 | | | | | | | | | | | | |
| (A-6) | | 45.0 | 45.0 | | | | | | | | | | |
| (A-7) | | 45.0 | 45.0 | | | | | | | | | | |
| (B-1) | 10.0 | | | 9.2 | | | | 7.0 | 7.0 | | | 7.0 | |
| (B-2) | | | | 22.4 | | | | 11.0 | 11.0 | | | 11.0 | |
| (B-3) | | | | | | | | 9.6 | 9.6 | | | 9.6 | |
| (C-1) | | | | 4.6 | | | | | | | | | |
| (C-2) | | | | | | | | 5.2 | 5.2 | | | 5.2 | |
| (C-3) | | | | | 5.3 | | | | | | | | |
| (C-4) | | | | | | 4.4 | 2.4 | | | 4.4 | 4.4 | | 2.4 |
| (C-5) | | | | | | 3 | | 10.2 | 10.2 | 3 | 3 | 10.2 | |
| (C-6) | 10.0 | 10.0 | 10.0 | | | | | | | | | | |
| (D-1) | 0.1 | 0.1 | 0.1 | 0.1 | 0.1 | 0.1 | 0.1 | 0.1 | 0.1 | 0.1 | 0.1 | 0.1 | 0.1 |
| (E-1) | 3.0 | | | 3.0 | 3.0 | 3.0 | 3.0 | 3.0 | 3.0 | 3.0 | 3.0 | 3.0 | 3.0 |
| (E-2) | | 4.0 | 4.0 | | | | | | | | | | |
| (F-1) | | 0.1 | | | 0.1 | 0.1 | 0.1 | | | 0.1 | 0.1 | | 0.1 |
| (F-2) | 0.1 | | | 0.1 | | | | | | | | | |
| (F-3) | | | 0.1 | | | | | | | | | | |
| (F-4) | | | | | | | | 0.2 | 0.2 | | | | |
| (F-5) | | | | | | | | | | | | 0.2 | |
| (F-6) | | | | | | | | | | | | | |
| (F-7) | | | | | | | | | | | | | |
| (F-8) | | | | | | | | | | | | | |
| (F-9) | | | | | | | | | | | | | |
| (G-1) | 300 | 300 | 300 | 300 | 300 | 300 | 300 | 300 | 300 | 300 | 300 | 300 | 300 |

TABLE 3

| Composition | (27) | (28) | (29) | (30) | (31) | (32) | (33) | (34) | (35) | (36) | (37) | (38) | (39) | (40) |
|---|---|---|---|---|---|---|---|---|---|---|---|---|---|---|
| (A-1) | 38.9 | 38.4 | 51.0 | 46.8 | | 51.0 | 46.8 | 20.0 | 20.0 | | | 51.0 | 46.8 | 46.8 |
| (A-2) | 23.1 | 22.8 | 12.8 | 10.2 | | 12.8 | 10.2 | | | | | 12.8 | 10.2 | 10.2 |
| (A-3) | 30.8 | 30.1 | | | | | | | | | | | | |
| (A-4) | | | | | | | | | | | | | | |
| (A-5) | | | | | | | | 60.0 | 60.0 | | | | | |
| (A-6) | | | | | 45.0 | | | | | 45.0 | 45.0 | | | |
| (A-7) | | | | | 45.0 | | | | | 45.0 | 45.0 | | | |
| (B-1) | | | 9.2 | 7.0 | | 9.2 | 7.0 | 10.0 | 10.0 | | | 9.2 | 7.0 | 7.0 |
| (B-2) | | | 22.4 | 11.0 | | 22.4 | 11.0 | | | | | 22.4 | 11.0 | 11.0 |
| (B-3) | | | | 9.6 | | | 9.6 | | | | | | 9.6 | 9.6 |
| (C-1) | | | 4.6 | | | 4.6 | | | | | | | | |
| (C-2) | | | | 5.2 | | | 5.2 | | | | | 4.6 | 5.2 | 5.2 |
| (C-3) | | 4.1 | | | | | | | | | | | | |
| (C-4) | 4.4 | 4.6 | | | | | | | | | | | | |
| (C-5) | 3 | | | 10.2 | | | 10.2 | | | | | | 10.2 | 10.2 |
| (C-6) | | | | | 10.0 | | | 10.0 | 10.0 | 10.0 | 10.0 | | | |
| (D-1) | 0.1 | 0.1 | 0.1 | 0.1 | 0.1 | 0.1 | 0.1 | 0.1 | 0.1 | 0.1 | 0.1 | 0.1 | 0.1 | 0.1 |
| (E-1) | 3.0 | 3.0 | 3.0 | 3.0 | | 3.0 | 3.0 | 3.0 | 3.0 | | | 3.0 | 3.0 | 3.0 |
| (E-2) | | | | | 4.0 | | | | | 4.0 | 4.0 | | | |
| (F-1) | | | | | | | | | | | | | | |
| (F-2) | | | | | | | | | | | | | | |
| (F-3) | | | | | | | | | | | | | | |
| (F-4) | | | | | | | | | | | | | | |
| (F-5) | 0.2 | 0.2 | | | | | | | | | | | | |
| (F-6) | | | | 0.2 | 0.2 | | 0.2 | | 0.2 | | 0.2 | 0.2 | 0.2 | 0.2 |
| (F-7) | | | | | | | | | | | | | | |
| (F-8) | | | | | | | | | | | | | | |
| (F-9) | | | | | | | | | | | | | | |
| (G-1) | 300 | 300 | 300 | 300 | 300 | 300 | 300 | 300 | 300 | 300 | 300 | 300 | 300 | 300 |

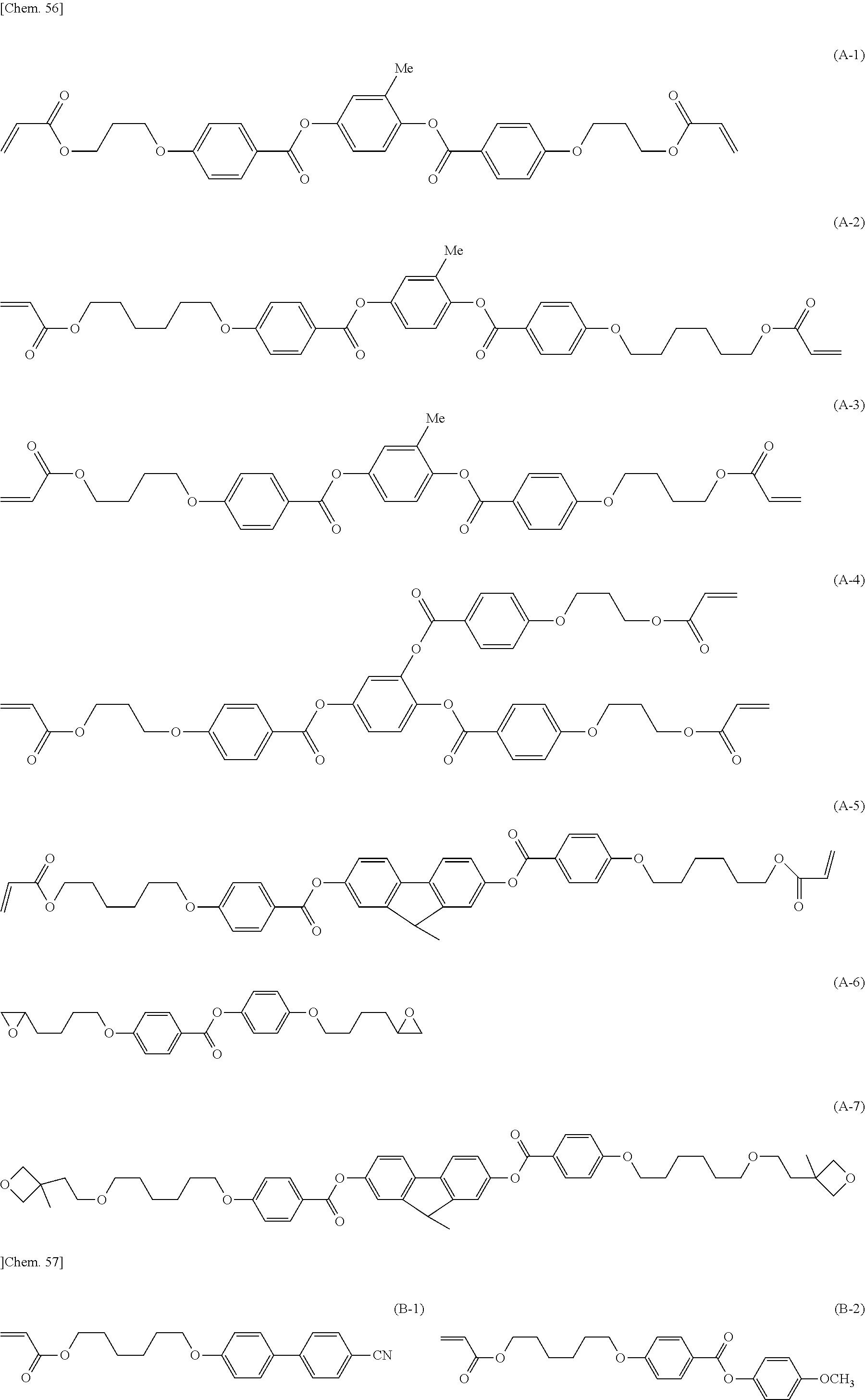

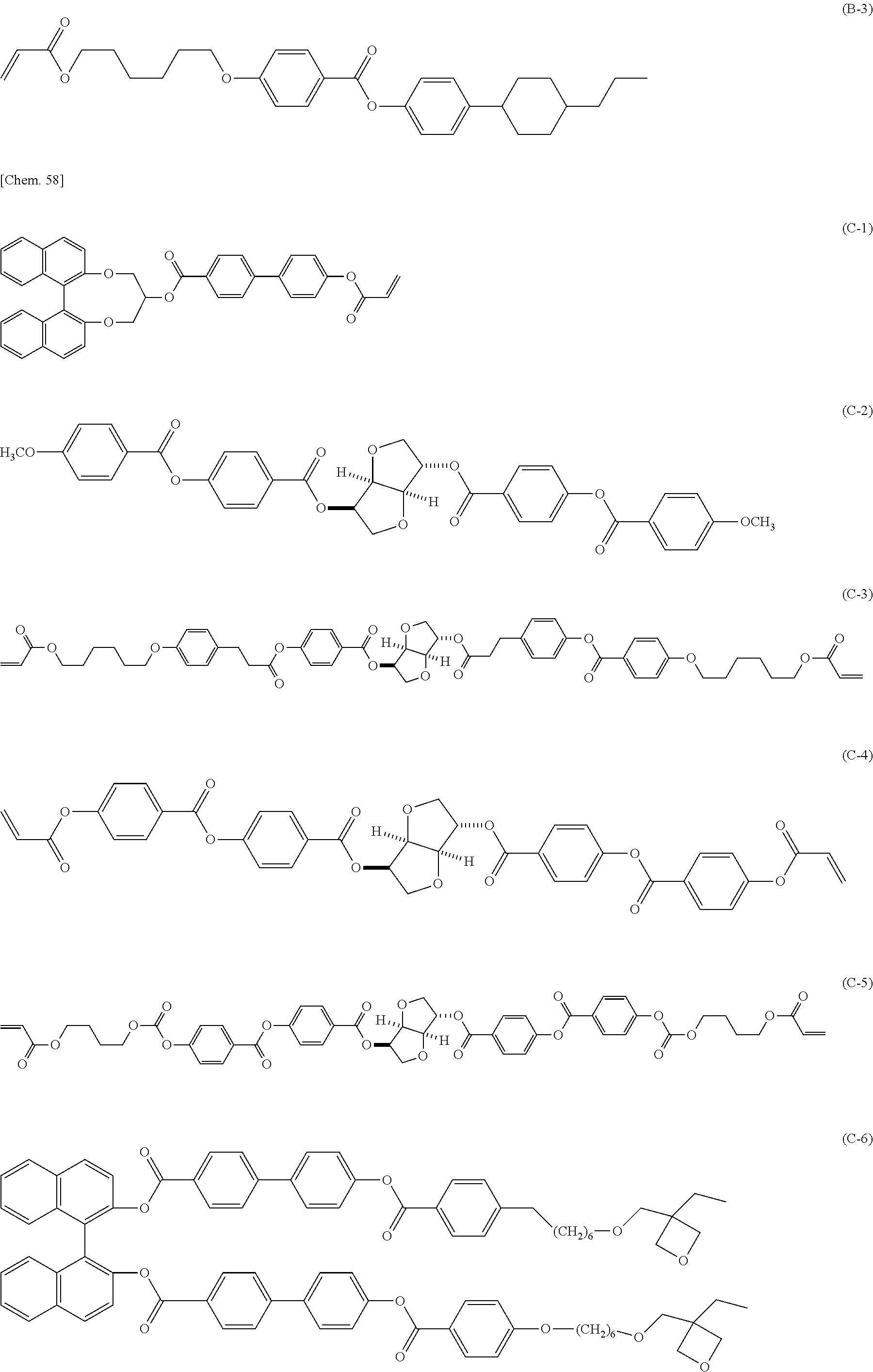

MEHQ (D-1)

Irgacure 907 (E-1)

Cationic Polymerization Initiator DTS-102 (E-2)

Copolymer of 2-ethylhexyl acrylate and butyl acrylate (F-1)

Copolymer of butyl acrylate and butyl Methacrylate (F-2)

Poly(propylene glycol) diacrylate (F-3)

Copolymer of the following (F-a) and (F-b) (F-4)

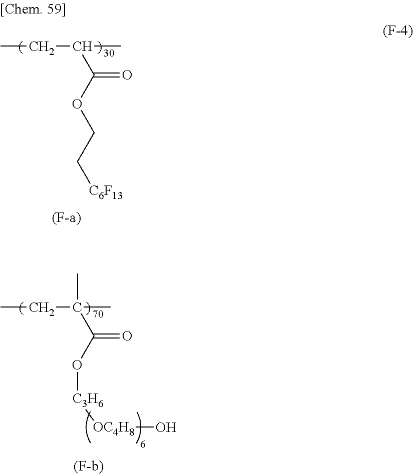

Liquid Paraffin (F-5)

Silicone polymer EFKA-2550 manufactured by BASF Japan Ltd. (F-6)

UV curable resin urethane acrylate Unidic V-4260 manufactured by DIC Corporation (F-7)

UV curable resin epoxy acrylate Acrydic V-5500 manufactured by DIC Corporation (F-8)

Thermosetting alignment material polyimide 575798 manufactured by Sigma Aldrich (F-9)

((F-1): A copolymer with Mw: 5000 and Mn;: 10000produced by polymerization of 2-ethylhexyl acrylate and butyl acrylate at a ratio of 3:1. (F-2): A copolymer with Mw: 10000 and Mn: 20000 produced by polymerization of butyl acrylate and butyl methacrylate at a ratio of 9:1. (F-3): Poly(propylene glycol) diacrylate with Mw: 708. (F-4): A copolymer with Mw: 4200 and Mn: 9500 produced by polymerization of (F-a) and (F-b) at a ratio of 3:7. (F-5): A liquid paraffin with Mw: 740.)

### Example 1

### (Alignment)

### Preparation of Optically Anisotropic Body for Evaluating Alignment>

A polyimide alignment film material for a horizontal alignment film was applied to a light-transmitting substrate by a spin coating method, was dried at 100° C. for 10 minutes, and was baked at 200° C. for 60 minutes, thereby forming a coating film. The coating film was rubbed. Rubbing was performed with a commercially available rubbing machine. The prepared polymerizable cholesteric liquid crystal composition (1) was applied to the substrate with a spin coater at 2000 rpm/30 s at room temperature and was dried at 80° C. for 2 minutes. Subsequently, after standing at 25° C. for 2 minutes, an optically anisotropic body (film thickness: 1 μm) of Example 1 was formed by W irradiation with a high-pressure mercury lamp in a nitrogen atmosphere at an irradiance of 3600 mJ/cm².

### <Evaluation of Alignment>

◯: No defect was observed in visual inspection and by polarized light microscopy.

Δ: No defect was observed in visual inspection, but an unaligned portion was partly observed by polarized light microscopy.

×: No defect was observed in visual inspection, but an unaligned portion was widely observed by polarised light microscopy.

### <Evaluation of Heat Resistance>

The optically anisotropic body prepared in the alignment evaluation test was subjected to ITO sputtering with a sputtering apparatus for 2.5 minutes at 50° C., at a pressure of 3.7×10⁻¹ Pa, at an argon flow rate of 90 sccm, and at an oxygen gas flow rate of 4.7 sccm, thereby forming an ITO film with a thickness of 700 angstroms on. the optically anisotropic body. Subsequently, after baking (at 1000° C. for 10 minutes), three asperities (differences in film thickness) in an area 50 μm square of the coating film were measured with an SPM surface analyzer. The average of the differences in film thickness was examined. In Examples 1 to 30 and Comparative Examples 2, 3, and 10, the average difference in film thickness of the optically anisotropic body before ITO evaporation was 0.02μ.

The results are shown in the tables below.

TABLE 4

| | Composition | Alignment | Heat resistance |
|---|---|---|---|
| Example 1 | Composition (1) | ∘ | 0.02 |
| Example 2 | Composition (2) | ∘ | 0.03 |
| Example 3 | Composition (3) | ∘ | 0.02 |
| Example 4 | Composition (4) | ∘ | 0.02 |
| Example 5 | Composition (5) | ∘ | 0.02 |
| Example 6 | Composition (6) | ∘ | 0.02 |
| Example 7 | Composition (7) | ∘ | 0.02 |
| Example 8 | Composition (8) | ∘ | 0.03 |
| Example 9 | Composition (9) | ∘ | 0.02 |
| Example 10 | Composition (10) | ∘ | 0.02 |
| Example 11 | Composition (11) | ∘ | 0.03 |
| Example 12 | Composition (12) | ∘ | 0.02 |
| Example 13 | Composition (13) | ∘ | 0.02 |
| Example 14 | Composition (14) | ∘ | 0.03 |
| Example 15 | Composition (15) | ∘ | 0.02 |
| Example 16 | Composition (16) | ∘ | 0.02 |
| Example 17 | Composition (17) | ∘ | 0.03 |
| Example 18 | Composition (18) | ∘ | 0.02 |
| Example 19 | Composition (19) | ∘ | 0.02 |
| Example 20 | Composition (20) | ∘ | 0.02 |
| Example 21 | Composition (21) | ∘ | 0.02 |
| Example 22 | Composition (22) | ∘ | 0.02 |
| Example 23 | Composition (23) | ∘ | 0.02 |

TABLE 5

| | Composition | Alignment | Heat resistance |
|---|---|---|---|
| Example 24 | Composition (24) | ∘ | 0.02 |
| Example 25 | Composition (25) | ∘ | 0.02 |
| Example 26 | Composition (26) | ∘ | 0.02 |
| Example 27 | Composition (27) | ∘ | 0.02 |
| Example 28 | Composition (28) | ∘ | 0.02 |
| Comparative | Composition (29) | x | — |
| example 1 | | | |
| Comparative | Composition (30) | ∘ | 0.50 |
| example 2 | | | |
| Comparative | Composition (31) | ∘ | 0.40 |
| example 3 | | | |
| Comparative | Composition (32) | x | — |
| example 4 | | | |
| Comparative | Composition (33) | Δ | — |
| example 5 | | | |
| Comparative | Composition (34) | x | — |
| example 6 | | | |
| Comparative | Composition (35) | Δ | — |
| example 7 | | | |
| Comparative | Composition (36) | x | — |
| example 8 | | | |
| Comparative | Composition (37) | Δ | — |
| example 9 | | | |
| Comparative | Composition (38) | ∘ | 0.60 |
| example 10 | | | |
| Comparative | Composition (39) | Δ | — |
| example 11 | | | |
| Comparative | Composition (40) | Δ | — |
| example 12 | | | |

### Examples 2 to 28, Comparative Examples 1 to 12

The polymerizable cholesteric liquid crystal compositions (2) to (40) were used to prepare optically anisotropic bodies, and alignment and heat resistance were measured. The results are shown in the tables as Examples 2 to 28 and Comparative Examples 1 to 12. The optically anisotropic bodies of Examples 2 to 28 and Comparative Examples 1 to 12 were formed by the method described below,

For the optically anisotropic .foodies for the evaluation of alignment and others in Examples 1 to 6 and Comparative Examples 1 to 3, in the same manner as in Example 1, a polyimide alignment film material for a horizontal alignment film was applied to a light-transmitting substrate by a spin coating method, was dried at 100° C. for 10 minutes, and was baked at 200° C. for 60 minutes, thereby forming a coating film. The coating film was rubbed. Rubbing was performed with a commercially available rubbing machine. The prepared polymerizable cholesteric liquid crystal composition was applied to the substrate with a spin coater at 2000 rpm/30 s at room temperature and was dried at 80° C. for 2 minutes. Subsequently, after standing at 25° C. for 2 minutes, optically anisotropic bodies (film thickness: 1 μm) of examples and comparative examples were formed by UV irradiation with a high-pressure mercury lamp in a nitrogen atmosphere at an irradiance of 3600 mJ/cm². Heat resistance was evaluated in ITO films formed on the optically anisotropic bodies under the same conditions as in Example 1.

For the optically anisotropic bodies for the evaluation of alignment and others in Examples 7 to 16 and Comparative Examples 2 to 9, a coating film was formed on the light-transmitting substrate by drying at 100° C. for 10 minutes and subsequent baking at 200° C. for 60 minutes. The coating film was rubbed. Flubbing was performed with a commercially available rubbing machine. The prepared polymerizable liquid crystal composition for a cholesteric film was applied to the substrate with a spin coater at 350 rpm/30 s at room temperature and was dried at 80° C. for 2 minutes. Subsequently, after standing at 25° C. for 2 minutes, optically anisotropic bodies (film thickness: 4 μm) of examples and comparative examples were formed by UV irradiation with a high-pressure mercury lamp in a nitrogen atmosphere at an irradiance of 3600 mJ/cm². Heat resistance was evaluated in ITO films formed on the optically anisotropic bodies under the same conditions as in Example 1.

For optically anisotropic bodies for the evaluation of alignment and others in Examples 17 to 20 and Comparative Example 10, a COP substrate was used as a substrate, and the prepared polymerizable cholesteric liquid crystal composition was applied to the substrate with a bar coater #3 at room temperature and was dried at 80° C. for 2 minutes. After standing at 25° C. for 2 minutes, optically anisotropic bodies (film thickness: 1 μm) of examples and comparative examples were formed by UV irradiation with a high-pressure mercury lamp in a nitrogen atmosphere at an irradiance of 3600 mJ/cm². Heat resistance was evaluated in ITO films formed on the optically anisotropic bodies under the same conditions as in Example 1.

For optically anisotropic bodies for the evaluation of alignment and others in Example 21 and Comparative Example 11, a COP substrate was used as a substrate, and the prepared polymerizable cholesteric liquid crystal composition was applied to the substrate with a bar coater #5 at room temperature and was dried at 80° C. for 2 minutes. After standing at 25° C. for 2 minutes, optically anisotropic bodies (film thickness: 4 μm) of examples and comparative examples were formed by UV irradiation with a high-pressure mercury lamp in a nitrogen atmosphere at an irradiance of 3600 mJ/cm². Heat resistance was evaluated in ITO films formed on the optically anisotropic bodies under the same conditions as in Example 1.

For the optically anisotropic bodies for the evaluation of alignment and others in Examples 22 and 23 and Comparative Example 12, a polyimide alignment film material for a horizontal alignment film was applied to a glass substrate by a spin coating method, was dried at 100° C. for 10 minutes, and was baked at 200° C. for 60 minutes, thereby forming a coating film (6). The coating film was rubbed. Rubbing was performed with a commercially available rubbing machine. A homogeneous alignment polymerizable liquid crystal compositiori described in Example 2 of Japanese Unexamined Patent Application Publication No. 2014-231568 was applied to the substrate with a spin coater at 650 rpm/30 s at room temperature and was dried at 100° C. for 2 minutes. After standing at 25° C. for 2 minutes, a first retardation film (7) with a thickness of 0.6 μm was formed by UV irradiation with a high-pressure mercury lamp in a nitrogen atmosphere at an irradiance of 3600 mJ/cm² (see FIG. 12). The prepared polymerizable cholesteric liquid crystal composition listed in the table was applied to the retardation film 1 with a spin coater at 350 rpm/30 s at room temperature and was dried at 80° C. for 2 minutes. Subsequently, after standing at 25° C. for 2 minutes, a second retardation film (8) with a thickness of 4 μm was formed by UV irradiation with a high-pressure mercury lamp in a nitrogen atmosphere at an irradiance of 3600 mJ/cm² (see FIG. 12). Heat resistance was evaluated in ITO films formed on the retardation film 2 under the same conditions as in Example 1.

For the optically anisotropic body for the evaluation of alignment and others in Example 24, a polyimide alignment film material for a horizontal alignment film was applied to a light-transmitting substrate by a spin coating method,, was dried at 100° C. for 10 minutes, and was baked at 200° C. for 60 minutes, thereby forming a coating film. The coating film was rubbed. Rubbing was performed with a commercially available rubbing machine. The prepared polymerizable cholesteric liquid crystal composition listed in the table was applied to the substrate with a spin coater at 2000 rpm/30 s at room temperature and was dried at 80° C. for 2 minutes. After standing at 25° C. for 2 minutes, an optically anisotropic body with a film thickness of 1 μm was formed by UV irradiation with a high-pressure mercury lamp in a nitrogen atmosphere at an irradiance of 3600 mJ/cm². A solution containing 5% by weight of the formula (F-7) (containing 3 parts by weight of (E-1) per 100 parts by mass of (F-7); organic solvent: ethyl acetate) was applied to the optically anisotropic body with a spin coater at 800 rpm/120 s at room temperature and was dried at 80° C. for 2 minutes. After standing at 25° C. for 2 minutes, a protective layer (film thickness: 1 μm) for protecting the optically anisotropic body was formed by UV irradiation with a high-pressure mercury lamp in a nitrogen atmosphere at an irradiance of 3600 mJ/cm². Thus, the optically anisotropic body of Example 26 was formed. Heat resistance was evaluated in ITO films formed on the protective layer under the same conditions as in Example 1.

For the optically anisotropic bodies for the evaluation of alignment and others in Examples 25 and 26, a polyimide alignment film material for a horizontal alignment film was applied to a light-transmitting substrate by a spin coating method, was dried at 100° C. for 10 minutes, and was baked at 200° C. for 60 minutes, thereby forming a coating film. The coating film was rubbed. Rubbing was performed with a commercially available rubbing machine. The prepared polymerizable cholesteric liquid crystal composition listed in the table was applied to the substrate with a spin coater at 350 rpm/30 s at room temperature and was dried at 80° C. for 2 minutes. After standing at 25° C. for 2 minutes, an optically anisotropic body with a film thickness of 4 μm was formed by UV irradiation with a high-pressure mercury lamp in a nitrogen atmosphere at an irradiance of 3600 mJ/cm². A solution containing 5% by weight of (F-7) used in Example 24 was applied to the optically anisotropic body with a spin coater at 6000 rpm/120 s at room temperature and was dried at 80° C. for 2 minutes. After standing at 25° C. for 2 minutes, a protective layer (film thickness: 0.1 μm) for protecting the optically anisotropic body was formed by UV irradiation with a high-pressure mercury lamp in a nitrogen atmosphere at an irradiance of 3600 mJ/cm². Thus, the optically anisotropic body of each example was formed. Heat resistance was evaluated in ITO films formed on the protective layer under the same conditions as in Example 1.

For the optically anisotropic body for the evaluation of alignment and others in Example 27, a poiyimide alignment film material for a horizontal alignment film was applied to a light-transmitting substrate by a spin coating method, was dried at 100° C. for 10 minutes, and was baked at 200° C. for 60 minutes, thereby forming a coating film. The coating film was rubbed. Rubbing was performed with a commercially available rubbing machine. The prepared polymerizable cholesteric liquid crystal composition listed in the table was applied to the substrate with a spin coater at 350 rpm/30 s at room temperature and was dried at 80° C. for 2 minutes. After standing at 25° C. for 2 minutes, an optically anisotropic body with a film thickness of 4 μm was formed by UV irradiation with a high-pressure mercury lamp in a nitrogen atmosphere at an irradiance of 3600 mJ/cm². A solution containing 5% by weight of (F-8) (containing 3 parts by weight of (E-1) per 100 parts by mass of (F-8); organic solvent: ethyl acetate) was applied to the retardation film with a spin coater at 800 rpm/120 s at room temperature and was dried at 80° C. for 2 minutes. After standing at 25° C. for 2 minutes, a protective layer (film thickness: 1 μm) for protecting the optically anisotropic body was farmed by UV irradiation with a high-pressure mercury lamp in a nitrogen atmosphere at an irradiance of 3600 mJ/cm². Thus, the optically anisotropic body of Example 27 was formed. Heat resistance was evaluated in ITO films formed on the protective layer under the same conditions as in Example 1.

For the optically anisotropic body for the evaluation of alignment and others in Example 28, a polyimide alignment film material for a horizontal alignment film was applied to a light-transmitting substrate by a spin coating method, was dried at 100° C. for 10 minutes, and was baked at 200° C. for 60 minutes, thereby forming a coating film. The coating film was rubbed. Rubbing was performed with a commercially available rubbing machine. The prepared polymerizable cholesteric liquid crystal composition listed in the table was applied to the substrate with a spin coater at 350 rpm/30 s at room temperature and was dried at 80° C. for 2 minutes. Subsequently, after standing at 25° C. for 2 minutes, an optically anisotropic body (film thickness: 4 μm) was formed by UV irradiation with a high-pressure mercury lamp in a nitrogen atmosphere at an irradiance of 3600 mJ/cm². The (F-9) was applied to the optically anisotropic body with a spin coater at 1000 rpm/60 s at room temperature and was dried at. 80° C. for 2 minutes. After standing at 25° C. for 2 minutes a protective layer (film thickness: 1 μm) for protecting a retardation, film was formed by standing for 30 minutes on a hot plate at 200° C. Thus, the optically anisotropic body of Example 28 was formed. Heat resistance was evaluated in ITO films formed on the protective layer under the same conditions as in Example 1.

### Example 29, Example 30, Comparative Example 13

### (Liquid Crystal Display of VA Mode)

TABLE 6

| Composition | (40) | (41) | (42) |
|---|---|---|---|
| (A-1) | 46.8 | 38.9 | 46.8 |
| (A-2) | 10.2 | 23.1 | 10.2 |
| (A-3) | | 30.8 | |
| (A-4) | | | |
| (A-5) | | | |
| (A-6) | | | |
| (A-7) | | | |
| (B-1) | 7.0 | | 7.0 |
| (B-2) | 11.0 | | 11.0 |
| (B-3) | 9.6 | | 9.6 |
| (C-1) | | | |
| (C-2) | 5.2 | | 5.2 |
| (C-3) | | | |
| (C-4) | | 4.4 | |
| (C-5) | 10.2 | 3 | 10.2 |
| (C-6) | | | |
| (D-1) | 0.1 | 0.1 | 0.1 |
| (E-1) | 3.0 | 3.0 | 3.0 |
| (E-2) | | | |
| (F-1) | | 0.1 | |
| (F-2) | | | |
| (F-3) | | | |
| (F-4) | 0.1 | | |
| (F-5) | | | |
| (F-6) | | | 0.2 |
| (F-7) | | | |
| (F-8) | | | |
| (F-9) | | | |
| (G-1) | 300 | 300 | 300 |

The polymerizable cholesteric liquid crystal compositions (40), (41), and (42) were used to prepare optically anisotropic bodies, and alignment and heat resistance were measured. The results are shown in the tables as Examples 29 and 30 and Comparative Example 13. The optically anisotropic bodies of Examples 29 and 30 and Comparative Example 13 were formed by the method described below.

For the optically anisotropic bodies for the evaluation of alignment and others in Examples 29 and 30 and Comparative Example 13, a color filter layer (4) and a planarization layer (5) were formed on a light-transmitting substrate (3), and then a solution (organic solvent: cyclopentanone) containing 3% by weight of a cinnamic acid polymer (H) was applied by a spin coating method and was dried at 80° C. for 2 minutes. Subsequently, after standing at 25° C. for 2 minutes, a photo-alignment film (6) was formed by irradiation (irradiance: 100 mJ/cm2) with linearly polarized parallel light of visible ultraviolet light with a wavelength of approximately 313 nm emitted from a high-pressure mercury lamp through a polarizing filter in a direction perpendicular to the substrate.

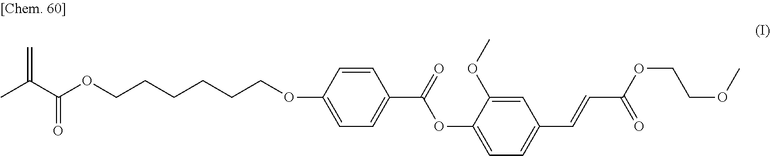 [SMILES: C=C(C)C(=O)OCCCCCCOc1ccc(C(=O)Oc2ccc(/C=C/C(=O)OCCOC)cc2OC)cc1]

(The cinnamic acid polymer (H) was prepared as described below. One part (10.0 mmol) of a compound (I) represented by the structural formula described above was dissolved in 10 parts of ethyl methyl ketone, and 0.01 parts of azobisisobutyronitrile (AIBN) was added. The mixture was heated under reflux in a nitrogen atmosphere for 2 days, thereby producing a solution. The solution was then added dropwise to 60 parts of methanol while stirring. Precipitated solid was filtered off. The solid was dissolved in 5 parts of tetrahydrofuran (THF) and was added dropwise to 120 parts of ice-cooled hexane while stirring. Precipitated solid was filtered off. The solid was dissolved in 5 parts of THF and was added dropwise to 120 parts of ice-cooled methanol while stirring. Precipitated solid was filtered off. The solid was dissolved in THF and was dried under vacuum.)

A homogeneous alignment polymerizable liquid crystal composition described in Example 2 of Japanese Unexamined Patent Application Publication No. 2014-231568 was applied to the substrate with a spin coater at 650 rpm/30 s at room temperature and was dried at 100° C. for 2 minutes. After standing at 25° C. for 2 minutes, a first retardation film (7) with a thickness of 0.6 μm was formed by UV irradiation with a high-pressure mercury lamp in a nitrogen atmosphere at an irradiance of 3600 mJ/cm². The prepared polymerizable cholesteric liquid crystal composition listed in the table was applied to the retardation film 1 with a spin coater at 350 rpm/30 s at room temperature and was dried at 80° C. tor 2 minutes. Subsequently, after standing at 25° C. for 2 minutes, a second retardation film (8) with a thickness of 4 μm was formed by UV irradiation with a high-pressure mercury lamp in a nitrogen atmosphere at an irradiance of 3600 mJ/cm². Heat resistance was evaluated in an ITO film (9) formed on the second retardation film (8) under the same conditions as in Example 1. After the ITO film (9), which was a transparent electrode layer, was deposited on the second retardation film (8), an alignment film (10) was formed. After an ITO film (13), which was a pixel electrode layer, was formed on a light-transmitting substrate (14), an alignment film (12) was formed and was subjected to weak rubbing. Liquid crystal displays of the VA mode according to Examples 29 and 30 and Comparative Example 13 were produced by injecting a TFT liquid crystal manufactured by DIG Corporation into a liquid crystal layer (11) between the alignment film layers (10) and (12) (FIG. 13).

The results are shown in the table below.

TABLE 7

| | Composition | Alignment | Heat resistance |
|---|---|---|---|
| Example 29 | Composition (22) | ∘ | 0.02 |
| Example 30 | Composition (23) | ∘ | 0.02 |
| Comparative | Composition (40) | Δ | — |
| example 13 | | | |

The results show that the polymerizable cholesteric liquid crystal compositions containing a non-silicon compound having a repeating unit selected from the formulae (F-1) to (F-5) and (F-7) to (F-9) (Examples 1 to 23 and 29 to 30) can form an optically anisotropic body with better alignment than the polymerizable cholesteric liquid crystal compositions not containing the compound having a repeating unit (Comparative Examples 1, 4, 6, and 8). In the polymerizable cholesteric liquid crystal compositions containing a silicon compound having a repeating unit (Comparative Examples 2, 3, 5, 7, and 8 to 13), the addition of the silicon compound having a repeating unit can provide an optically anisotropic body with good alignment of a retardation film when the retardation film has a small thickness of 1 μm (Comparative Examples 2, 3, and 10), but cannot provide a retardation film with good alignment when the retardation film has a large thickness of 4 μm (Comparative Examples 5, 7, 9, and 11 to 13). Even when a retardation film formed of a polymerizable cholesteric liquid crystal composition to which the silicon compound having a repeating unit was added had a small, thickness of 1 μm, the retardation film had a large difference in film thickness after the formation of an ITO film and subsequent baking and obviously had low heat resistance. By contrast, the use of the polymerizable cholesteric liquid crystal compositions containing a non-silicon compound having a repeating unit selected from the formulae (F-1) to (F-5) and (F-7) to (F-9) (Examples 1 to 23 and 29 to 30) resulted in a small difference in film thickness after the formation of an ITO film and subsequent baking. A comparison with Comparative Examples suggests that the compound selected from the formulae (F-1) to (F-5) and (F-7) to (F-9) was not incorporated into the optically anisotropic body during the polymerization of the polymerizable cholesteric liquid crystal composition, was formed on the optically anisotropic body as a protective layer for protecting the optically anisotropic body, and could protect the optically anisotropic body from heat of baking after the formation of an ITO film, thereby improving heat resistance.

This consideration is also supported by the fact that, a solution containing a non-silicon compound having a repeating unit on an optically anisotropic body, the heat resistance of optically anisotropic bodies formed by stacking the protective layer for protecting the optically anisotropic body (Examples 24 to 28) was comparable to the heat resistance of the optically anisotropic bodies of Examples 1 to 23.

1. A polymerizable cholesteric liquid crystal composition comprising: one or two or more polymerizable liquid crystal compounds (I) having two or more polymerizable functional groups in a molecule; chiral compound (III); a polymerization initiator (IV); optionally a non-silicon compound (V) having a repeating unit: and optionally one or two or more polymerizable liquid crystal compounds (II) having one polymerizable functional group.

2. The polymerizable cholesteric liquid crystal composition according to claim 1, wherein the non-silicon compound (V) having a repeating unit is an essential component.

3. The polymerizable cholesteric liquid crystal composition according to claim 1, wherein the non-silicon compound (V) having a repeating unit is an acrylic compound and/or a methacrylic compound.

4. The polymerizable cholesteric liquid crystal composition according to claim 1, wherein the polymerizable liquid crystal compound (I) having two or more polymerizable functional groups in the molecule is a compound represented by a general formula (I-1).
[Chem. 1]
P¹¹-(Sp¹¹-X¹¹)_{q1}-MG¹²-((X¹²-Sp¹²⁾_{q2}-P¹²)_{q3} (I-1)
(wherein P¹¹ and P¹² independently denote a polymerizable functional group, Sp¹¹ and Sp¹² independently denote an alkylene group having 1 to 18 carbon atoms or a single bond, one —CH₂— or two or more nonadjaeent —CH₂— groups in the alkylene group are independently optionally substituted with —O—, —COO—, —OCO—, or —OCO—O—, one or two or more hydrogen atoms of the alkylene group are optionally substituted with a halogen atom (a fluorine atom, a chlorine atom, a bromine atom, or an iodine atom) or a CN group. X¹¹ and X¹² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C═C—, or a smgle bond (provided that P¹¹-Sp¹¹, P¹²-Sp¹², Sp¹¹-X¹¹, and Sp¹²-X¹² have no direct bonding of heteroatoms), q1 and q2 are independently 0 or 1, q3 is 1 or 2, and MG¹² denotes a mesogenic group)

5. The polymerizable cholesteric liquid crystal composition according to claim 1, wherein the polymerizable liquid crystal coinpoimd(s) (II) having one polymerizable functional group in the molecule is/are a compound or compounds represented by a general formula (II-1).
P²²-(Sp²²-X²²)_{q6}-MG²²-R²¹ (II-2)
(wherein P²² denotes a polymerizable functional group. Sp²² denotes an alkylene group having 1 to 18 carbon atoms or a single bond, one —CF₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom or a CN group, X²² denotes —O—, —S—, —OCH₂—, —CH₂O—, —CO—, —COO—, —OCO—, —CO—S—, —S—CO—, —O—CO—O, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH—, —OCO—CH₂CH₂—, —CH₂CH₂—COO, —CH₂CH₂—OCO—. —COO—CH₂—, —OCO—CH₂—, —CH₂—COO—, —CH₂—OCO—, —CH═CH—, —N═N—, —CH═N—N═CH—, —CF═CF—, —C═C—, or a single bond (provided that P²²-Sp²² and contain no direct bonding of heteroatoms other than C or H), q6 is 0 or 1, MG²² denotes a mesogenic group, R²¹ denotes a hydrogen atom, a halogen atom, a cyano group, a linear or branclied alkyl group having 1 to 12 carbon atoms, a linear or branched alkenyl group having 1 to 12 carbon atoms, one —CH₂— or two or more nonadjacent —CH₂— groups in the alkyl group and the alkenyl group are independently optionally substituted with —O, —S—, —CO—, —COO, —OCO—, —CO—S—, —S—CO—, —O—CO—O—, —CO—NH—, —NH—CO—, —NH—, —N(CH₃)—, —CH═CH—COO—, —CH═CH—OCO, —COO—CH═CH—, —OCO—CH═CH—, —CH═CH—, —CF═CF—, or —C═C—, one or two or more hydrogen atoms of the alkyl group and the alkenyl group are independently optionally substituted with a halogen atom or a cyano group, and the plurality of substituenfe, if present, may be the same or different)

6. An optically anisotropic body comprising the polymerizable cholesteric liquid crystal composition according to claim 1.

7. A retardation film comprising the polymerizable cholesteric liquid crystal composition according to claim 1.

8. A patterned retardation film comprising the polymerizable cholesteric liquid crystal composition according to claim 1.

9. A brightness enhancement film comprising the polymerizable cholesteric liquid crystal composition according to claim 1.

10. An antireflection film comprising the polymerizable cholesteric liquid crystal composition according to claim 1.

11. A thermal barrier film comprising the polymerizable cholesteric liquid cyrstal composition according to claim 1.

12. A laminate having a protective layer on an optically anisotropic body, comprising the polymerizable cholesteric liquid crystal composition according to claim 1.

13. A method for producing the laininare according to claim 12, comprising: applying a solution containing a non-silicon compound (V) having a repeating unit to an optically anisotropic body formed by polymerizing the polymerizable eholesEerie liquid crystal composition, drying the solution, and if necessary performing curing.

14. A method for producing the laminate according to claim 12 comprising: polymerizing the polymerizable cholesteric liquid crystal composition.

15. A liquid crystal display comprising the optically anisotropic body according to claim 6.

16. A liquid crystal display comprising the retardation film according to claim 7.

17. An image display apparatus comprising the patterned retardation film according to claim 8 .

18. An image display apparatus comprising the brightness efiianeementfihn according to claim 9.

19. An image display apparatus comprising the autireflection film according to claim 10.

20. An optical device comprising the optically anisotropic body according to claim 7.

21. An optical device comprising the patterned retardation film according to claim 8.

22. A printed material comprising the optically anisotropic body according to claim 6.
